(19) United States
(12) Patent Application Publication
(10) Pub. No.: US 2006/0101443 A1
(43) Pub. Date: May 11, 2006

(54) Source code management system and method

(76) Inventor: Jim Nasr, Acworth, GA (US)

Correspondence Address: BLACKWELL IGBANUGO P.A., 3601 WEST 76TH STREET, SUITE 250, MINNEAPOLIS, MN, 55435, US

(21) Appl. No.: 11/258,414

(22) Filed: Oct. 25, 2005

Related U.S. Application Data
(60) Provisional application No. 60/621,775, filed on Oct. 25, 2004.

(51) Int. Cl. G06F 9/44

(52) U.S. Cl. 717/163; 717/123

(57) ABSTRACT

The present invention provides a system and method for managing source code. The system comprises an administrative module including a build services module configured to perform a build action on a source code file and a library module functionally coupled to the administration module and configured to support library services operations on the source code file. The method comprises the steps of managing a source code file with a document management based library module configured to perform a file action on a folder, and managing a source code project, associated with the source code file, with an administrative module.

### RELATED APPLICATION

This application claims the benefit of a pending U.S. provisional application Ser. No. 60/621,775, filed Oct. 25, 2004, titled Source Code Management System and Method, which is herein incorporated by reference.

### BACKGROUND

Source code management (SCM) is central to enabling software developers to operate effectively in IT organizations today. With the proliferation of content management systems, such as those produced by Documentum, Vignette, and Stellant, to manage enterprise data, a divide has developed in the repository used for content and source code. Content is stored in the content management system while source code is centrally managed in a source code management system, such as that provided by Microsoft Visual Source Sale™, Merant's™ PVCS, open source products such as CVS, or even file systems.

Often many different source code management systems are utilized by separate groups in an organization, but a singular enterprise content management (ECM) system is deployed. An enterprise solution to source code management that can be deployed and utilized by the entire organization is in critical demand. The logical choice for most organizations is to maximize the investment return of their content management system by utilizing the robust library service mechanisms already present in most enterprise content management systems.

However, most enterprise content management systems lack key functionality necessary for properly managing source code. For instance, the document management system by Documentum lacks hierarchical export or check out functionality, a common element of most source code management systems.

In the case of web site deployment, there is a need to synchronize content and source code for a particular web site release. Source code for a web site could be for data access objects, business layer objects, portal components, Java Server Pages (JSP), or other functional components of a web site page. Content and source code have separate lifecycles. Content generally moves from Work In Progress (WIP) to Staging to Active in its lifecycle while source code moves from Development to Quality Assurance (QA) to Production.

There is a logical association between the content and source code lifecycles. The WIP state for content may be associated with the Development stage of source code. Staging state may be associated with QA and Active state to Production.

Because content and source code are stored in separate repositories, there is no mechanism to package content and source code associated with a particular web site release. Therefore, this packaging must occur manually, which is often difficult to coordinate between content teams and source code development teams. The result is an error prone process that makes it difficult to deploy and redeploy web site releases.

What is needed is a source code management system and method for overcoming at least some of the above-described problems.

### SUMMARY OF THE INVENTION

Accordingly, the present invention provides a source code management system comprising an administrative module and a library module functionally coupled thereto. The administrative module includes a build services module configured to perform a build action on a source code file. Non-limiting examples of the build action include extracting, packaging and deploying. The library module is configured to support library services operations on the source code file. The library module and the administrative module may be included in the same module. Alternatively, the library module and administrative module may be the same module.

In one embodiment of the present invention, the administrative module is configured to create and manage a source code project; and the library module is a document management based library module functionally coupled to the administration module and configured to perform a file action on a folder associated with the source code project or a folder containing the source code file, or alternatively, any subfolders within the folder. Non-limiting examples of the file action include check out, check in, import, export, get latest, and unlock.

In one embodiment of the present invention, the build services module is configured to perform a build action by attaching a build metatag to the source code file, or the source code file collection. The build metatag is configured to functionally interact with the system for managing source code. The build metatag may define one or more of the following: how the administrative module and library module interact with the source code file, the build action, and what file actions may be taken on the source code file. The build metatag may comprise a build status label capable of functionally interacting with the library module or the administrative module. The build status label may be an object, such as a collection.

In one embodiment of the present invention, there is at least one version of the source code file. Alternatively, there may be more than one version of the source code file. In a further embodiment, the library module, the administrative module, the build metatag, the file actions, and the build actions act independently on each version of the source code file. In a still further embodiment, the library module, the administrative module, the build metatag, the file actions, and the build actions act simultaneously on each version of the source code file.

In one embodiment of the present invention, the build action creates a build list, for example, an object functionally interactive with another portion of the system, the library module, or the administrative module. In one embodiment, the build action creates a system object.

In one embodiment of the present invention, the system is configured to functionally interact with an integrated development environment. In a further embodiment, the system is configured to automatically launch a source code file in the Eclipse Integrated Development Environment or other source code editors. In a further embodiment, the system according to claim 1 is configured to functionally interact with a diff/merge application, to enable the system to perform diff/merge actions on two versions of the same file, or two completely different files or a file from the repository and the local file system. In a still further embodiment, the build services module is capable of performing build actions on source code files together with content files.

In one embodiment of the present invention, a computer operable method for managing computer data storage is provided. The method comprises the steps of a first software agent obtaining file storage attributes for a plurality of files, wherein the files are stored on a data storage device of a first computer, wherein the files are controlled by a file system, and wherein the file storage attributes are obtained from the file system; a second software agent intercepting calls to the file system and obtaining file storage attributes from the calls; the second software agent storing obtained file storage attributes in a first data repository; a third software agent obtaining file storage attributes from first data repository; a storage management application obtaining file storage attributes from the first software agent; the storage management application obtaining file storage attributes from the third software agent; and the storage management application storing and updating file storage attributes in a second data repository.

In one embodiment, a computer operable method for managing source code is provided, the method comprising the steps of managing a source code file with a library module; and managing a source code project, associated with the source code file, with an administrative module. In a further embodiment, the library module comprises a document management based library module configured to perform a file action on a folder and the step of managing a source code file further comprises performing a file action. In a further embodiment, the administrative module is configured to create and manage a source code project, and the method further comprises the step of creating a source code project with the administrative module.

In one embodiment of the present invention, the administrative module is configured to perform a build action on the source code file, and the step of managing the source code project further comprises performing a build action on the source code file. The library module is functionally coupled to the administration module and configured to support library services operations on the source code file, and the step of managing a source code file includes performing library services operations on the source code file. In a further embodiment, the library module comprises a document management based library module functionally coupled to the administration module and configured to perform a file action on a folder associated with the source code project, and the step of managing a source code file includes performing a file action on a folder associated with the source code project. The library module performs a file action selected from the group comprising check out, check in, import, export, get latest and cancel check out. In a further embodiment, the library module performs the file action on a folder and on any subfolders within the folder.

In one embodiment of the present invention, the method further comprises the step of performing a build action with the administrative module. Non-limiting example of the build action include extracting, packaging and making deploying. The build and release action may define what file actions may be taken on the source code file. In a further embodiment, the administrative module is configured to perform a build action by attaching a build metatag to the source code file collection, and the step of performing a build action with the administrative module comprises attaching a build metatag to the source code file collection with the administrative module. The build metatag is configured to functionally interact with the system for managing source code. The build metatag may define the build action. In a further embodiment, the build metatag defines the file actions taken on the source code file. In a still further embodiment, the build metatag defines how the administrative module and library module may interact with the source code file. The build metatag may comprise a build status label. The build status label may be an object, such as a collection. The build status label is capable of functionally interacting with the library module, and administrative module.

According to the method of the present invention, actions may be taken on at least one version of the source code file. There may be more than one version of the source code file acted on. In one embodiment the method includes the step of managing at least one additional version of the source code file. The library module, the administrative module, the build metatag, the file actions, and the build actions act independently on the source code file and the at least one additional version of the source code file.

In one embodiment of the present invention, the build action creates a build list. The build list is an object functionally interactive with another portion of the system, such as the library module, or the administrative module. The build action creates a system object. In one embodiment, the method includes the step of performing diff/merge actions on a first version of a file and a second version of a file. In one embodiment, the method includes the step of performing diff/merge actions on a first file and a second file. In a further embodiment, the build services module performs build actions on source code files and content files.

### BRIEF DESCRIPTION OF THE DRAWINGS

In order that the advantages of the invention will be readily understood, a particular description of the invention briefly described herein will be rendered by reference to specific embodiments that are illustrated on the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram showing functional elements of one embodiment;

FIG. 2 is a block diagram showing the functional context of one embodiment;

FIG. 3 displays the technical context of one embodiment;

FIG. 4 is a diagram of a configuration for a CheckinAction of one embodiment in accordance with the present invention;

FIG. 5 is a diagram of a configuration for a CheckinAction of one embodiment in accordance with the present invention;

FIG. 6 is a diagram of a configuration for a CheckinAction of one embodiment in accordance with the present invention;

FIG. 7 is a diagram of a configuration of a CheckinContainer component of one embodiment in accordance with the present invention;

FIG. 8 is a table showing properties of a CheckinFolder page in accordance with an embodiment of the present invention;

FIG. 9 is a diagram of a configuration of a SCMCheckinAction in accordance with an embodiment of the present invention;

FIG. 10 is a diagram of a configuration of a Checkin component, SCMCheckin in accordance with an embodiment of the present invention;

FIG. 11 is a diagram of a configuration of a Checkin component, CheckinContainer in accordance with the present invention;

FIG. 12 is a diagram of a configuration of a Checkin functionality in accordance with an embodiment of the present invention;

FIG. 13 is a Sequence Diagram illustrating the SCMCheckin functionality and the interaction between the component and service layer in accordance with an embodiment of the present invention;

FIG. 14 is a diagram of a Command-Line functionality in accordance with an embodiment of the present invention;

FIG. 15 is a diagram of a Command-Line functionality in accordance with an embodiment of the present invention;

FIG. 16 is a diagram of a Command-Line functionality in accordance with an embodiment of the present invention; and

FIG. 17 is a sample of a user interface in accordance with an embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment.” “in an embodiment.” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In one embodiment, the present invention relates to source code management systems and methods. In particular, the present invention relates to a source code management system and method having build functionality and/or integrated with a document management system.

In one embodiment according to the present invention, the source code management system has an administrative module and a library module. In a further embodiment, the administrative module has a build services module configured to perform a build action on a source code file. Build actions include, but are not limited to, extracting, packaging, and deploying the build. The library module is functionally coupled to the administrative module and configured to support library services operations.

In one embodiment according to the present invention, the library module is a document management based library module. The document management based library module is configured to perform a file action on a folder including a source code file. File actions include, but are not limited to check out, check in, import, export, get latest and cancel check out. The library module is functionally coupled to the administrative module and configured to support library services operations.

In one embodiment according to the present invention, the administrative module has a build services module configured to perform a build action on a set of source code files, associated with a source code project, and the document management based library module is configured to perform a file action on a folder containing the source code file. The library module is functionally coupled to the administrative module and configured to support library services operations. Build actions include, but are not limited to, extracting, packaging, and deploying. File actions include, but are not limited to, check out, check in, import, export, get latest and cancel check out.

In one embodiment according to the present invention, the method for managing source code includes managing source code using a document management based library module, managing a source code project in an administrative module, and performing a file action on a folder within the document based library module, wherein the folder contains a source code file associated with the source code project. File actions include, but are not limited to, check out, check in, import, export, get latest and cancel check out.

In one embodiment according to the present invention, the method for managing source code includes managing a source code file associated with a source code project with a library module; managing the source code project with an administrative module; and performing a build and release action on the source code file. Build actions include, but are not limited to, extracting, packaging and deploying.

In one embodiment according to the present invention, the method for managing source code includes managing a source code file, associated with a source code project, with a document management based library module; managing the source code project with an administrative module; performing a file action on a folder containing the source code file with the document based library module; and performing a build on the source code file. File actions include, but are not limited to, check out, check in, import, export, get latest and cancel check out. Build actions include, but are not limited to extracting, packaging and deploying.

In one embodiment in accordance with the present invention, the document based library module is configured to perform a file action on a folder and on any subfolders within the folder.

In one embodiment of the present invention, the document based library module and the administrative module are included in the same module.

In one embodiment of the present invention, the document based library module and the administrative module are the same module.

In one embodiment of the present invention, the build action is performed by attaching a build metatag to the source code file collection; the build metatag being configured to functionally interact with the system for managing source code. Additionally the build metatag may be configured to functionally interact with additional systems.

In one embodiment of the present invention, the build action may define what file actions may be taken on the source code file. Also, the build metatag may define what the build constitutes. Additionally the build metatag may define what file actions may be taken on the source code file. Further, the build metatag may define how the administrative module and library module may interact with the source code file.

In one embodiment of the present invention, the build metatag may comprise a build status label. Additionally, the build status label may be an object. Further, the build status label may functionally interact with the library module or the administrative module or both.

In one embodiment of the present invention, the build object may be a collection.

In one embodiment of the present invention, there may be several versions of the source code file, wherein the library module, the administrative module, the build metatag, the file actions, and the build actions may each act independently, uniquely, collectively, or simultaneously on each version of the source code file.

In one embodiment of the present invention, the build action creates a build list. Further, the build list may be an object functionally interactive with the library module, the administrative module and/or any other portion of the system.

In one embodiment of the present invention, the build comprises a system object.

In one embodiment of the present invention, the system is configured to functionally interact with an integrated development environment. For example, the system may be configured to automatically launch a source code file in the Eclipse Integrated Development Environment (IDE) or other source code editors.

In one embodiment of the present invention, the system is configured to functionally interact with a difference/merge (diff/merge) application. The system is capable of performing diff/merge actions on more than one file. For example, the system is capable of performing dif/merge actions on two versions of the same file, or alternatively, on two completely different files or between a file in the repository and a file in the local file system.

In one embodiment of the present invention, the administrative module contains a build module. The build module is capable of performing build actions on source code files. Still further, the build module is capable of performing build actions on source code files together with content files.

The described embodiments in accordance with the present invention provide control of files, especially source code files. Further, some of the embodiments of the present invention are within a document management system. Again further, some of the embodiments of the present invention are configured such that hierarchy may be exploited. Still further, in some of the embodiments of the present invention, the control provides management of source code build activities.

For the purposes of promoting an understanding of the principles of the present invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

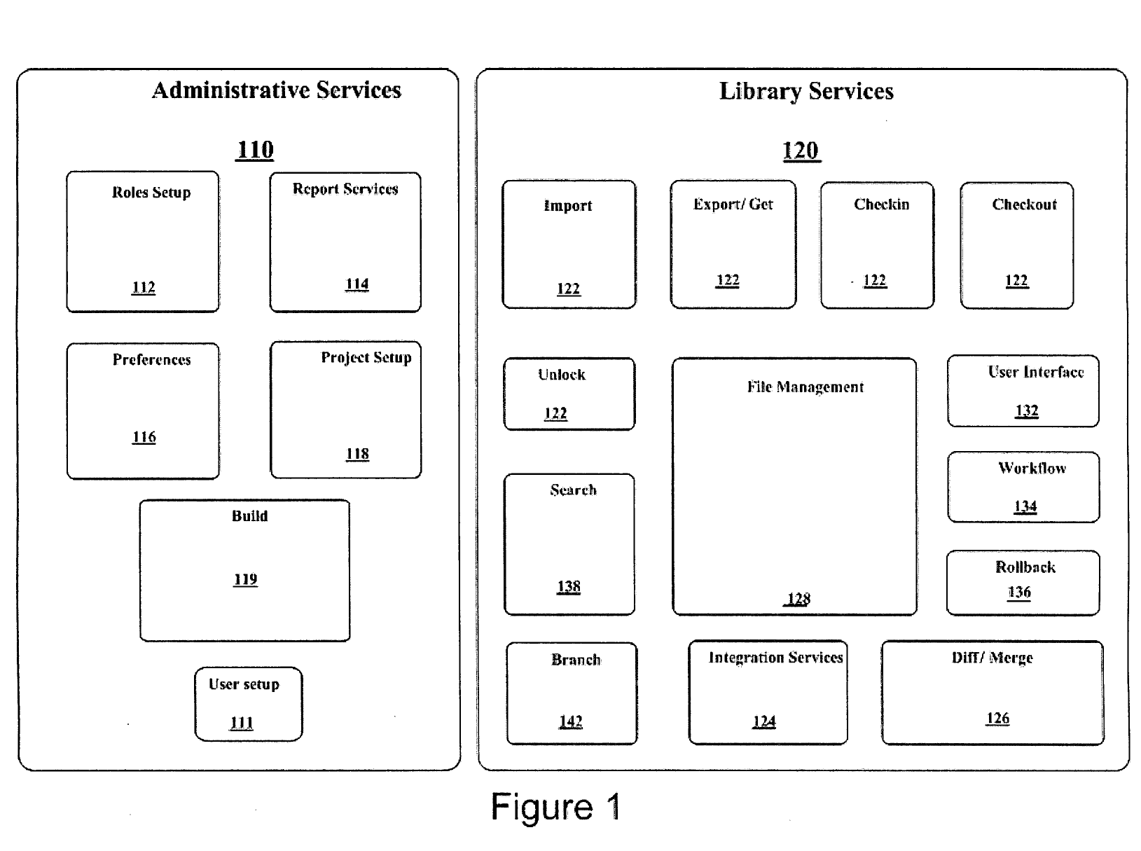

FIG. 1 is a block diagram showing functional elements of one embodiment of a system in accordance with the present invention. There is an administrative services module 110 and a library services module 120. Included in the administrative services module 110 is a roles setup module 112, a report services module 114, a preferences module 116, a project setup module 118, a build module 119, and a user setup module 111. Included in the library services module are action modules 122, including import, export/get, check in, check out and unlock. Additionally, the library services module includes a search module 138, a file management module 128, a user interface module 132, a workflow module 134, a rollback module 136, a branch module 142, an integration services module 124 and a diff/merge module 126.

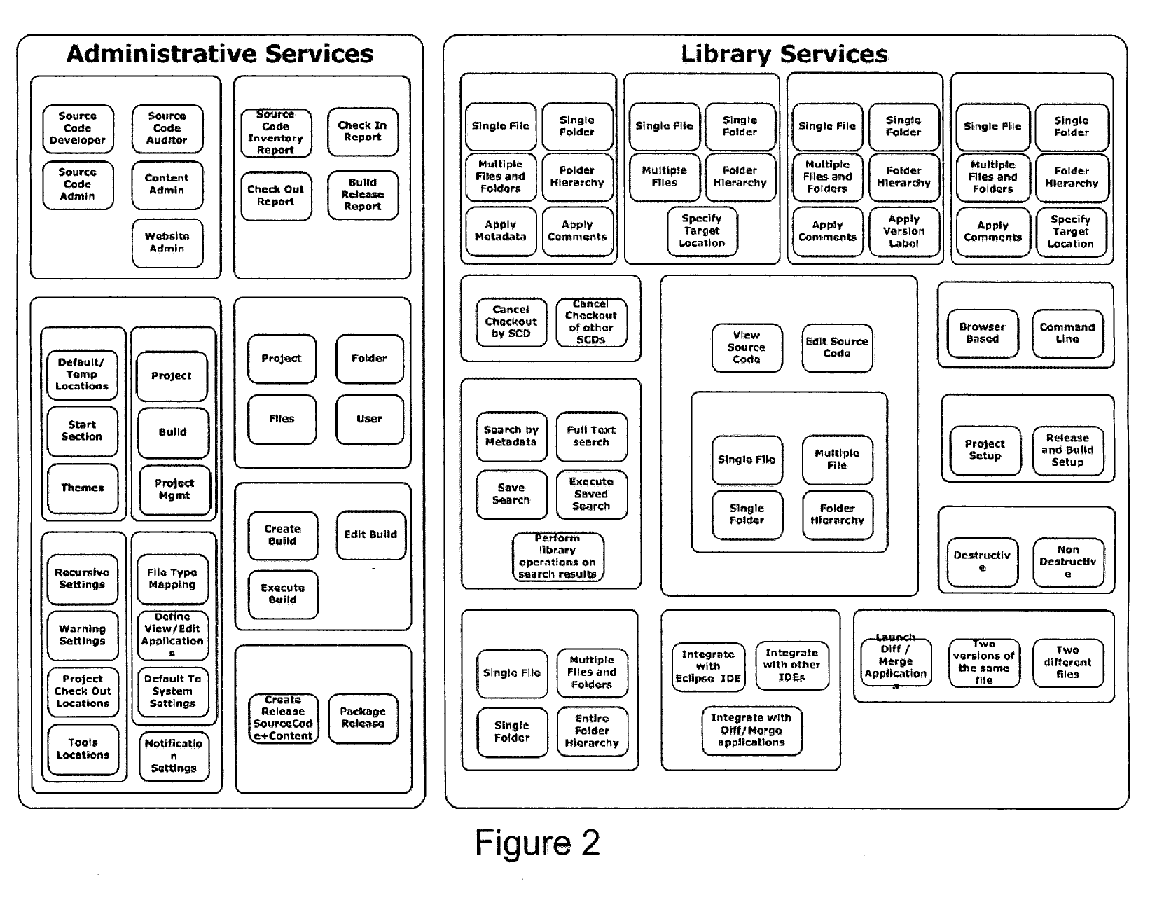

FIG. 2 is a block diagram of one embodiment of a system similar to FIG. 1, but displaying additional detail concerning the function and contents of the main modules of the embodiment shown in FIG. 1. For example, the file management module 128 as shown at FIG. 1, is shown at FIG. 2 including greater detail regarding the modules and functions included within the file management module 128. In particular, the action modules 122, the file management module 128, and the branch module 142 each include modules and functions permitting appropriate operations to be performed on a single file, multiple files, a single folder, and multiple folders. Further, the build module 119 includes functions and modules relating to creating builds, executing builds, which include source code and content.

As further explanation of the details of the system included in FIG. 2, Project Setup includes setting up a source code project. The Project is the root for all items (source code and other project assets) contained within the project. This top-level project consists of folder hierarchies therein, which depict the project source code structure. Project Setup operations are performed by a Source Code Administrator (SCA) and include setting up top-level project folders or Cabinets, folder structure, and project preferences having Build metatag Prefixes, Build Export target location, and Mapping file types to application. The Source Code Developer (SCD) will be able to create folders within an existing project and view permission sets that have been assigned to existing projects and/or sub-folders.

Still referring to FIG. 2, authorized users of the system must be assigned permission to perform any actions within the embodiment. These permissions or rights are generally assigned by an SCA during User Setup. Permission Setup operations include: creating permission sets for users based on their roles, editing existing permission sets, assigning permission sets to existing projects/folders and viewing permission sets assigned to a project or sub-folders.

Still referring to FIG. 2, roles in the system refer to certain types of users within the embodiment. Each of these types will have slightly different permissions and rights to access and modify source code files within the project repository. Role setup operations include adding users to specific roles and removing users from roles. Default roles include SCM Source Code Administrator or SCA, SCM Source Code Developer or SCD and SCM Source Code Auditor or SCAU.

Still referring to FIG. 2, user setup involves an SCA creating users within the system and setting up their individual rights, permissions and general preferences. Operations include setting up users by using the SCM Administration Module and using DQL scripts, assigning users to their project roles and assigning general user preferences.

Still referring to FIG. 2, the following items are detailed requirements for processes surrounding setting user preferences within the system. These processes involve an SCA or SCD setting general project and individual user preferences. An SCA or SCD may set their personal preferences such that they are notified when certain actions are performed on specific objects in the document management system. This is otherwise known as subscribing to event notification. In order to subscribe to event notifications an SCA or SCD can select specific source code or other project-related files and specific events including check in, check out, lifecycle actions, rollbacks, deletes and cancel check outs. Notification preferences may be set on several levels including single and multiple files, single folders and folder hierarchy, as well as on the project-level.

Still referring to FIG. 2, the system has the ability to maintain customized settings or preferences for each user. An SCA or SCD may setup general project preferences such as; project-working folders, temporary file location, build location, default recursive functionality and difference/merge tool location. These settings only apply to each individual user, and, once set in place are used unless the user changes them.

Still referring to FIG. 2, the functionality of SCM Build Management includes functionality for Creating Releases, Creating, Editing and Executing Builds. Users who have Source Code Administration privileges perform the Build Management functionality. The creation of builds should encapsulate both Source Code Files and Content Files (for web projects) if necessary.

While creating a build, the SCA specifies a label for the build, specifies build related metadata and selects the files associated for the build. The file selection may be accomplished in a number of ways. Nonlimiting examples of the manner in which file selection may be performed include specifying the latest version for all source code files, specifying a specific version (or version label) for all source code files, specifying a lifecycle state or selecting every individual file (and its version) manually. Once the files are selected, SCM creates an internal representation of the build and associates it with the Release. A new build can also be created by using the configuration of a previously created build.

Still referring to FIG. 2, after the build is created, it can be executed. This would mean that any files belonging to the build are extracted and exported to a build location. The build location is part of the metadata associated with the build. If there are any build scripts associated with the build, they are exported and executed as well.

Still referring to FIG. 2, the following items are detailed functional requirements for the process of checking in objects into the system. This process involves an SCA or SCD checking in source code or other project-related files that he/she previously checked-out in order to edit their content. During check in, the user must also choose how to apply version labels to the object(s) being checked-in, such as, major versions, minor versions and text labels. The user can also opt to apply comments to the source code file(s). The user should not be able to change the name of the file or the format, hence these fields will be made non editable (read-only). During check out, the working folder structure resembles the folder hierarchy in what may be described as a Documentum™ Project repository. In other words, the folder hierarchy in the repository becomes the folder tree relative to the project's working folder. At the time of check in, the file is retrieved from this local hierarchy for checking in. Alternately, the user can choose to pick the file from a different location on the local file system. The user has additional options while checking in a source code file, such as retain lock, make it the current version, keep a local copy after check in and subscribe to this file.

Still referring to FIG. 2, the check in operation can be performed on several levels including single and multiple files, as well as single and multiple folders and folder hierarchies. Additional options include the ability to perform check in operation from the command line with all the appropriate command line options. For example, in a document management system environment this would include: document management system document database authentication parameters, username and password, the source location on the document database, local directory, file/folder name, document database folder, check in comment, version information and whether or not the check in operation is recursive.

Still referring to FIG. 2, the following items are detailed requirements for the process of checking out objects from the system. This process involves an SCA or SCD checking out source code or other project-related files/folders for viewing or editing purposes. The check out operation can be performed on several levels including single and multiple files, as well as single and multiple folders and folder hierarchies. During check out, the file/folder is checked out relative to the working folder the user has set in the User Preferences. During check out, the working folder structure resembles the folder hierarchy in the repository. In other words, the folder hierarchy in the local file system becomes the folder tree relative to the project working folder setup in the document management system for that particular project. The folder tree is built hierarchically on the local file system, if a folder relative to the check out path does not exist. Alternatively, the user can choose to check out the file to a different location.

Still referring to FIG. 2, when checking out folder(s), the user is given the choice to hierarchically check out any subfolders and files. If a file/folder with the same name exists on the local file system, the user is given a choice to overwrite the existing file with a new copy from the embodiment. When the user checks out a folder an attempt will be made to check out all the files under that folder (and hierarchically under the subfolders, if that option is chosen). If any of these files are currently checked out by another user, then the user is given the option of getting a copy of the file on the local file system with read only permissions. Additional options include the ability to perform this operation from the command line with all the appropriate command line options including document management system authentication parameters, username and password, the source location on the document management system database, local directory, file/folder name, document management system folder, version information and whether or not the check out operation is recursive.

Still referring to FIG. 2, the following items are detailed requirements for the process of importing objects into the document management system, for a particular project, using the system in accordance with an embodiment of the present invention. This process involves an SCA or SCD selecting source code or other project related files from a local file system and importing them into the document management system. In order to do this, the user must select the document management system location (project cabinet/folder) into which the user wishes to import the files. Performing an import will launch a dialog in which the user must select the files or folders (from the local file system) that the user wishes to import. During this operation the user must configure the properties of each object being imported before the actual import occurs. These operations can be performed on two levels including single or multiple files, where the user must individually select the files the user wishes to import, and folder hierarchies where selecting a folder will result in the import of its contents as well as those of its sub-folders. Additional options include importing files, assigning appropriate metadata to the imported files, and performing an import from a command line interface. The use of a command line import requires the appropriate parameters including document management system authentication parameters, target working folder, source location on the document management system, overwrite parameters, version information, whether or not the import operation is recursive and metadata configuration file, if necessary.

Still referring to FIG. 2, the following items are detailed requirements for the Export process of the embodiment. This process involves an SCA or SCD exporting source code or other project-related files from the repository (document management system) to a folder on the local file system. The local folder is referred to as the target working folder. By default, the latest version of the file is exported, though the user can specify an alternate version to be exported via version labels (from the Version or History screens) or through the Export Options Screen. The user performing export must be authenticated into the system and must he authorized to perform export on the relevant source files. The user must also have write permissions on the target working folder (on the local file system) for the export operation to succeed. Appropriate error messages are displayed when these conditions are not met. These export operations can be performed on two levels including single or multiple files wherein the Export operation can handle one or more files together (the user must individually select the files he/she wishes to export), and folder hierarchies, wherein the Export operation can also handle one or more folders together as well as complete folder hierarchies (selecting a folder will result in the export of its contents as well as those of its sub-folders).

Still referring to FIG. 2, during the Export operation, the user can specify the target working folder (on the user's local machine) where any source files are to be exported. If the target working folder does not exist on the user's local machine, an option is provided to create that folder before performing export. If a file with the same name exists in the location where a file is being exported, a confirmation dialog for overwriting the existing file is displayed. The folder hierarchy is preserved while exporting hierarchy of files. The Export operation can also be performed from command line. All the options provided by the Graphic User Interface (GUI) can be passed as arguments. The use of a command line export requires the appropriate parameters including document management system authentication parameters, target working folder, source location on the document management system, overwrite parameters, version information, whether or not the export operation is recursive and metadata configuration file, if necessary.

Still referring to FIG. 2, the following items are detailed requirements for the process of canceling a user's check out of objects from a document management system within the embodiment. This process involves an SCA or SCD performing one of two actions, namely canceling their own cheeked-out files and canceling another user's (SCA only) check out of source code or other project-related files. When canceling a check out, the user can specify objects with specific labels or versions. An SCA can perform CancelCheckouts based on the users that have files checked-out from the document management system. These operations can be performed on several levels including single and multiple files, as well as single and multiple folders and folder hierarchies. Performing a CancelCheckout on a single folder, or multiple folders on the same level, implies that source code files within subfolders are affected.

Still referring to FIG. 2, the following items are detailed requirements for the process of deleting objects from a document management system in accordance with an embodiment of the present invention. This process involves an SCA or SCD selecting source code or other project-related files or folders and permanently removing them from the document management system. These operations can be performed on several levels including single and multiple files, as well as single and multiple folders and folder hierarchies. Performing a delete on a single folder, or multiple folders on the same level, implies that source code within subfolders may be affected. An SCA can also choose to delete an entire project from the document management system. An SCA or SCD must be the owner of an object in the document management system and have write permissions on that object in order to be able to delete it. An SCA cannot delete a file that is checked out by another user. The SCA must perform a cancel check out before the delete operation can be carried out. Additional options and functionality include ability to perform a delete operation from a command line interface by providing all the appropriate command parameters, ability to delete links and ability to delete an object that is already in a build that has not been executed (SCA only).

Still referring to FIG. 2, rollback functionality is a mechanism by which a system user can choose a previous non-current version of a source code file and make that version as the current version. This would imply that the changes in the recent versions are not necessary to be preserved in the current version, but needed to be preserved in the version history of the source code file. Since an earlier version is reinstated as the current version, when the user performs a “Get” or an “Export” operation against the file or the project, the version that was reinstated is exported to the user's local file system. While performing the Rollback function, the user should be able to specify comments to describe the necessity of performing that action.

Still referring to FIG. 2, rollback functionality in the system is classified as Non Destructive and Destructive. Non Destructive Rollback functionality retains all versions of the source code files in the version history. File-level rollbacks are done on an individual file basis. The user views the version history of a source code file, chooses a previous version, and specifies that version to become the current version. The system preserves the selected version in its position in the version history, but creates a new instance of it and makes it the current version. The user should be given the option to specify comments to describe the intent of the rollback operation. Destructive Rollback functionality destroys all intermediate versions between the current version and the version selected for rollback. This functionality is only available to the Source Code Administrator. Necessary checks are performed such that the intermediate versions that will be destroyed are not checked out to any user. File-level rollbacks are done on an individual file basis. The SCA views the version history of a source code file, chooses a previous version, and specifies that version to become the current version. The SCA also specifies that the rollback be done in a destructive manner. This destructive rollback results in all the intermediate versions deleted from the system and the version chosen for roll back becomes the current version. The comments that were specified during this operation are tagged along with any existing comments. The versions that were destroyed during this operation are automatically specified in the comments.

Still referring to FIG. 2, the following items are detailed requirements for the View and Edit Source code process of the system in accordance with an embodiment of the present invention. To view or edit source code files, an SCA or SCD can setup the default/preferred application to load the file as part of the user preferences. Additionally, the user is also given the option of choosing an alternate viewing/editing application. The user can choose to view/edit the current version or any previous version from the display. To edit a previous version, the rules applicable to checking out older versions apply.

Still referring to FIG. 2, the view source code file process involves an SCA or SCD choosing a source code file to view. The file is exported to a temporary location and loaded in the appropriate viewing application. The temporary location is preconfigured in the application. The edit source code file process involves a SCA or SCD user choosing a source code file to edit. The file is checked out to the working folder (already specified or user specifies it during the action) and loaded in the appropriate editing application. The preconditions for a successful check out apply here as well. The Edit the file properties of a source code file process involves a SCA or SCD user choosing the properties option for a file. The user can enter new values or edit the existing values. These properties can then be saved.

Still referring to FIG. 2, the following items are detailed requirements for the processes dealing with file management within the embodiment. The processes involved in file management include copying, moving and linking source code or other project related files and/or folders in the document management system. Copying objects from one location in the document management system to another involves an SCA or SCD copying the desired files or folders onto the SCM clipboard, and then pasting them elsewhere. This would create an exact replica of the intended objects at the target location. The user must have write permissions at the target location. Moving objects from one location in the document management system to another involves a SCA or SCP cutting the desired files or folders onto the SCM clipboard, and then pasting them elsewhere. This would remove the intended objects from the original location and create them at the target location. The user must have write permissions at the target location. Linking objects to others in the document management system involves a SCA or SCD cresting a link between a new object and an already existing object. This would imply that there is only one actual copy of that object within the document management system and the link or links are reflections of that. The user must have write permissions at the target location. These operations can he performed on several levels including single and multiple files as well as folder hierarchies.

Still referring to FIG. 2, the following items are detailed requirements for the Search process of the system. This process involves an embodiment user executing an advanced search by specifying search criteria including: metadata, keywords, phrases, match case, wild cards and check out status. The search results are displayed on the results page. On the results page the user can save the search by specifying a name for the saved search. The user can execute saved searches from the saved search tab of the advanced search screen. On the search results screen, the user can select a file and perform library actions such as, export, check out, check in, etc.

Still referring to FIG. 2, the following items are detailed requirements for the process of differencing and/or merging objects in the system. These processes involve a system user performing difference operations or merges on source code or other project-related objects in the document management system using a difference/merge tool of their choice.

Still referring to FIG. 2. Source Code Differencing allows an SCA or SCD to view two files simultaneously, or side-by-side to determine the differences between the files. Two primary ways of viewing the differences are textual and visual. The textual difference shows differences such as white spaces and content changes. Visual differences highlight content that has been added, edited or removed between two versions of the same file using different colored fonts and other formatting. A difference can be performed on two distinct versions of the same file or two distinct files on the document management system or a file in the document management system and a file on the local system.

Still referring to FIG. 2, Source Code Merging allows an SCA or SCD to compile the contents of two files into one file. In order to perform this operation the user has to select the two files to merge, and identify one as the Merge Target, i.e., the file into which the contents of the other will be inserted appropriately. The user can choose to perform a merge operation on separate files in the document management system or two branches of the same file. This is in case a file had been branched out earlier and needs to be brought back to the main branch. The Difference/Merge tool is an external application that is very loosely integrated with the embodiment. Due to the integration, the embodiment can launch the tool and automatically load the selected source files or other files into it for differencing and/or merging.

Still referring to FIG. 2, Source Code Developers use the IDE application for software development needs. The IDE enables the developers to view project hierarchy as well as individual source code content, edit, compile individual source code files and perform builds of entire source code project. IDE also provides context sensitive help and code completion for specific programming languages. The popular IDE among Java/J2EE developers is the Eclipse IDE. This is an open source IDE available for download from www.eclipse.org. The embodiment provides integration with the Eclipse IDE for primary functionality such as check in, check out, cancel check out, import, etc., on a file level as well as hierarchically. Additionally, one embodiment provides the same functions to other IDEs prevalent in the industry. From within the embodiment, the user should be able to launch the IDE for source code file edit operations. This can be achieved by mapping file types (formats such as .java, .jsp) to the IDE application from within the Preferences section of the embodiment. When such mapping exists and the user chooses to edit a source code file, the file is checked out by the embodiment, downloaded to the user's working directory and loaded in the IDE. The file is then available for edits in the IDE. For source code files that are already available in the users' working folders in the local file systems, the user should be able to select a particular file (within IDE) and be able to check it out to perform edits on it. This operation is initiated from the IDE and the embodiment should be able to recognize the source code file's appropriate location in the SCM Project, and check it out from the embodiment (by getting the latest version from the SCM and enabling write permissions on the local file system). The user has to be authenticated before the check out operation is performed. The information pertaining to the project and included source code files (its permissions, document management system location, etc.) should be locally stored on the file system and should be validated by the embodiment before the operation is performed.

Still referring to FIG. 2, after the file has been edited in the IDE, the user should be able to either cancel the check out action or check it in from within the system. This again should utilize information about the source code file stored in the local file system to be able to perform the appropriate SCM action. To perform SCM actions from the IDE, it is not necessary for the system to be open in the browser. Necessary integration processes have to be running or launched on demand to perform these operations.

Still referring to FIG. 2, the following items are detailed requirements for the SCM Access process of the system. This process involves an SCA or SCD launching a Web browser and entering the Universal Resource Locators (URL) to access the SCM application. The user must have a valid login identification (ID) and password setup for accessing the system. On successful login, the start page is displayed according to user preferences. If the user preference is not set up, the default page is displayed, which could be the Project/Folder View. If the provided login ID and password combination is invalid, an error message is displayed on the same login page. The user can access an SCM action directly through a URL. The URL should include the fully qualified component name and its associated parameters. Documentum™ WDK (Work Development Kits) Applications (SCM is a Documentum™ WDK Application) allows direct access to its components only after the authentication process. Therefore, directly accessing the component action would still display the login page. After the user successfully logs in, the user is redirected to the component that she originally requested and the component action is executed and the results displayed. The user can access the embodiment from command line. All the options provided by the GUI can be passed as arguments.

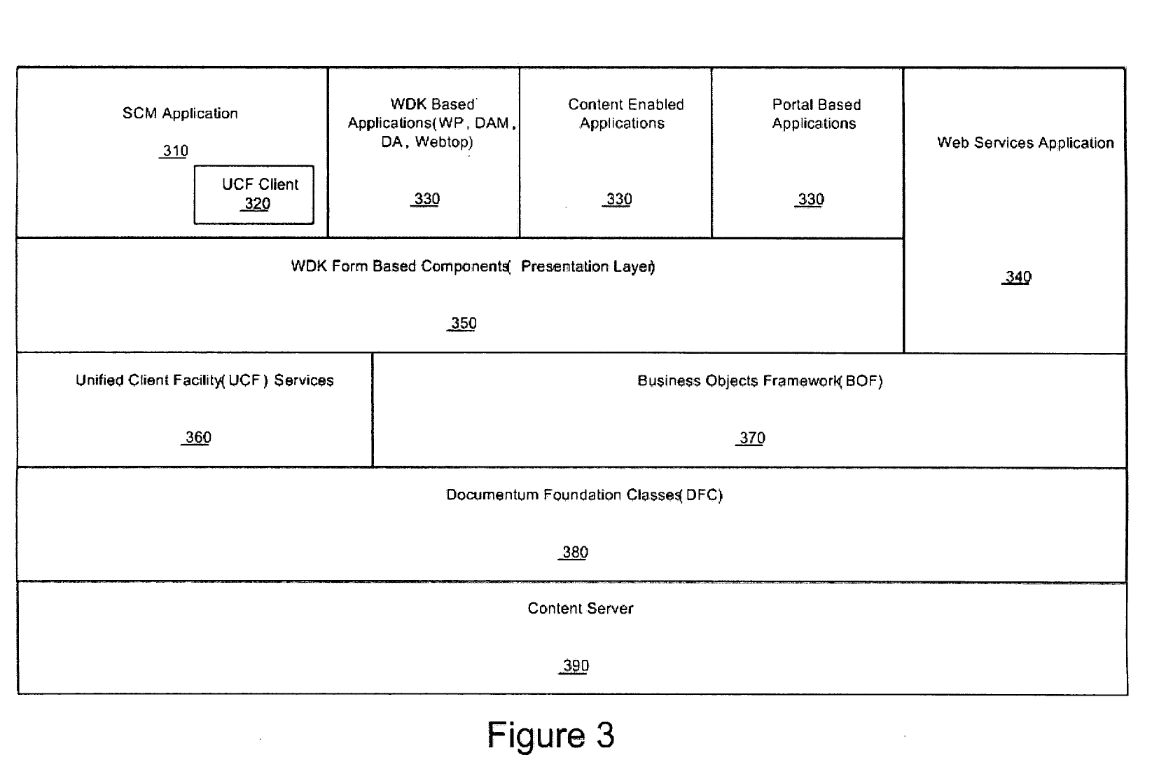

FIG. 3 displays the technical context of one embodiment of a system in accordance with the present invention, namely, the source code management application, or SCM application 310. Included in the SCM application 310 is a unified client facility client, or UCF client 320. The SCM application is configured as a WDK application, fitting within the framework of other dedicated WDK based document management applications 330 (like that produced by Documentum™). Examples include software produced by Web Publisher™ (WP), Digital Asset Manager™ (DAM), Document Administrator™ (DA) and Webtop™, as well as content enabled applications and portal based applications.

The SCM application 310 utilizes the UCF client 320, integrating source code and web content release management. Source code objects and content are stored in a repository, which may include the content server 390. Business and web component objects use the Document Foundation Classes, or DFC 380. The unified client facility services, or UCF Services 360, serve as a communication channel between the client and server, encapsulating details from the original request handler. Source code management logic is associated as business objects within the business objects framework, or BOF 370. The WDK form based components (Presentation Layer) 350 are an available standard set of components. Certain web content management services are available as web services within the web services application 340.

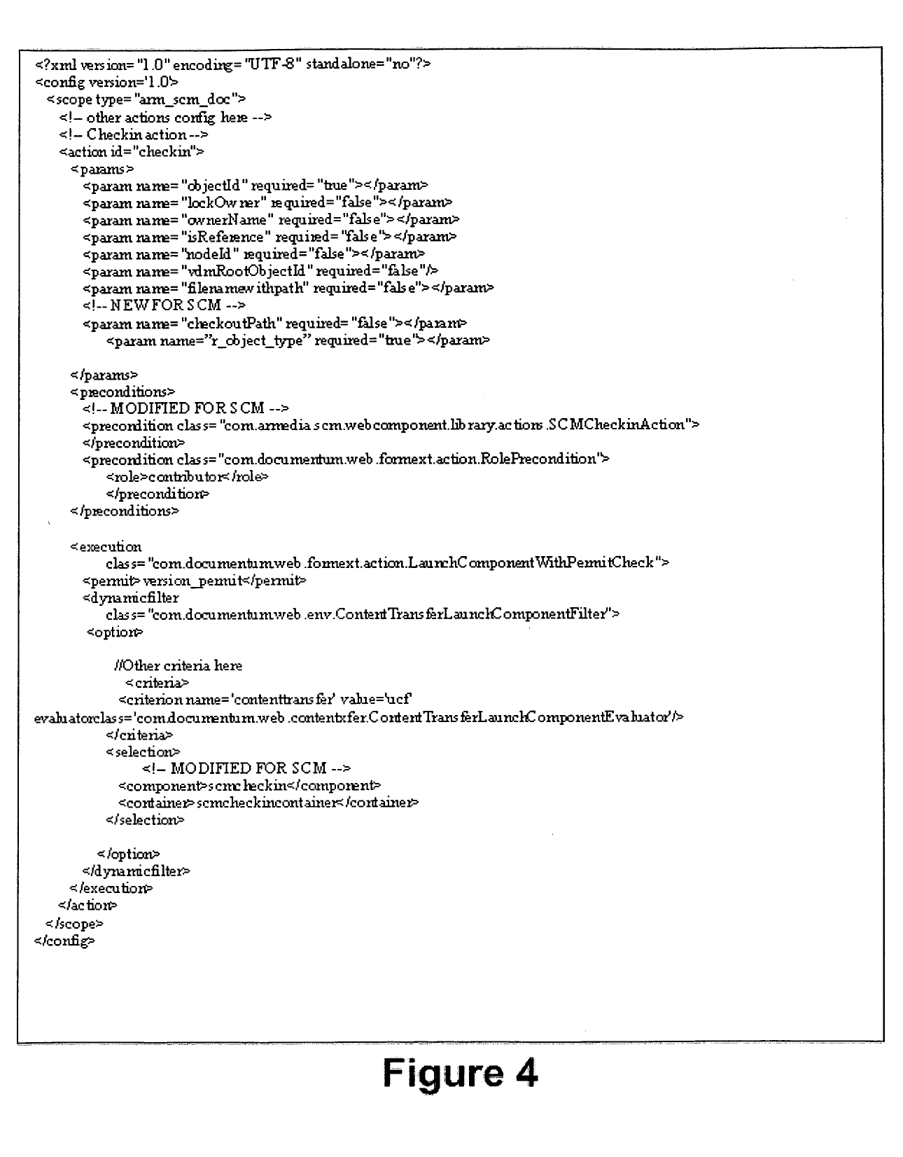

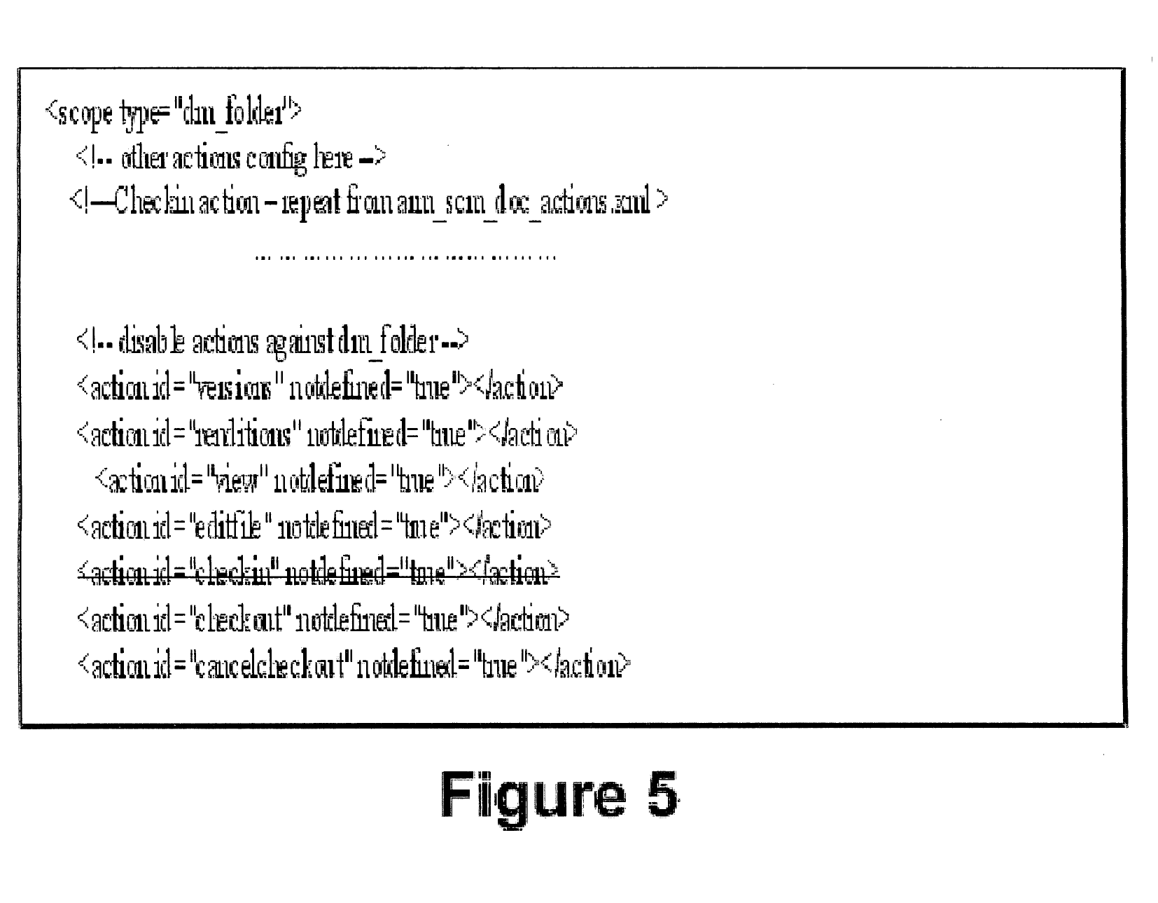

Explanation of one embodiment is included in the following Example, and FIGS. 4-16.

### EXAMPLE 1

Functional Requirements

The following items are detailed requirements for the process of checking in objects into the Embodiment. This process involves an SCA or SCD checking in source code or other project-related files that she had previously checked out, in order to edit their source code.

During check in, the user should also choose how to apply version labels to the objects being checked in. such as major versions, minor versions, and text labels.

The user can also opt to apply comments to the object(s). The user should not be able to change the name of the file or the format, hence these fields are made uneditable (read only). During check out, the working folder structure resembles the folder hierarchy in the document database. In other words, the folder hierarchy in the document database becomes the folder tree relative to the project working folder. At the time of check in, the file is retrieved from this local hierarchy for checking in. Alternatively, the user can choose to pick the file from a different location.

The user has some more options while checking in a document such as retain lock, make current version, keep a local copy after check in and subscribe to this file.

The check in operation can be performed on several levels including single and multiple files, as well as single and multiple folders and folder hierarchies.

Additional options include the ability to perform this operation from the command line with all the appropriate command line options including document management system authentication parameters, username and password, the source location on the document management system, local directory, file/folder name, document database folder, check in comment, version information, and whether or not the check in operation is recursive.

### EMBODIMENT APPROACH

According to the available Documentum Release of WDK 5.3 and the WDK/Webtop 5.3 Design Specification, there is a service layer which comprising three parts: ContentTransferService class, Service Processors, and Content Transport.

In one embodiment, the ContentTransferService class may be used without modifications. In one embodiment, a specific implementation of the ContentTransferService for the check in operation is called CheckinService. A processor implementation for the Checkin component is called the CheckinProcessor. The Content Transport encapsulates logic that deals with the transport mechanism (HTTP or UCF). HTTP is Hyper Text Transfer Protocol. In one embodiment, the transport mechanism used is UCF transport.

The custom SCM object types are designed and shown in other parts of the SCM Design Documents.

Technical Design

The embodiment check in functionality extends the existing check in functionality in the following manner:

GUI

A shortcut option is provided on the content pane for the Checkin action, which is accessed from the menu bar.

Actions

XML Configuration: A new SCM configuration, arm_scm_doc_actions.xml, is created based on the configuration in dm_sysobject_actions.xml and placed in the SCM layer. This configuration applies to arm_scm_doc object type.

A new required parameter check out path is added to this configuration. This attribute should also be added to arm_scm_doc.

arm_scm_doc_actions.xml is the configuration file for actions of the type arm_scm_doc. This configuration file is located in scm\config\actions relative to the embodiment. The configuration for the check in action is shown at FIG. 4.

In addition, the dm_folder_actions.xml is extended and modified. The Checkin currently disabled for folders. The Checkin action should be defined in the modified configuration as shown at FIG. 5.

Pre-Conditions

A new precondition class, com.armedia.webcomponent.library.actions.SCMCheckinAction extend com.documentum.webcomponent.library.actions.CheckinAction. The queryExecute( ) method is overridden in the new class. In addition to the existing checks, it also checks if the object referred to by the object ID is of the type of arm_scm_project or dm_folder. The logic needs to check for non-folder objects, as it is doing currently. For folder objects, within the folder, query for files checked out by current user. If the query returns at least one document checked out by current user, return true. This change is intended to enable the Checkin action for folders and projects in addition to documents. The contents of the folder are actually checked in, not the folder itself. Currently, the RolePrecondition for check in is Contributor. For the embodiment, role precondition is used but SCM roles are mapped to existing roles.

Execution

The execution class LaunchComponentWithPermitCheck does not change.

In the filter configuration, check in component reference is replaced with scmcheckin component. The details of the scmcheckin component configuration are presented later in this document.

The desired functionality for the embodiment is handling of folder and project level check ins, in addition to file level check ins. Currently, the user should manually select each file if multiple files need to be checked in. For the embodiment, the user should be able to select folders/projects to check in. This selects all checked out files within the folder/project hierarchically that have been checked out by the current user (lock owner), and then checking them in one at a time. This logic should be handled by the precondition classes.

The execution class, SCMCheckinFolderExecution, implements IactionExecution. The execute( ) method creates SCMCheckin object instances and calls the execute( ) method of LaunchComponentWithPermitCheck.

Components

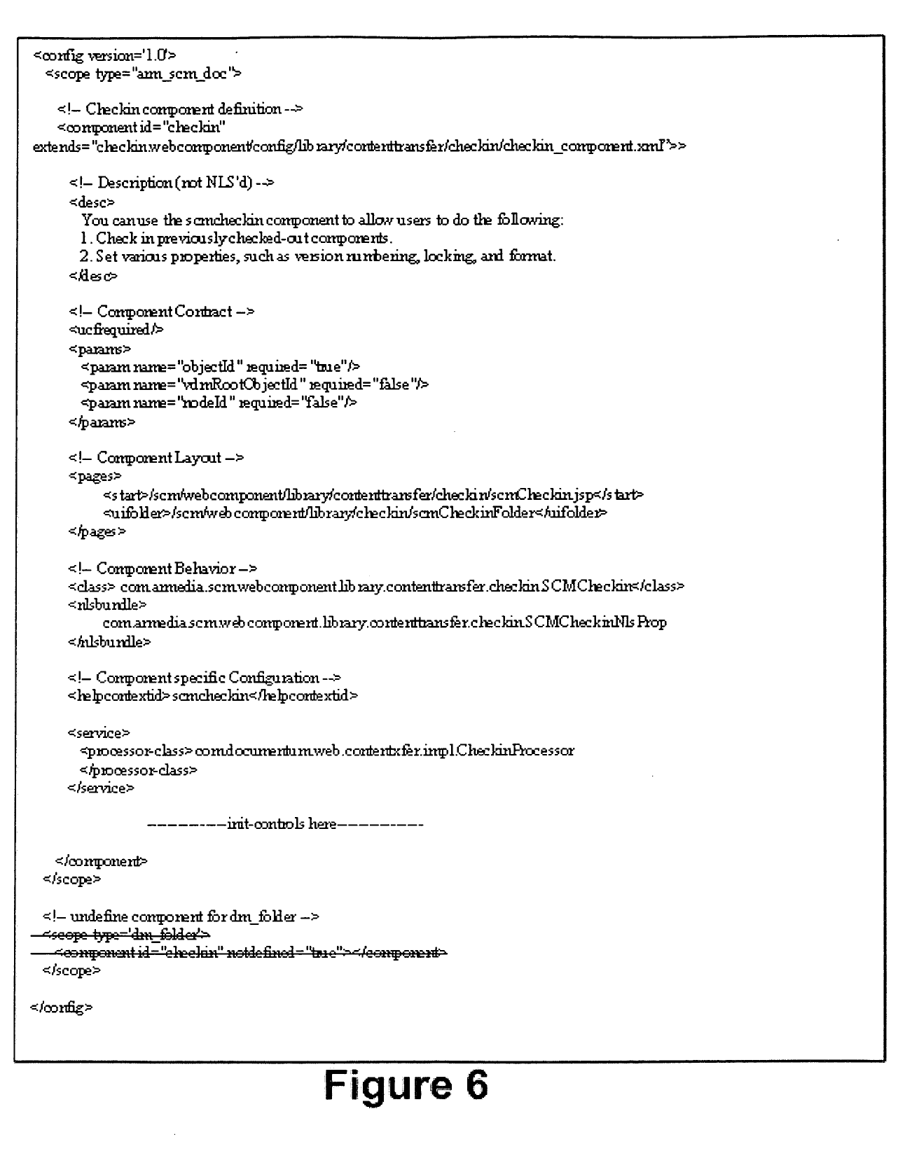

XMLConfiguration: check in_arm_scm_doc_component.xml is the configuration file for the check in_ammscm_doc_component. This configuration file is located in scm\config\library\check in relative to the embodiment. This configuration is based on the Checkin component configuration, as shown at FIG. 6.

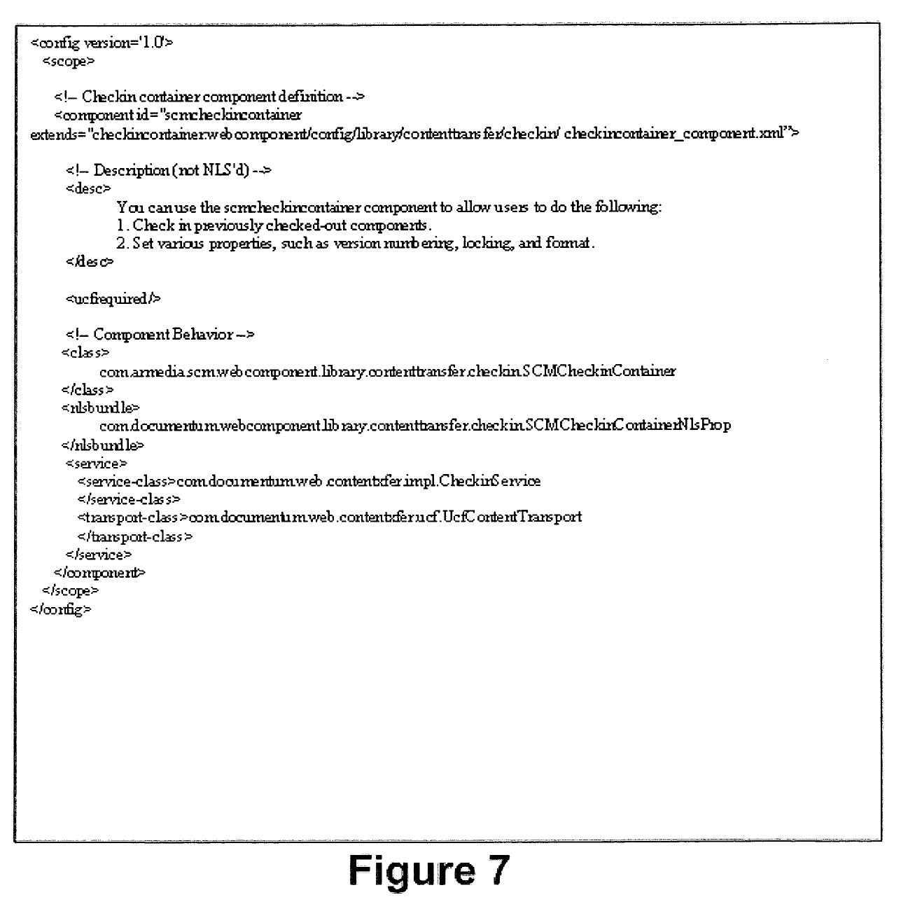

checkincontainer_arm_scm_doc_component.xml is the configuration file for the checkincontainer_arm_scm_doc_component. This configuration file is located in scm\config\library\check in relative to the embodiment. This configuration is based on the checkincontainer component configuration, as shown at FIG. 7.

JSP Pages

The checkin.jsp will be modified to scmCheckin.jsp in the scm layer. The desired changes are as follows:

1. The text field for displaying the filename needs to be modified to a header that shows the entire path of the file on the Docbase along with the filename. The user should not be allowed to edit the header or the filename.

2. The format of the file should be deployable (read only).

3. The default value for “keep a local copy after checkin” should be selected.

A new page, scmCheckinFolder.jsp, for folder level checkins is created. This screen should allow the user to apply common settings to all files hierarchically or give the option of editing the settings for individual files, one at a time.

Behavior Classes

The behavior class for scmCheckin.jsp is SCMCheckin and extends from Checkin. This handles folder level checkins too. The CheckinContainer is extended to SCMCheckin Container.

The behavior class for scmCheckin.jsp is SCMCheckin and will extend from UcfCheckin. This will handle folder level Check Ins too. The Checkin Container will be extended to SCMCheckinContainer.

The onInit( ) method in the SCMCheckin component will check to see if the documents being checked in are files or folders. If files are being checked in, the scmCheckin.jsp is displayed otherwise scmCheckinFolder.jsp is displayed. In this case, the Check In parameters are obtained and the actual files from within the folder are identified for Check In. The container has to extract all objects based on r_object_id (which is the identification of the folder selected) and internally construct an array list of object IDs of the documents that the folder contains. Based on the query results for documents contained in the folder, the on NextPage( ) method has to instantiate that many SCMCheckin components (from now on it is all files, no folders). After this, the documents can be checked-in as it currently exists.

As per WDK/Webtop 5.3 Design Specification, the Check In functionality in the service layer will be composed of three parts—CheckinService class, CheckinProcessor, and UcfContentTransport. The CheckinService will have a DFC Check In operation associated with it. Each CheckinProcessor instance packages the file parameters and invokes the DFC Check In operation with these packages.

The CheckinContainer's methods will be responsible for
Getting contained components;
Getting processor;
Setting properties; and
Executing the service.

For SCM, the steps involved in the Check In process are as follows:

1. On invoking the Check In action, the SCMCheckinContainer will be created and launched. In its onInit( ) method, it will create SCMCheckin component instances depending on the number of files being checked in.

2. The user will then set Check In properties for each object being checked in and finish.

3. Upon finishing, the SCMCheckinContainer will create a CheckinService class instance.

4. The SCMCheckinContainer will also create an UcfContentTransport class instance.

5. The container will then iterate through each contained components. Each component creates a CheckinProcessor instance and sets all the appropriate properties on it, like object id, version, label etc. There will be one CheckinProcessor instance per SCMCheckin component. For Check In, no changes are anticipated in the CheckinProcessor. The file path for the document will be captured by the registry, and this information can be retrieved using the object id by the CheckinProcessor. There will be some server side pre-processing before the actual content transfer like content analysis, gathering registry information etc.

6. The container will then create a list of these processor instances and set it onto the service class instance. At the end, the service class method for Check In will be executed.

7. There will be some server side post-processing after content transfer that would interact with DFC to execute any registry instructions or to do other cleanups. As part of post-processing, the local copy of the checked in file should be made read-only.

NLS Entries

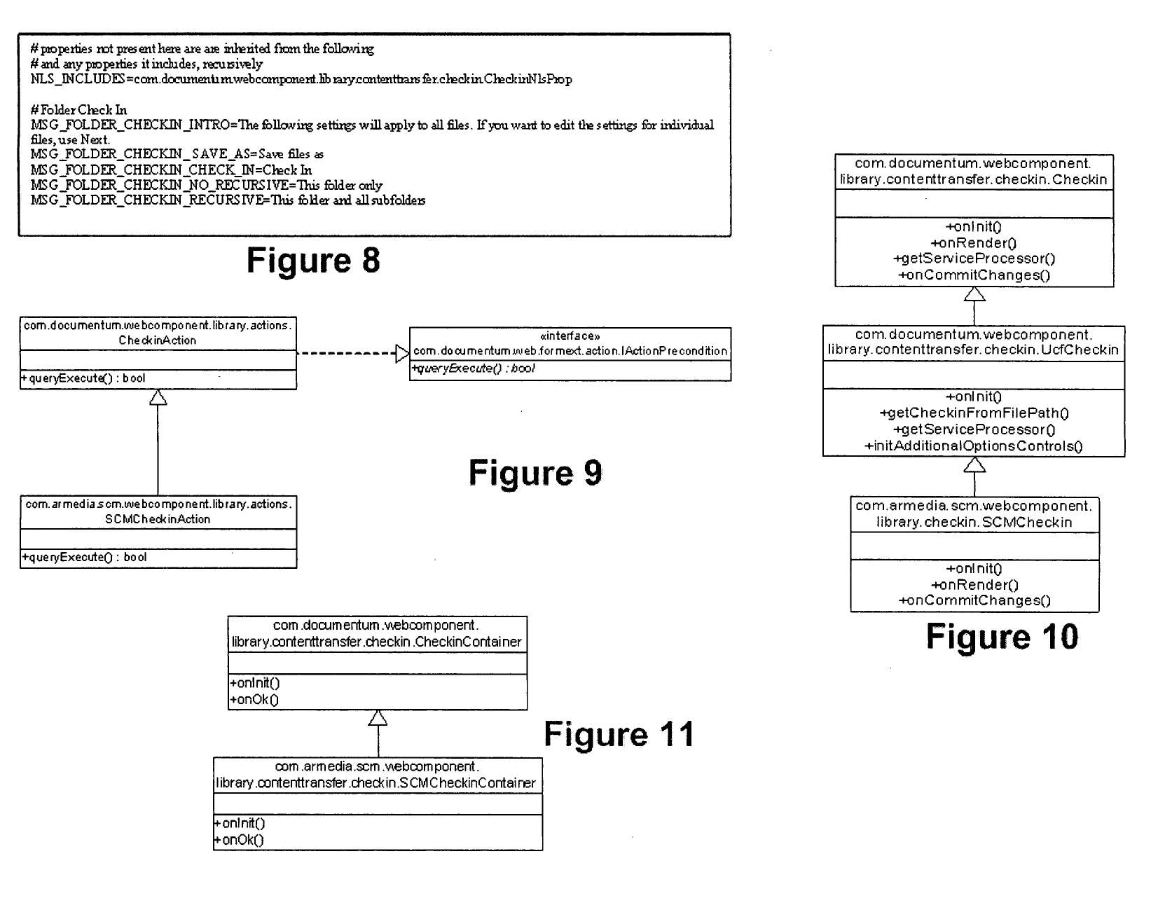

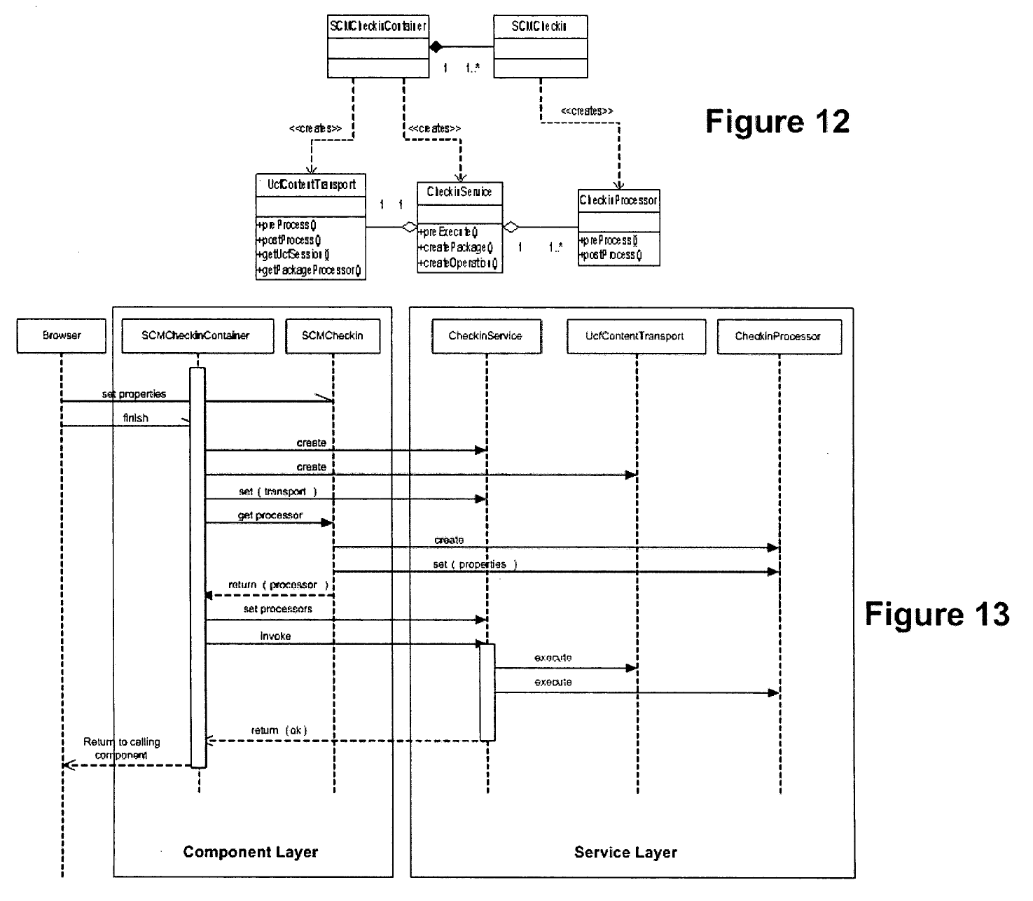

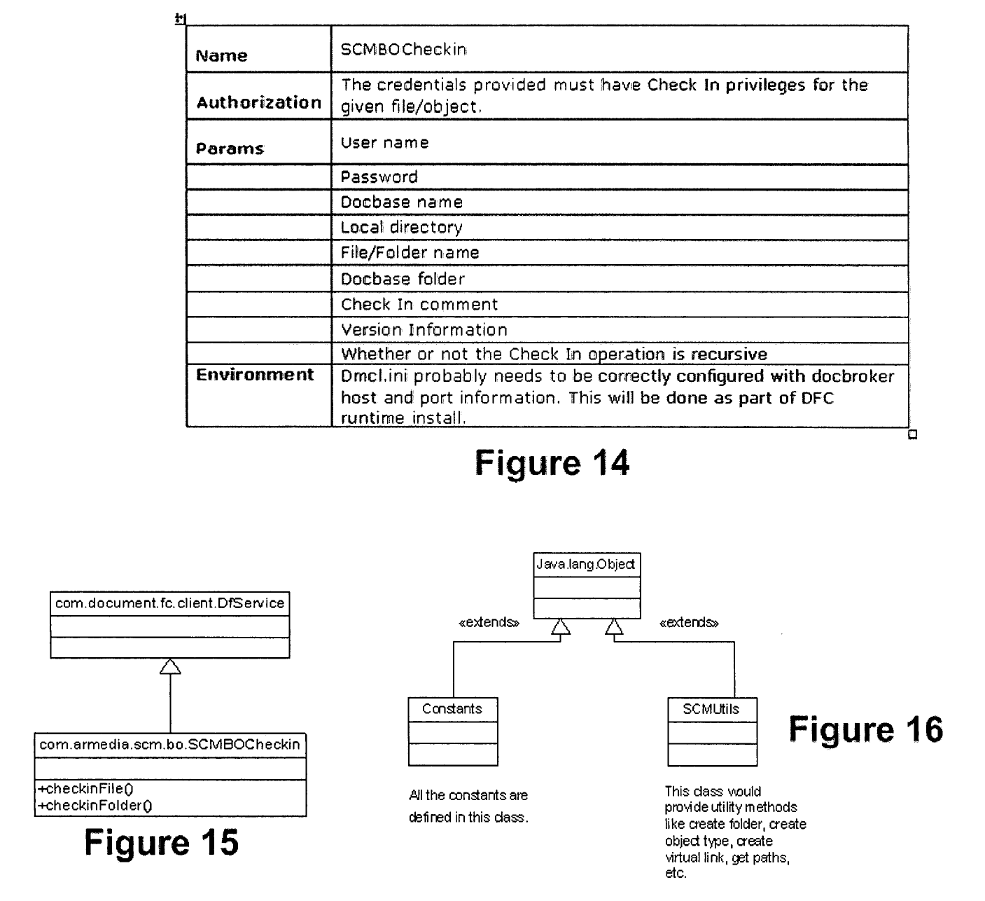

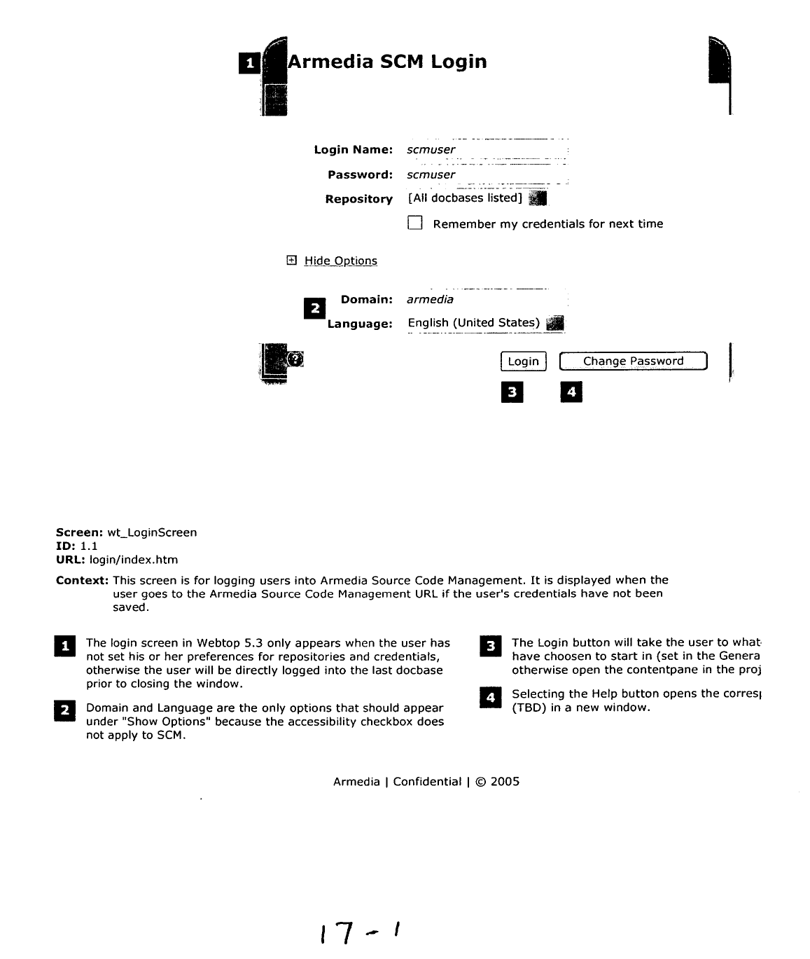

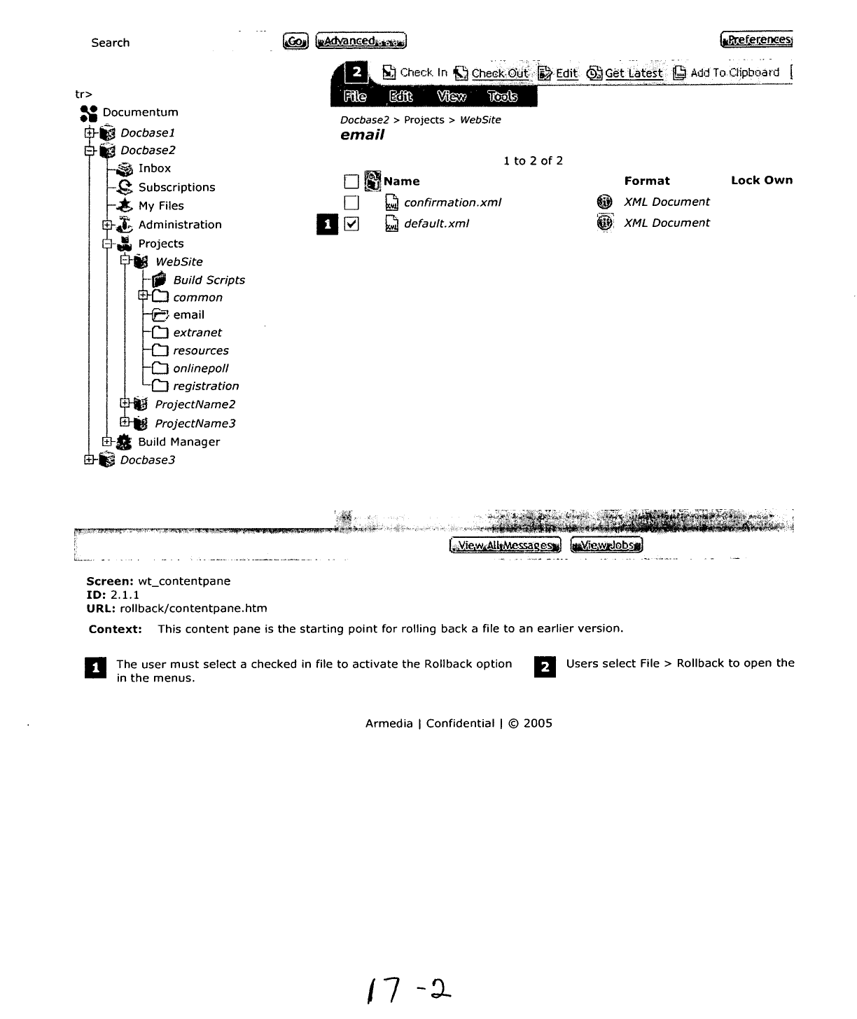

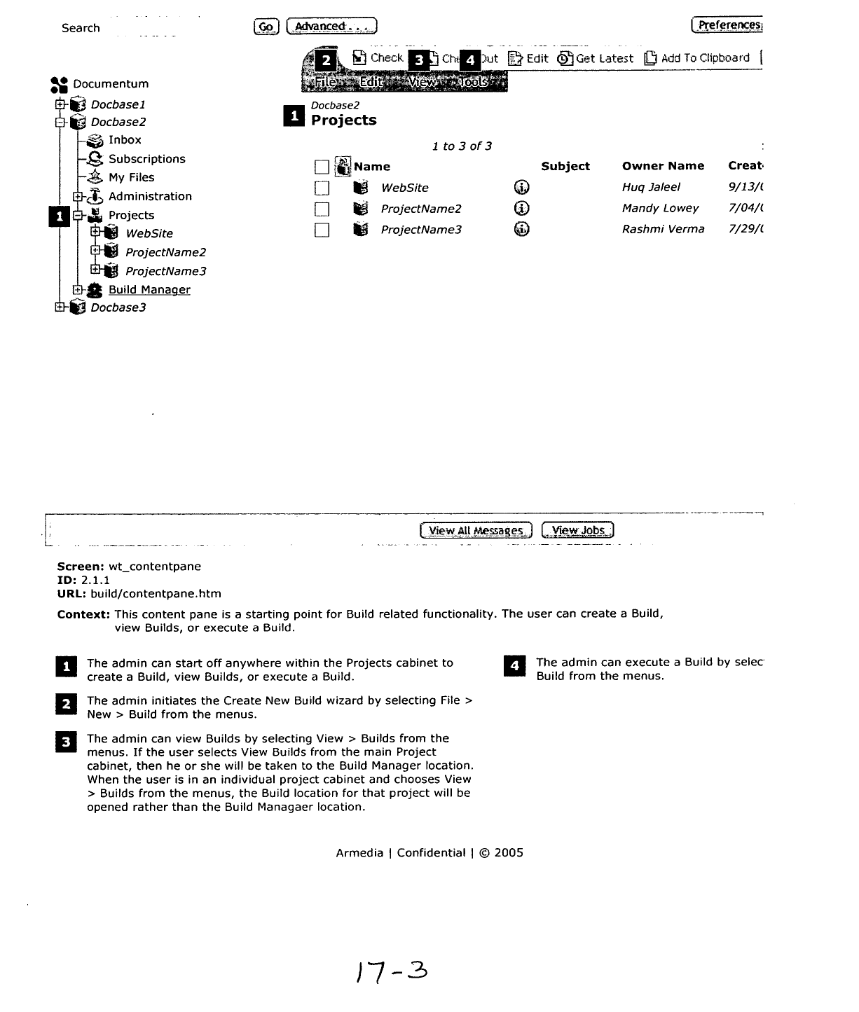

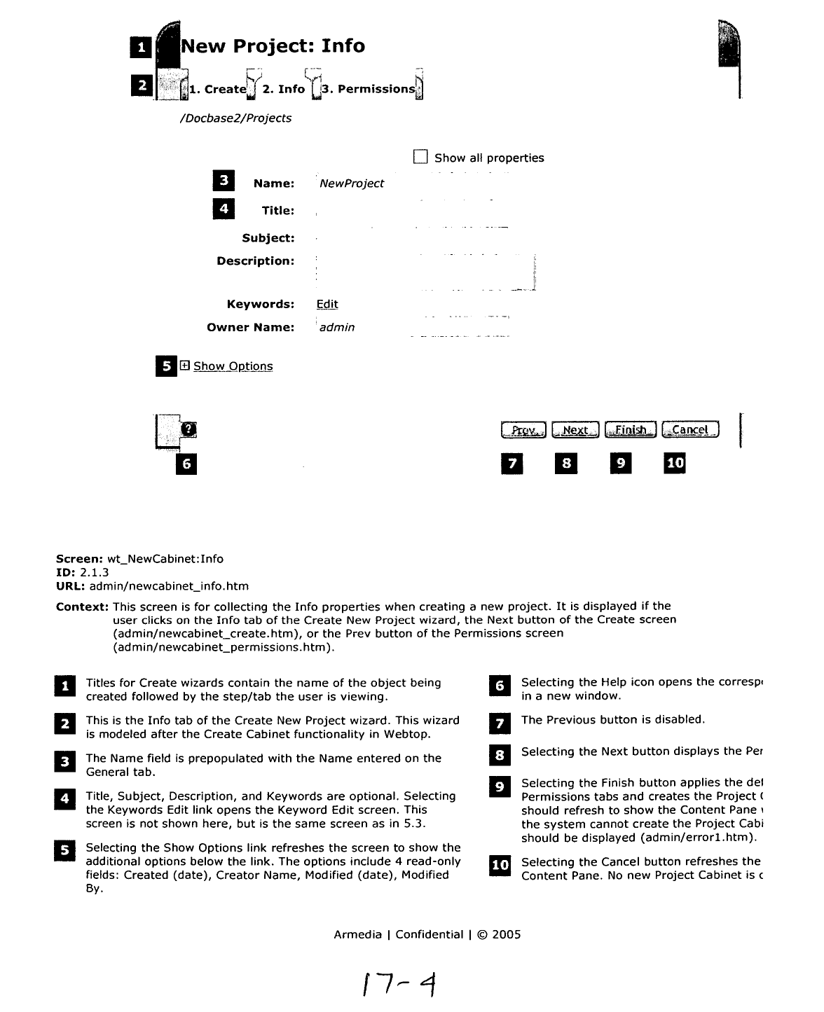

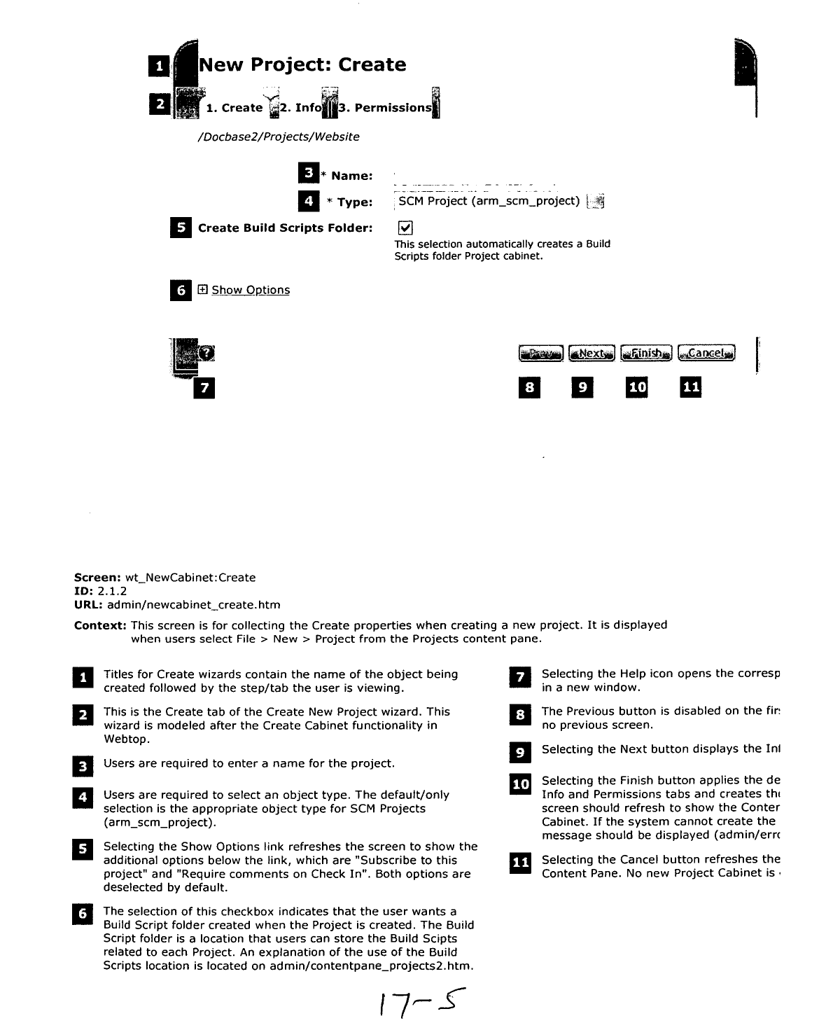

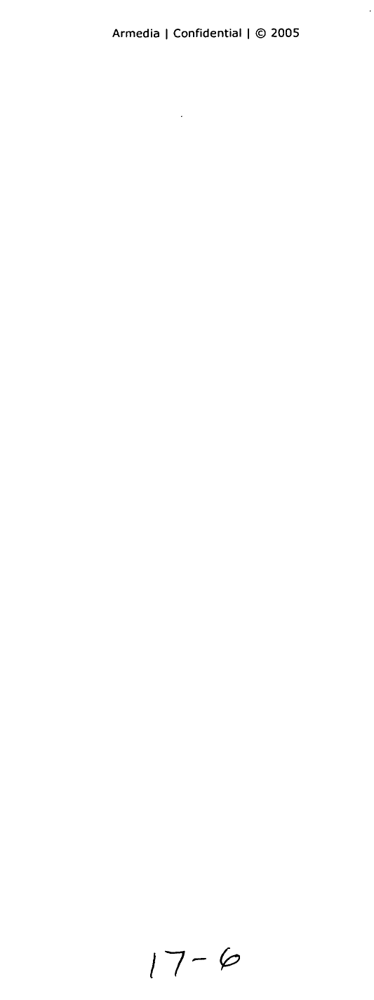

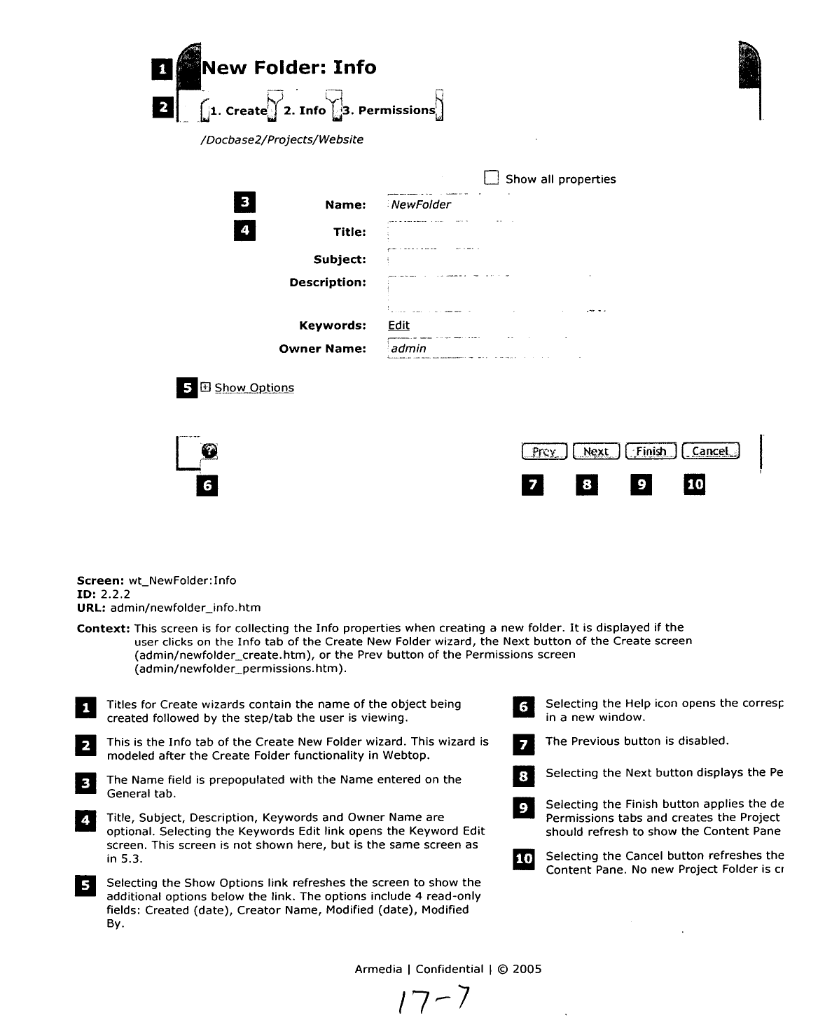

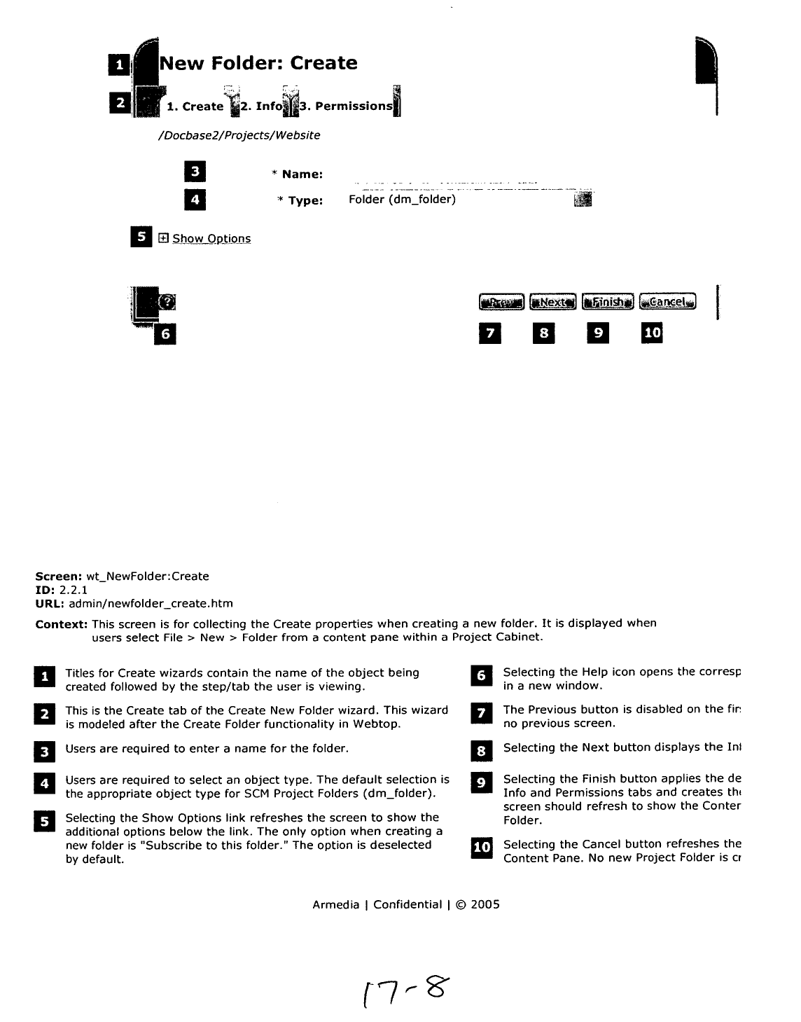

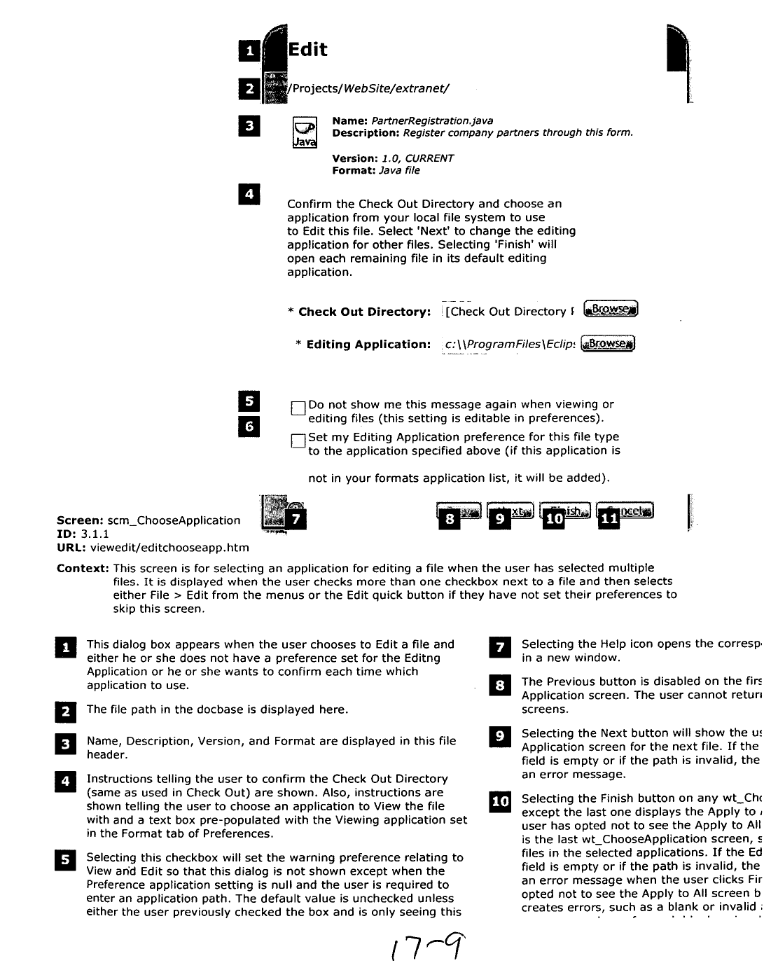

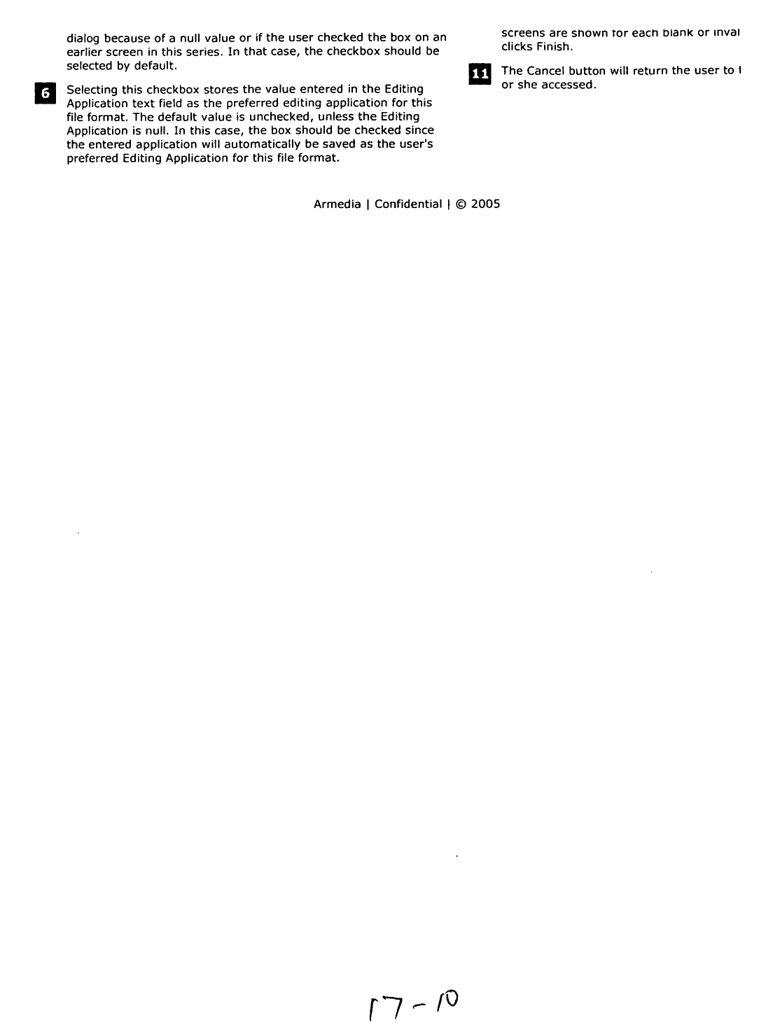

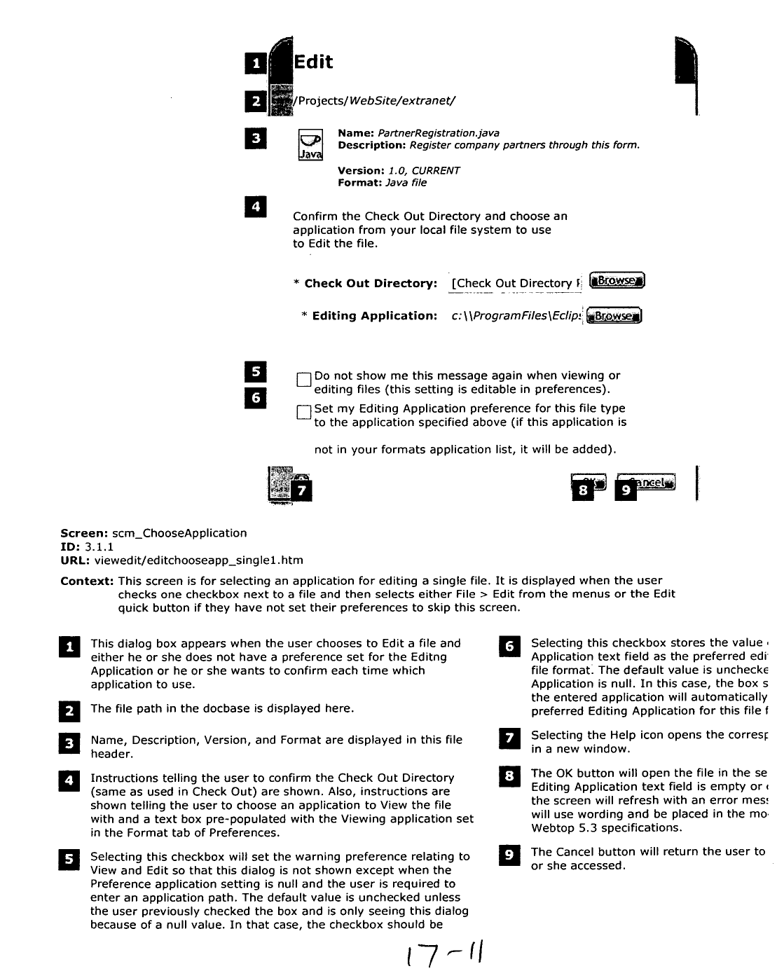

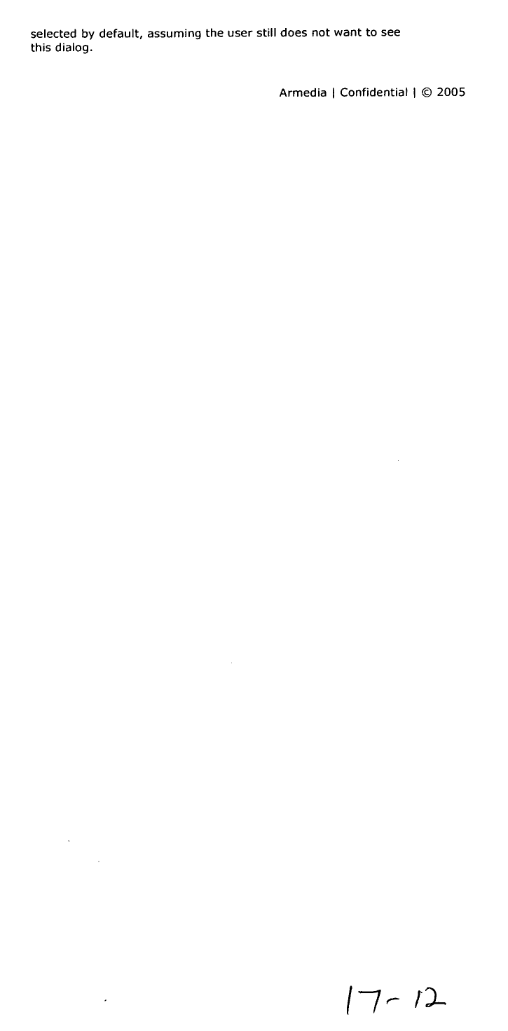

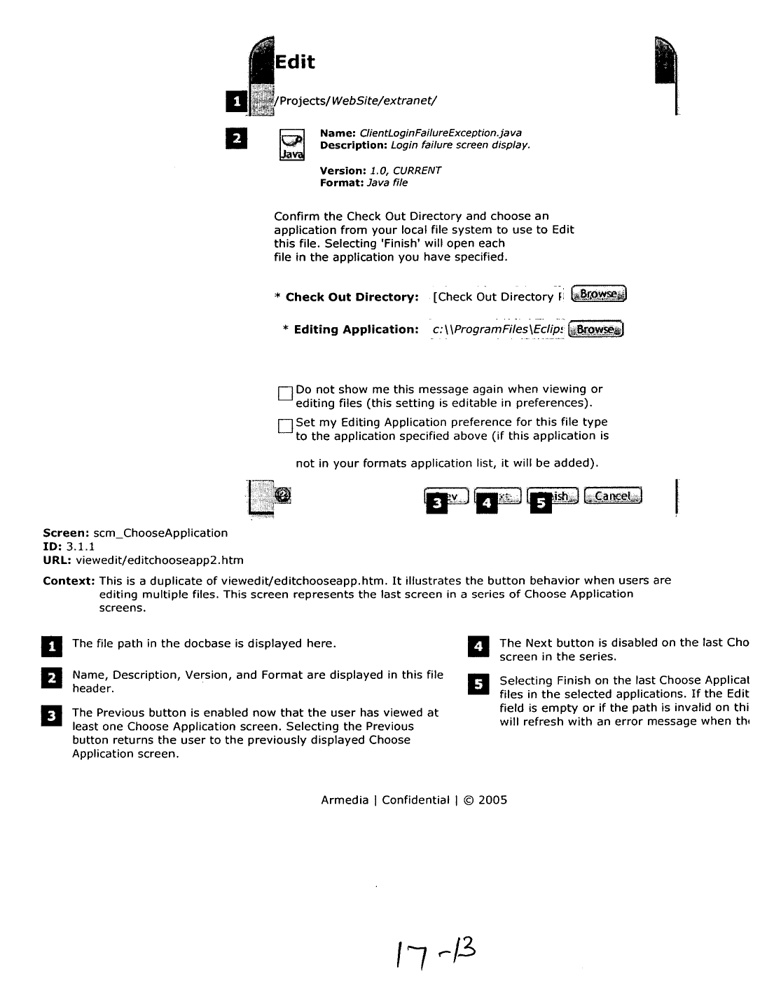

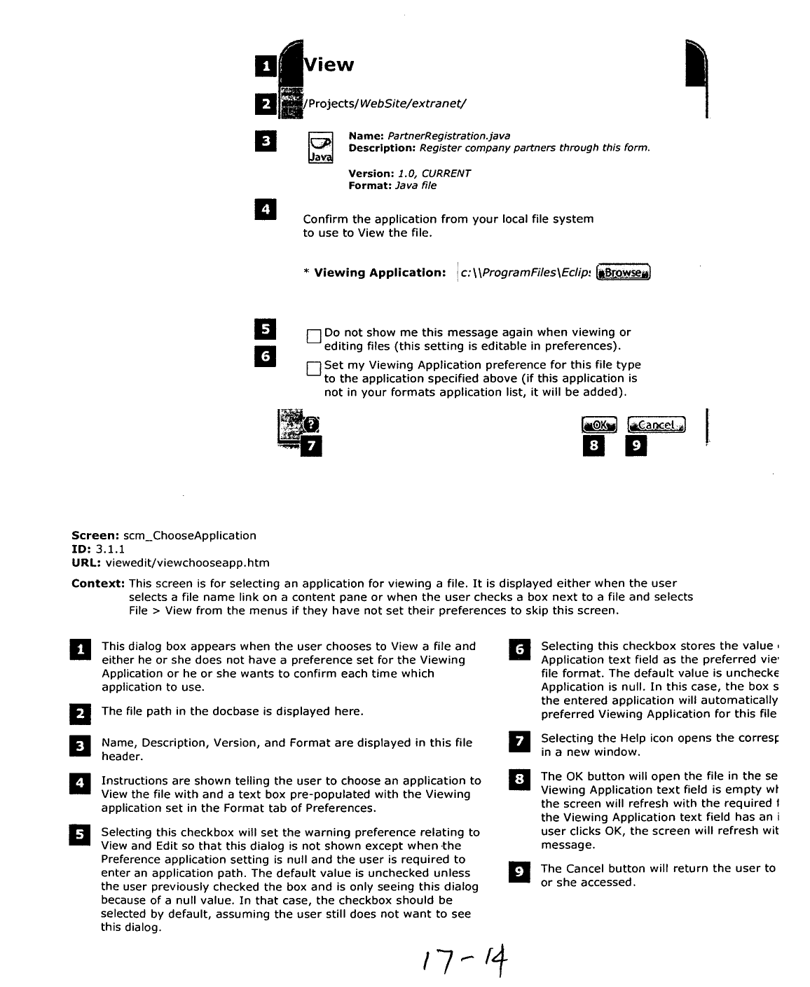

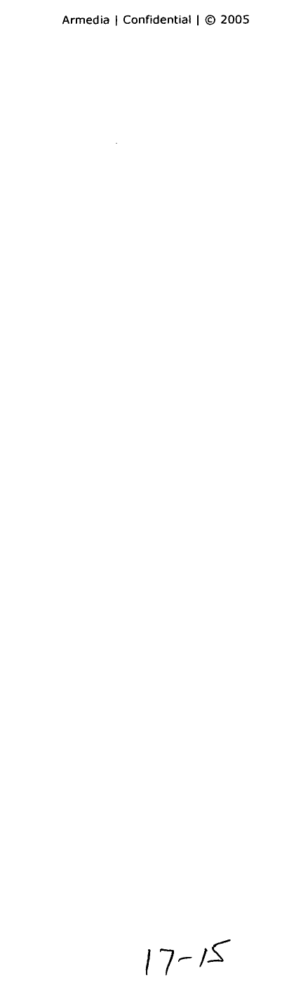

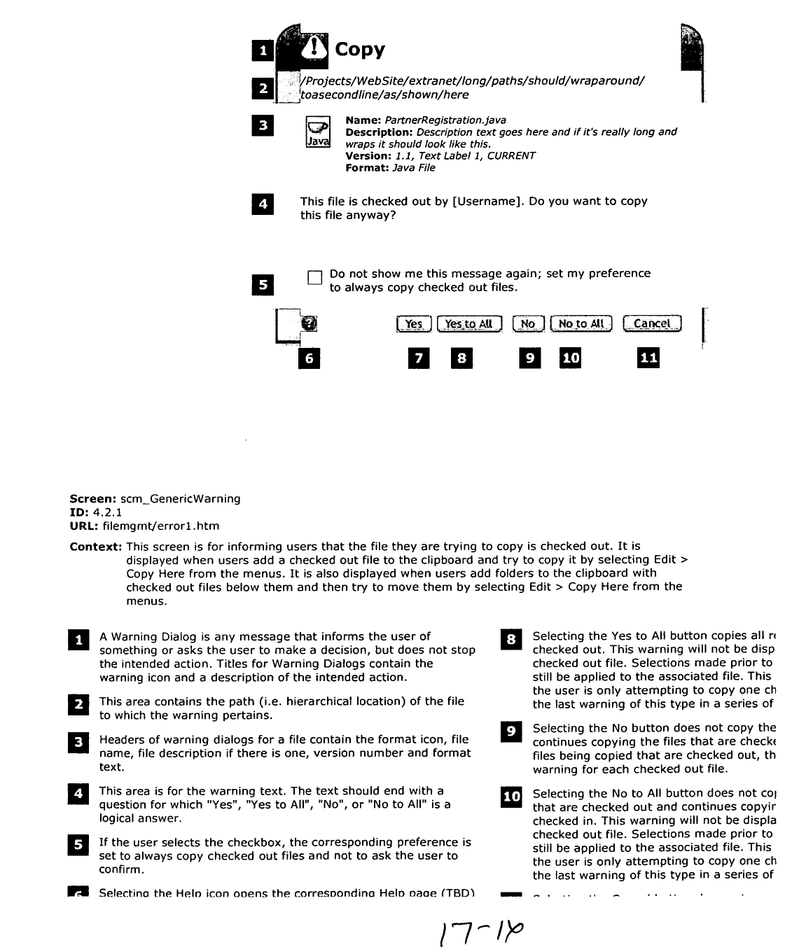

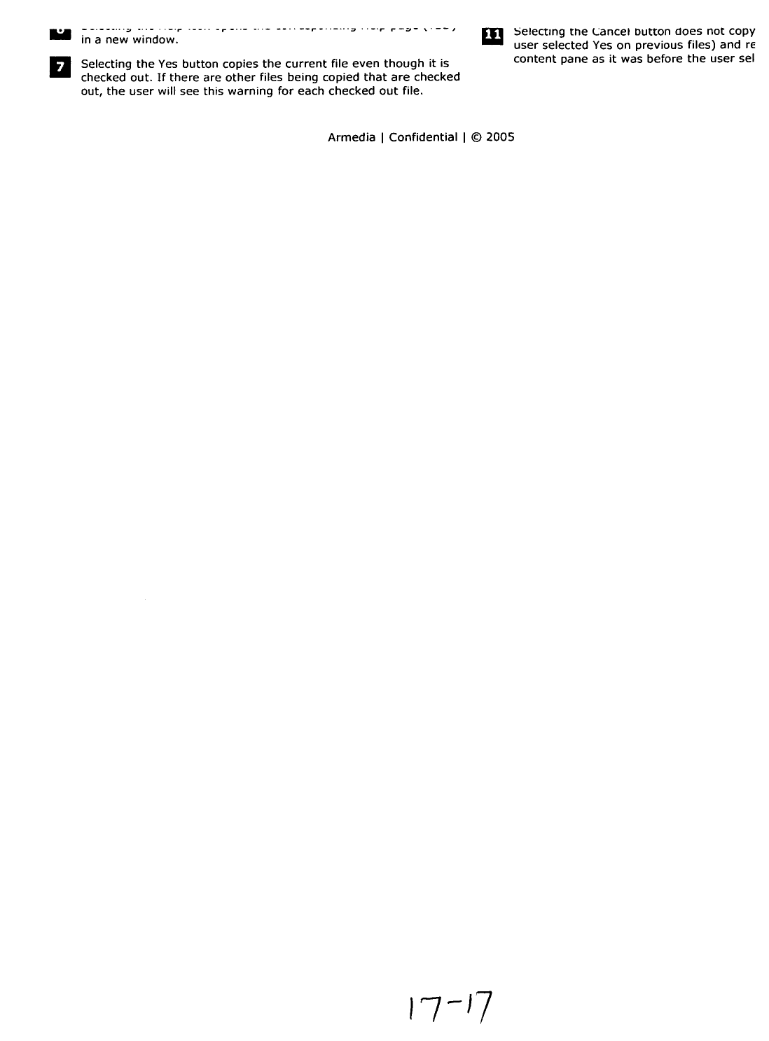

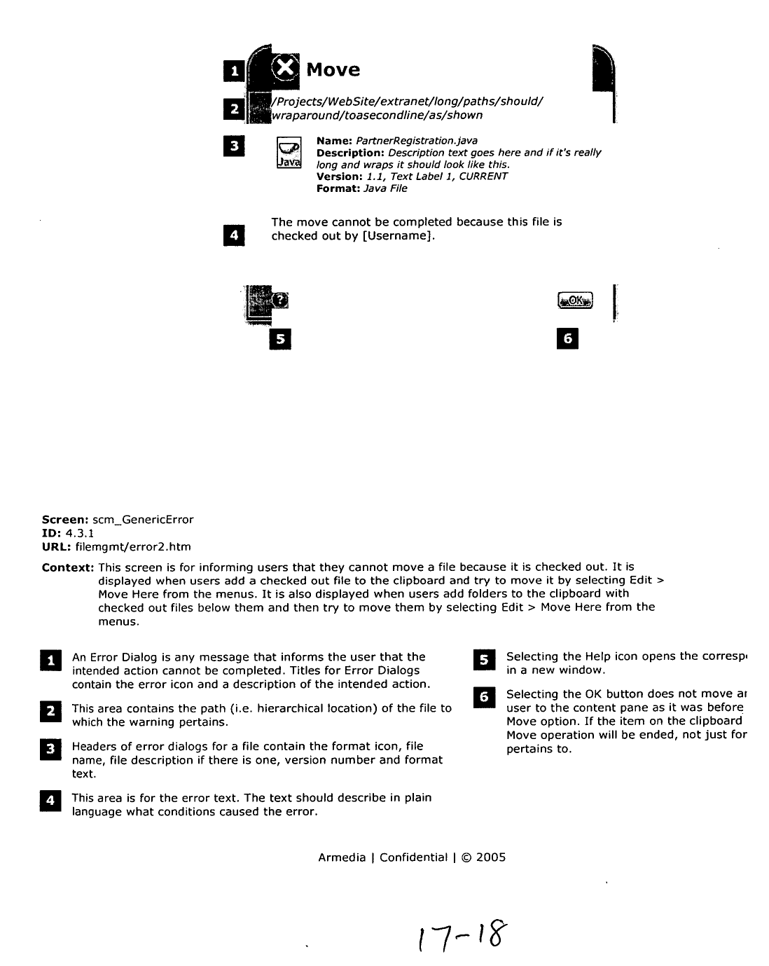

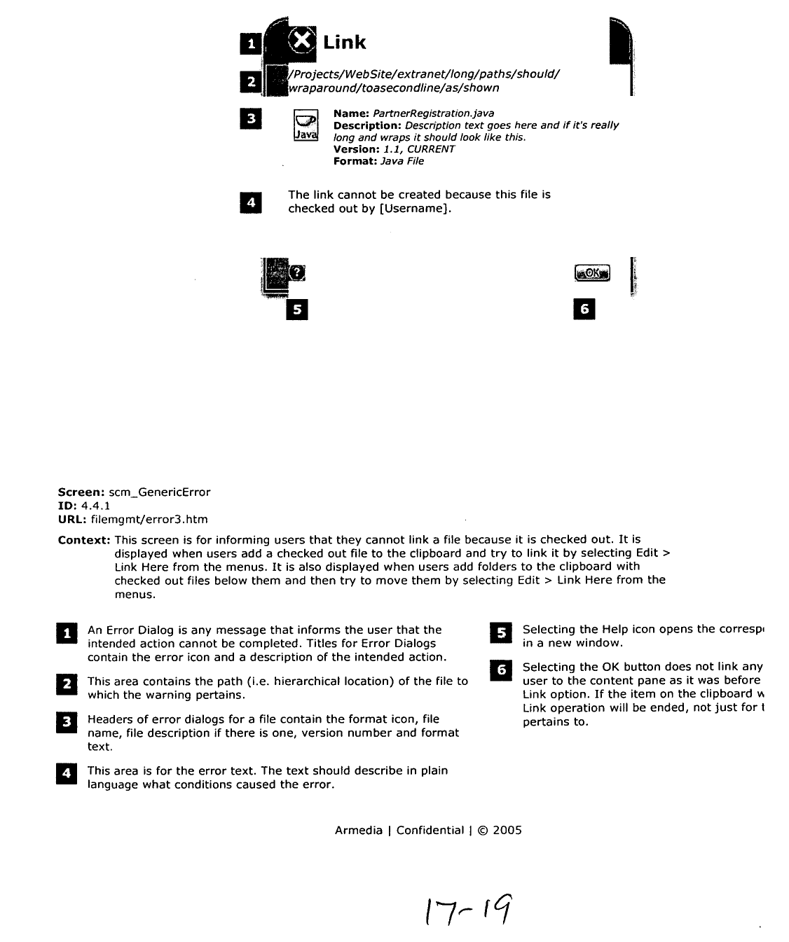

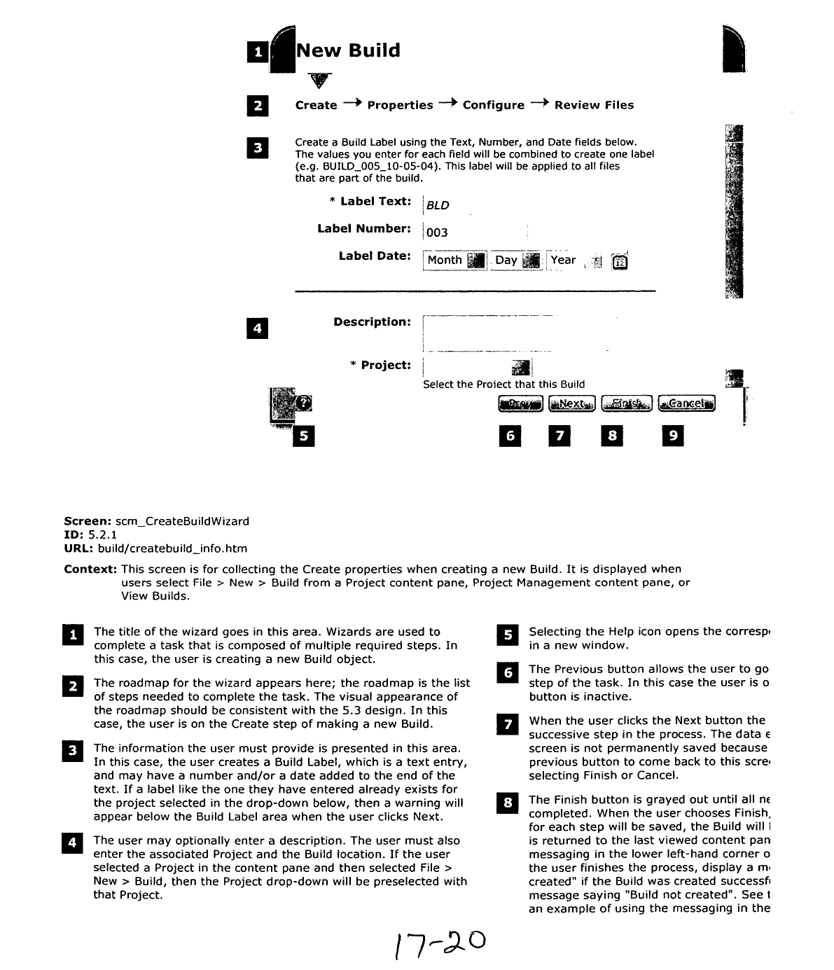

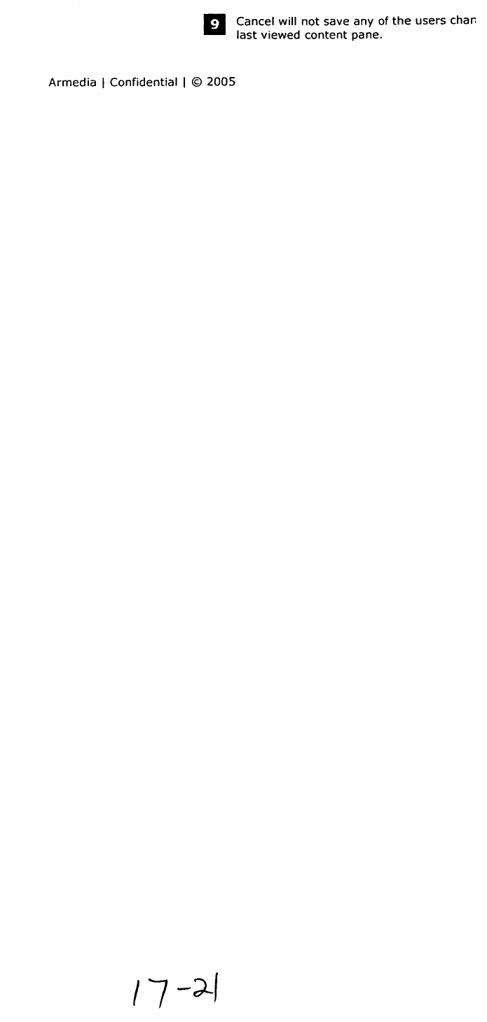

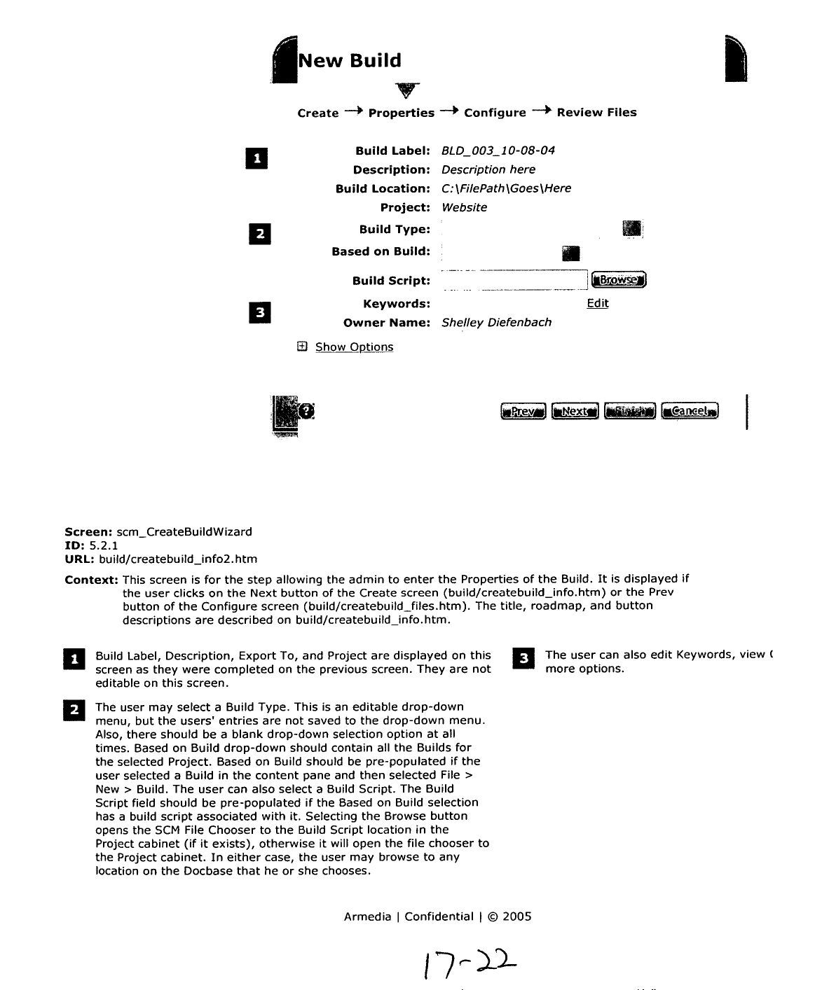

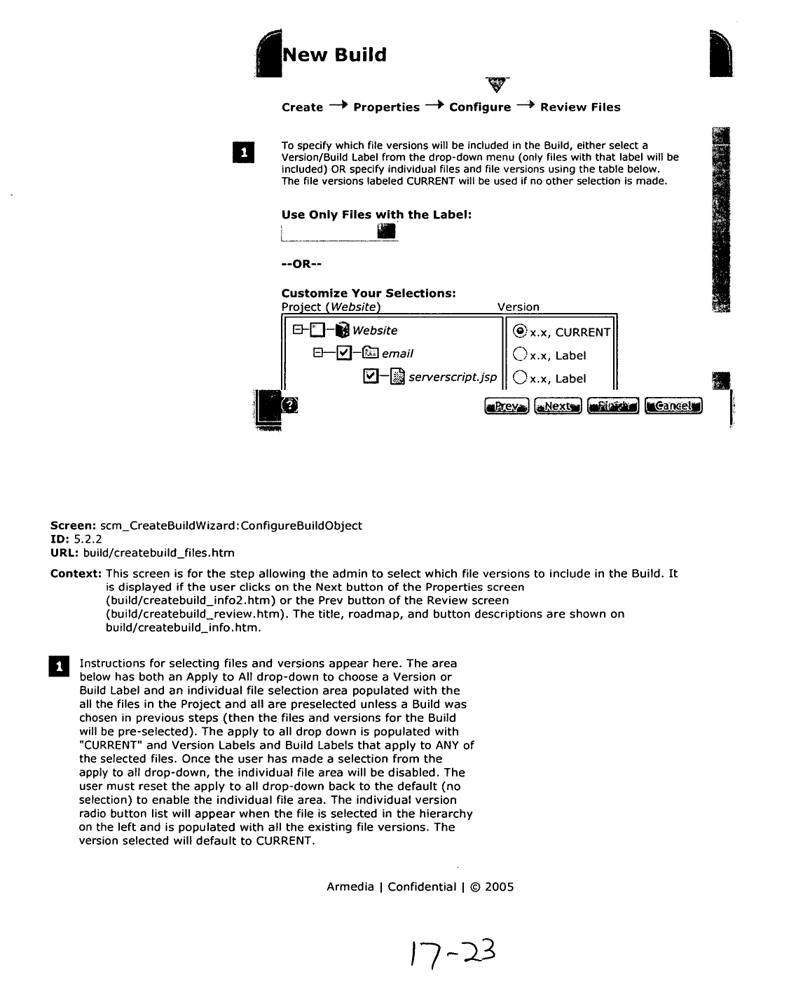

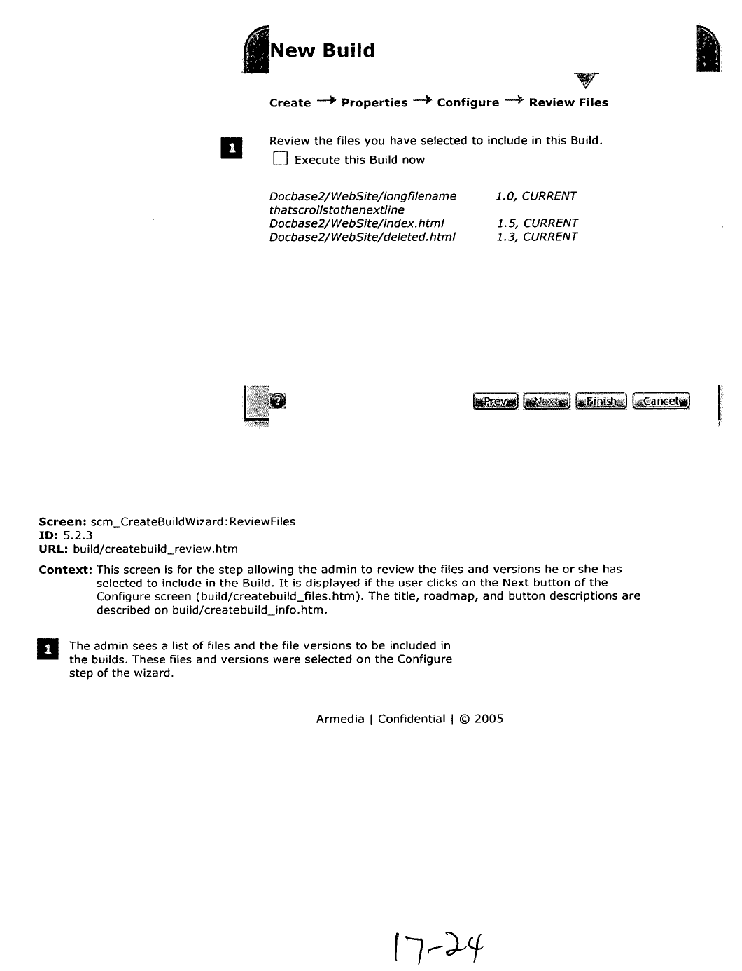

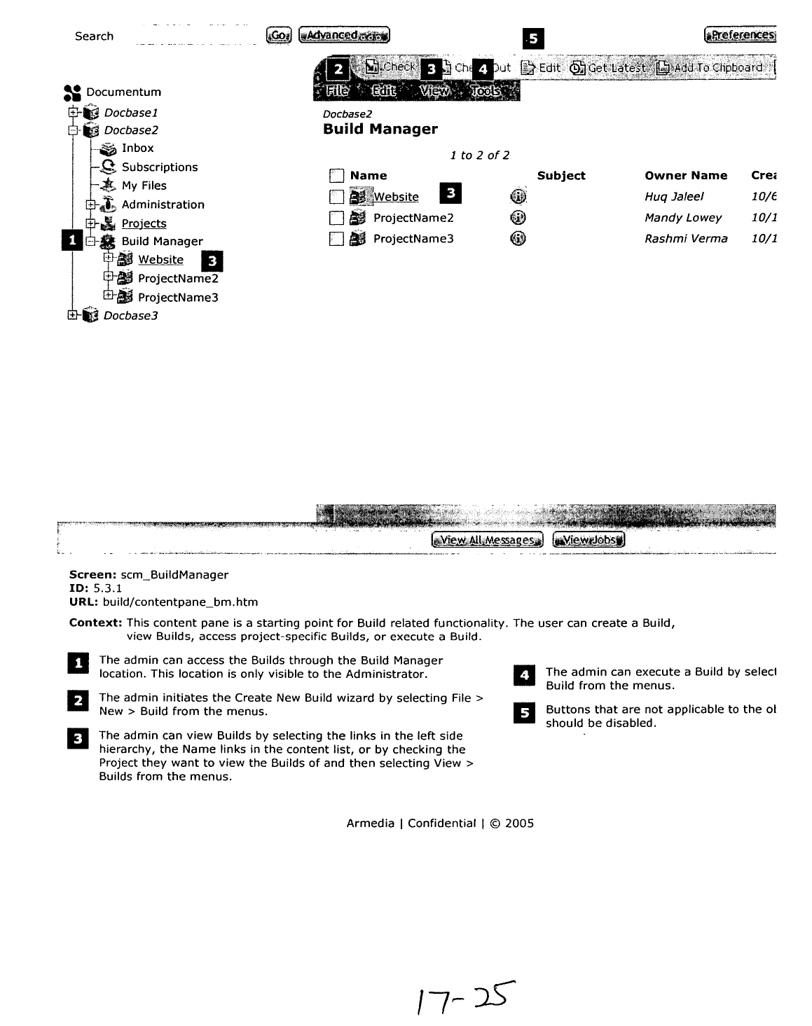

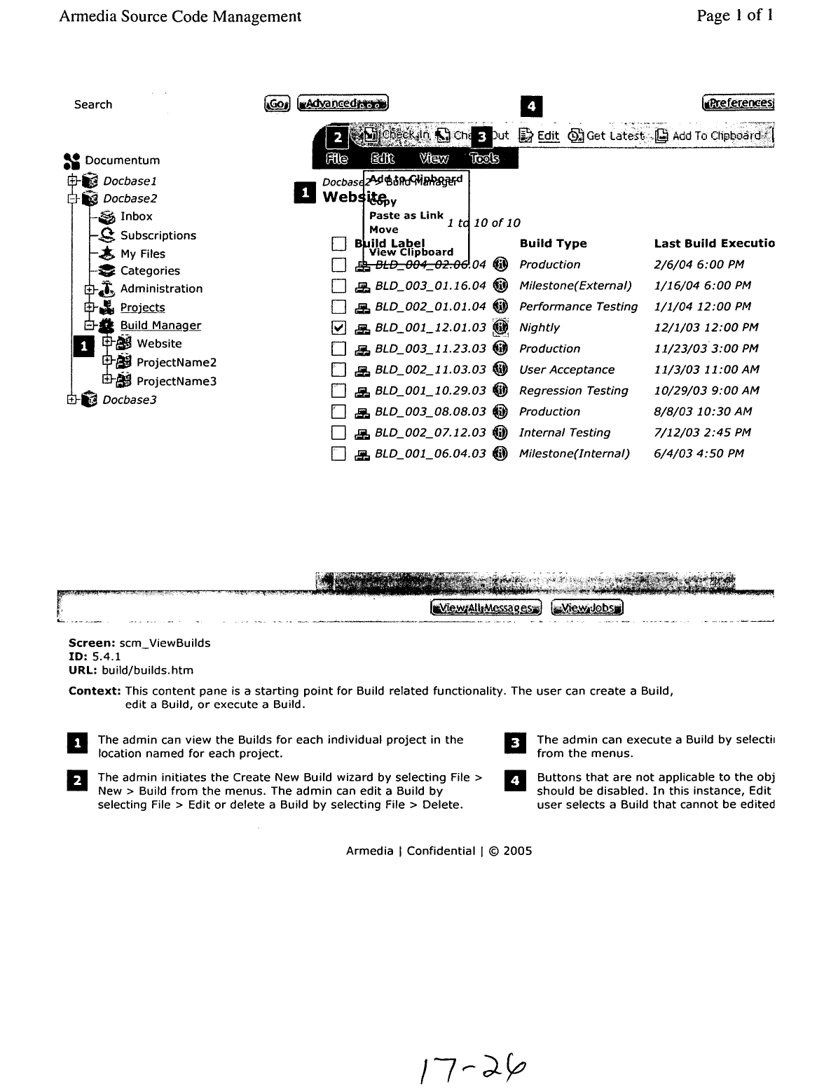

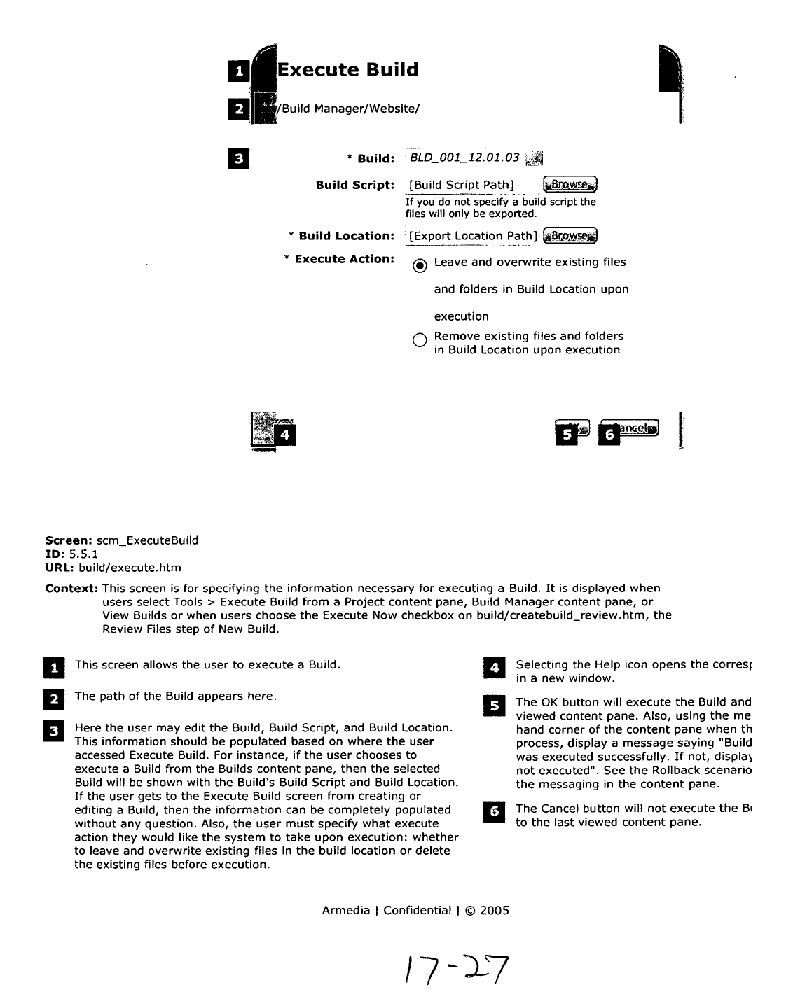

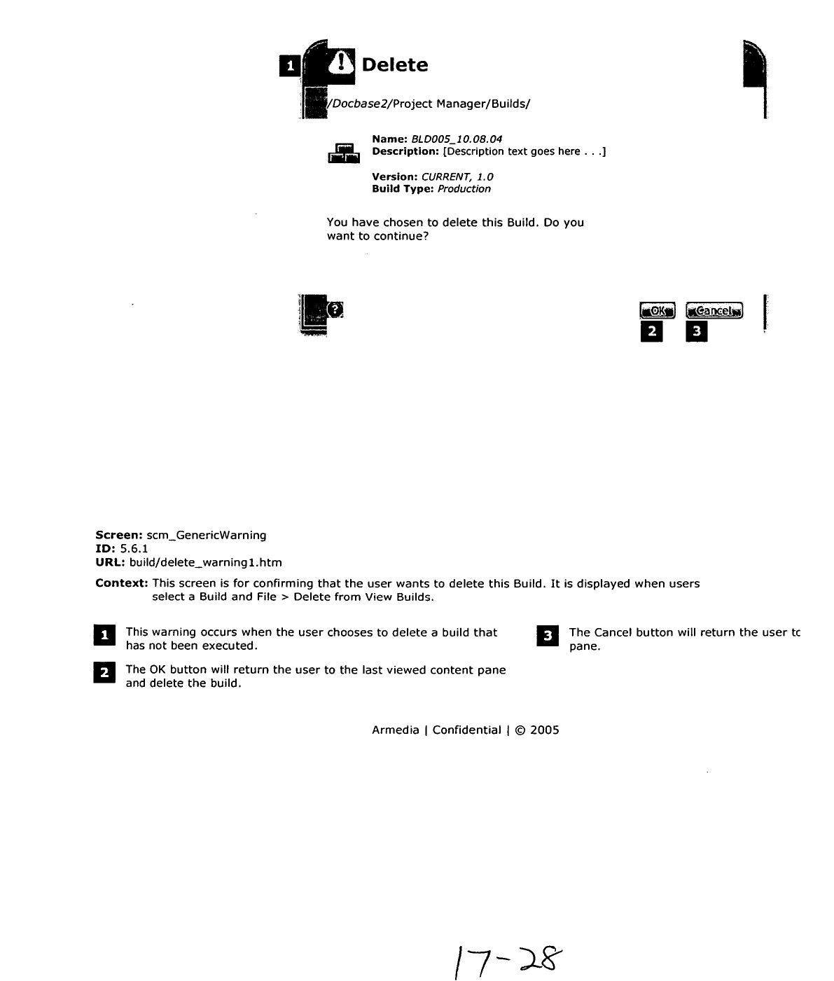

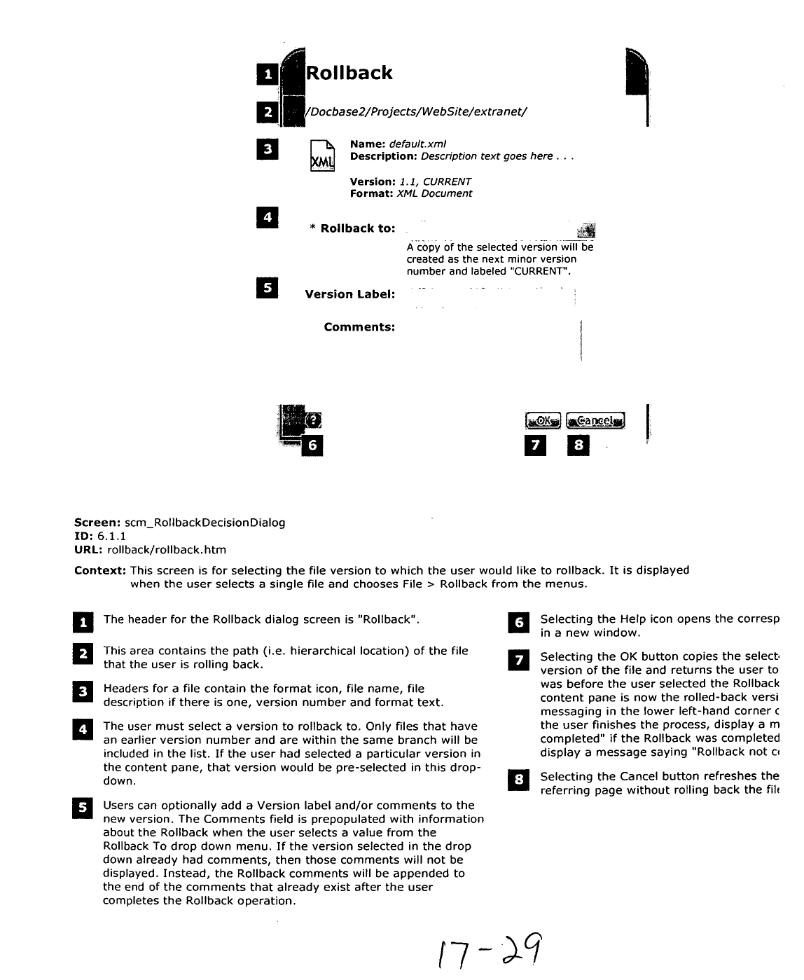

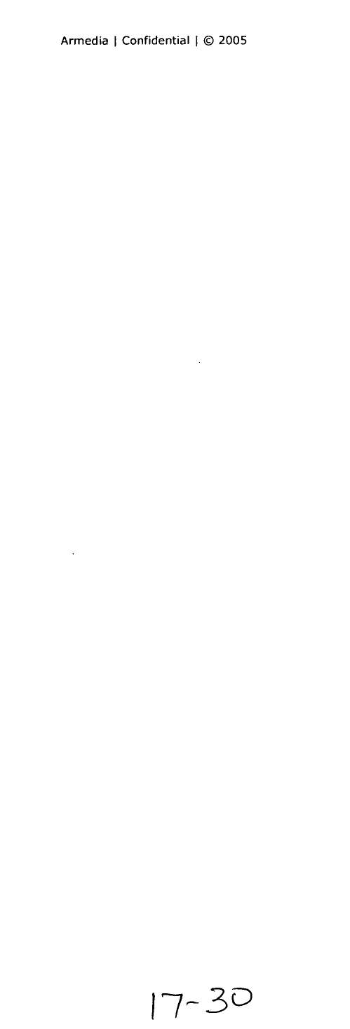

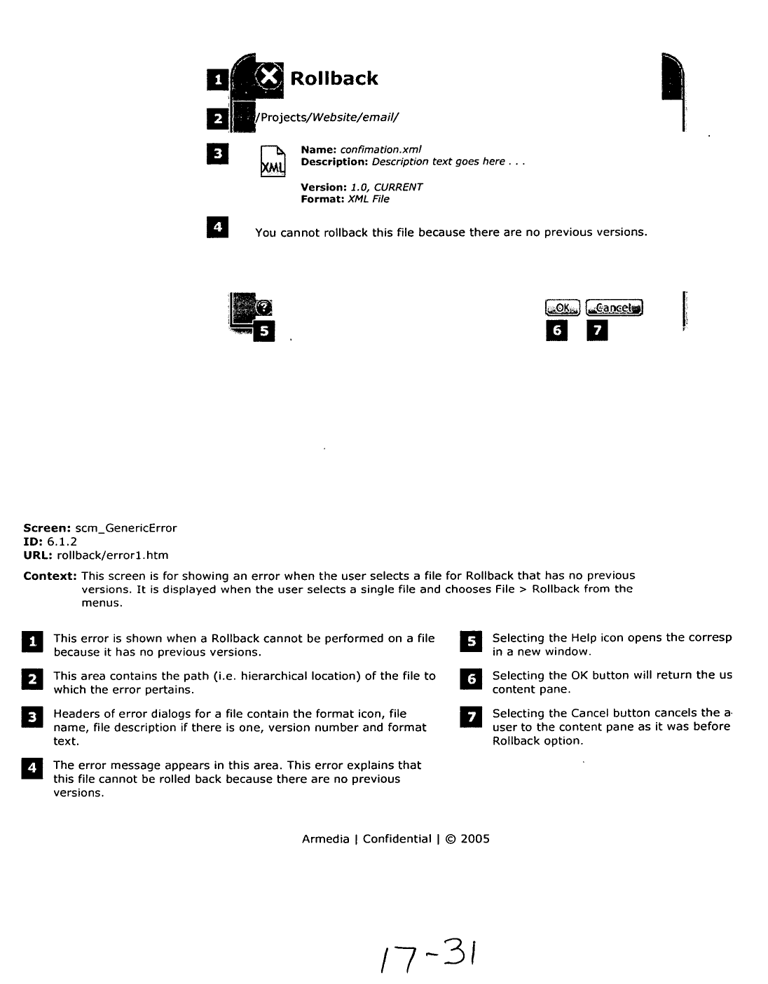

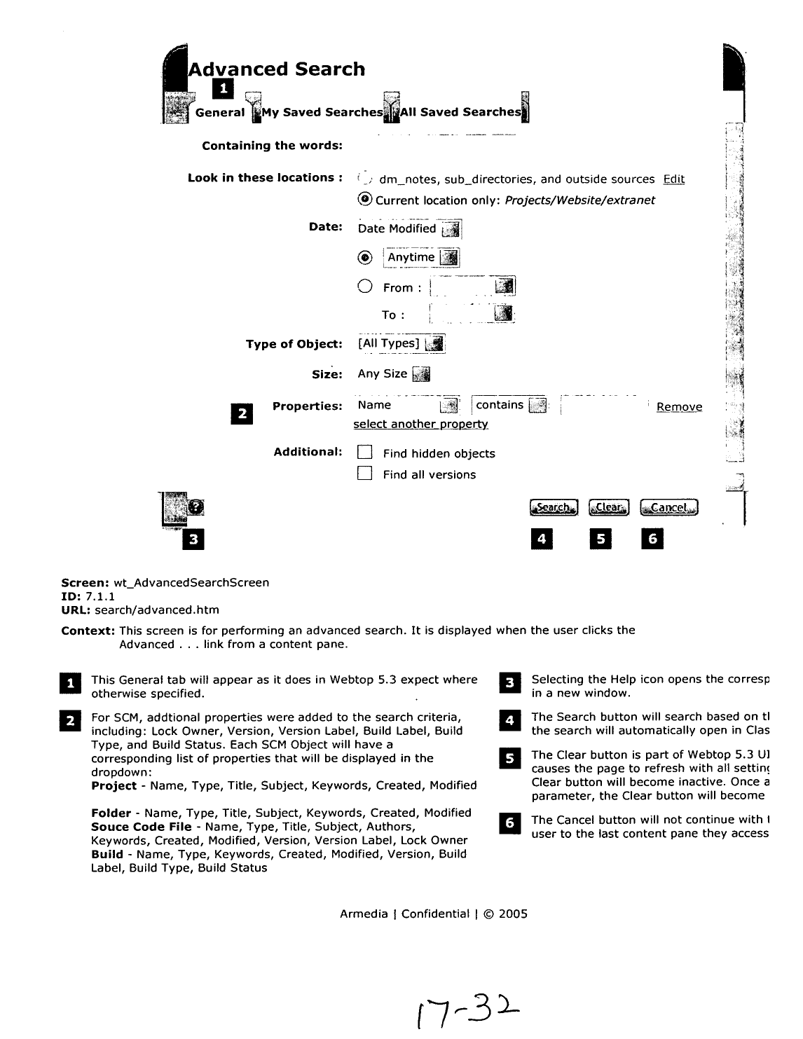

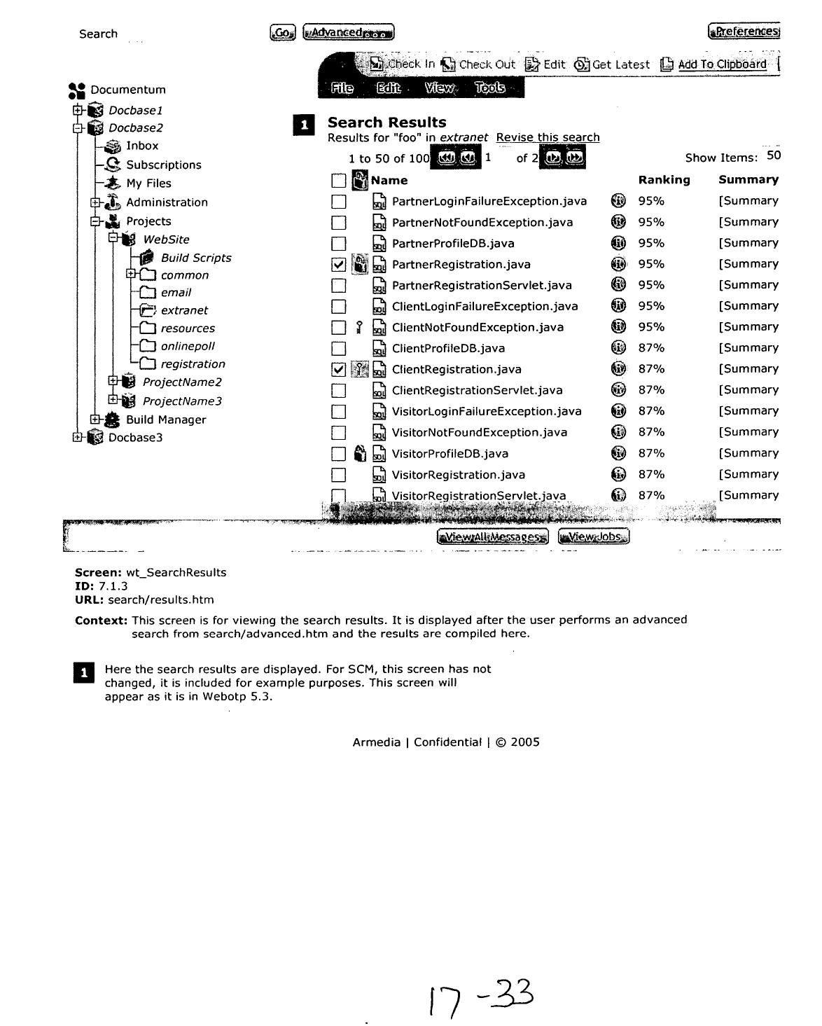

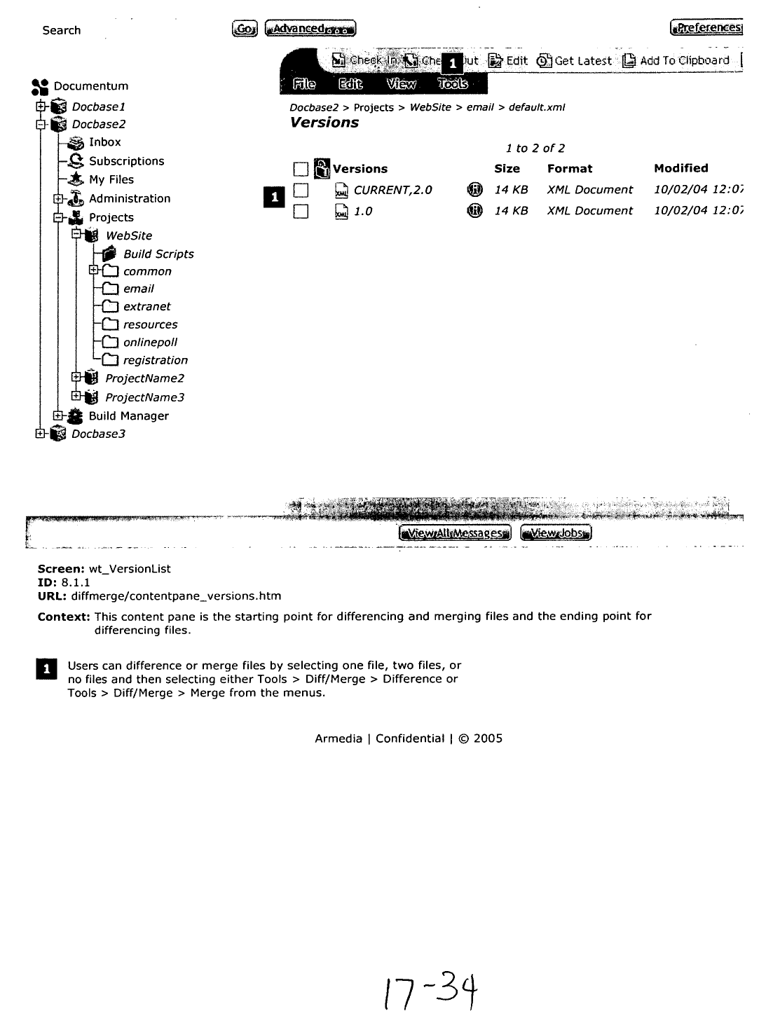

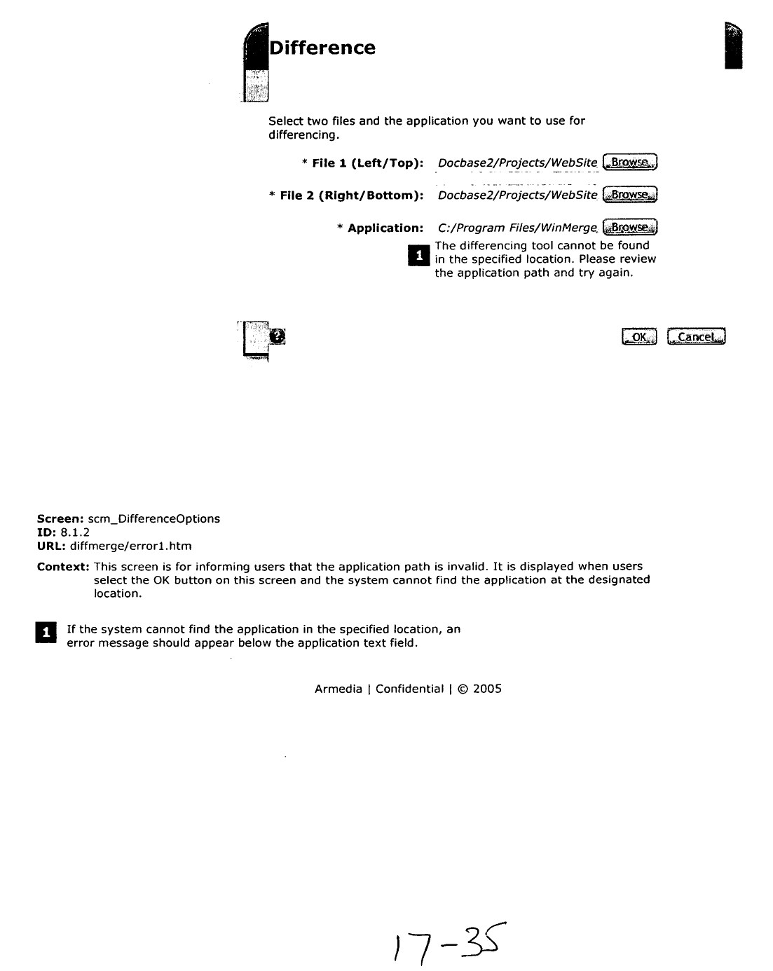

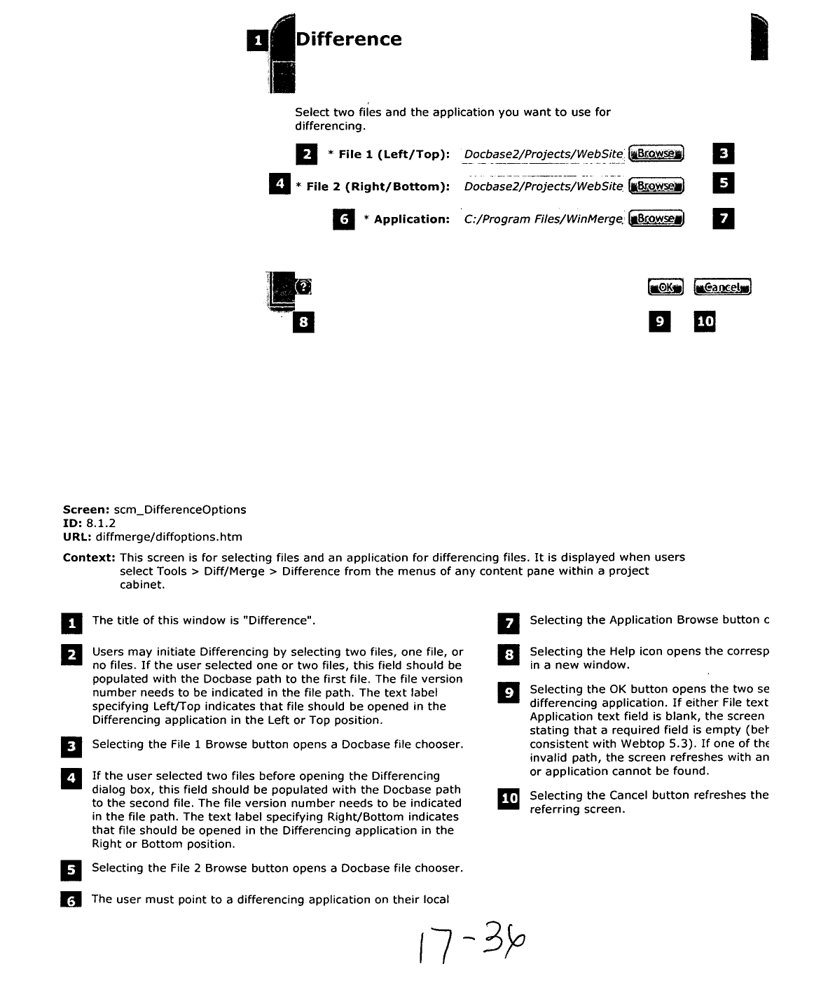

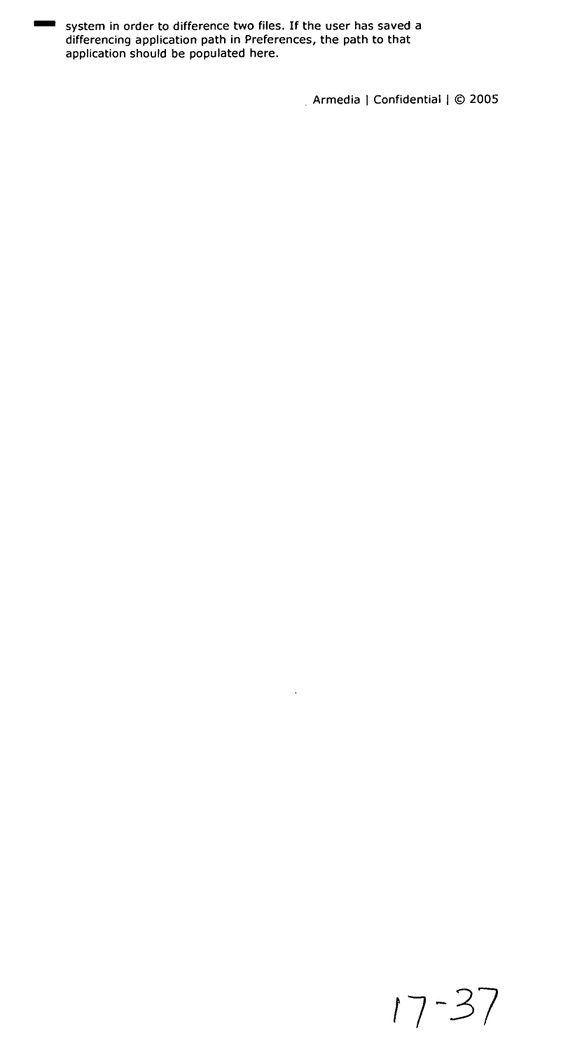

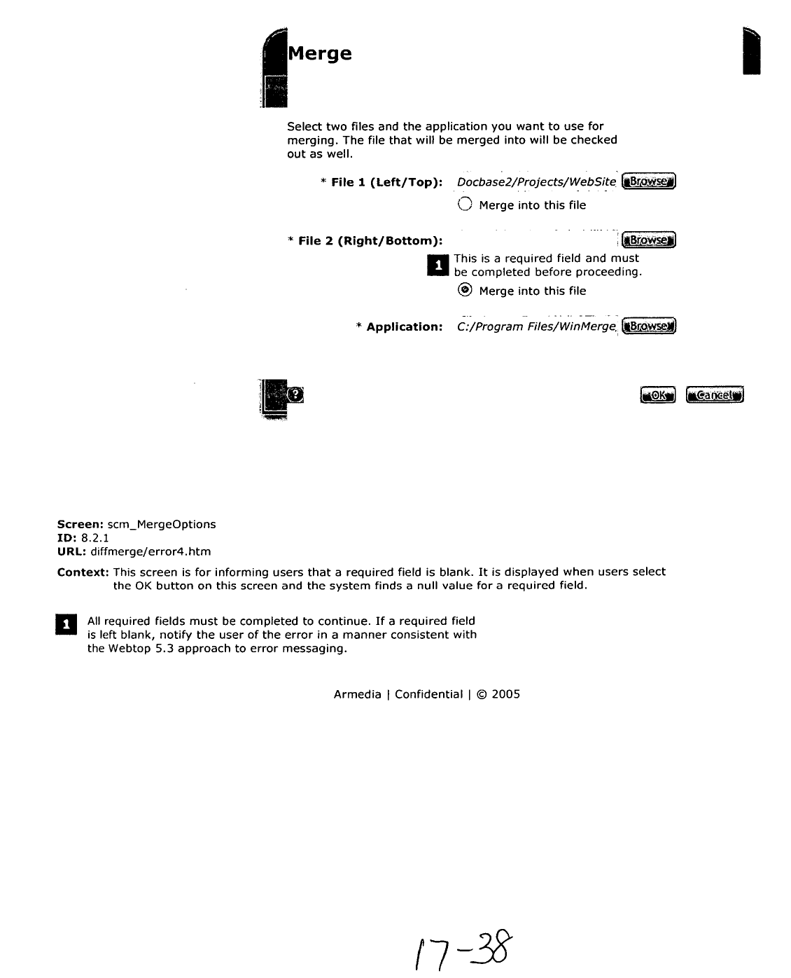

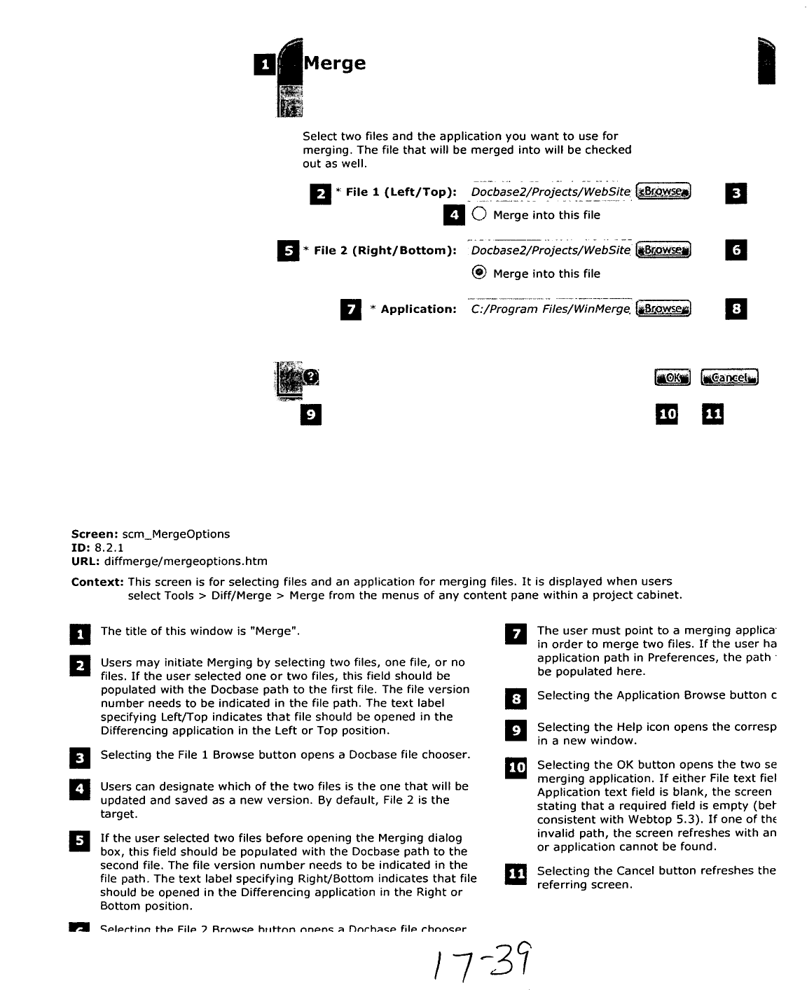

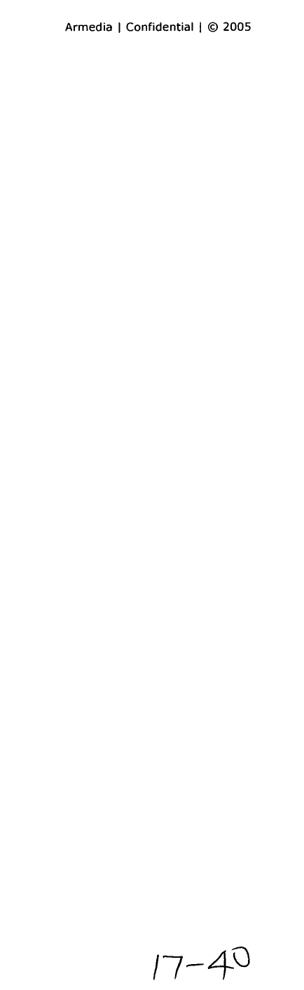

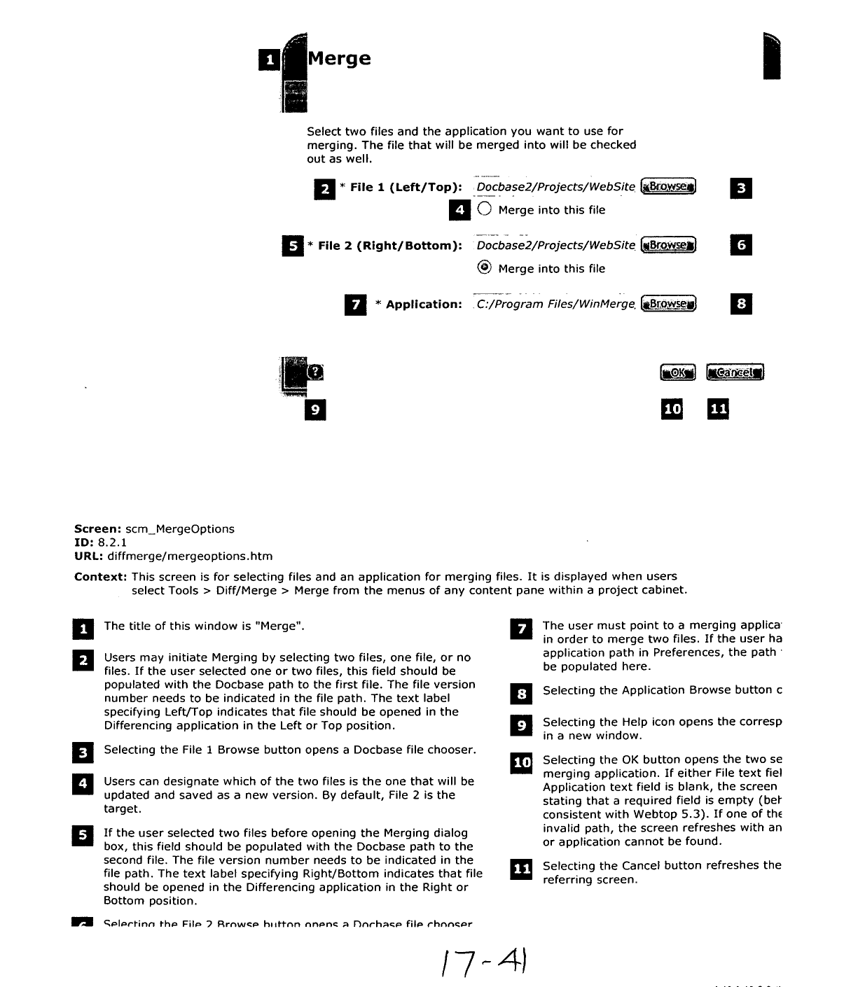

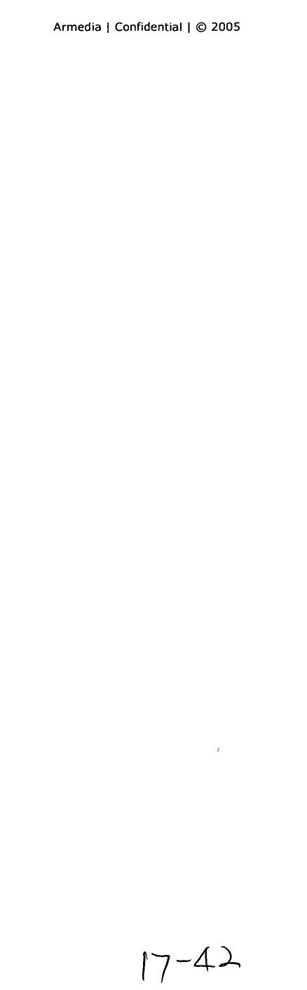

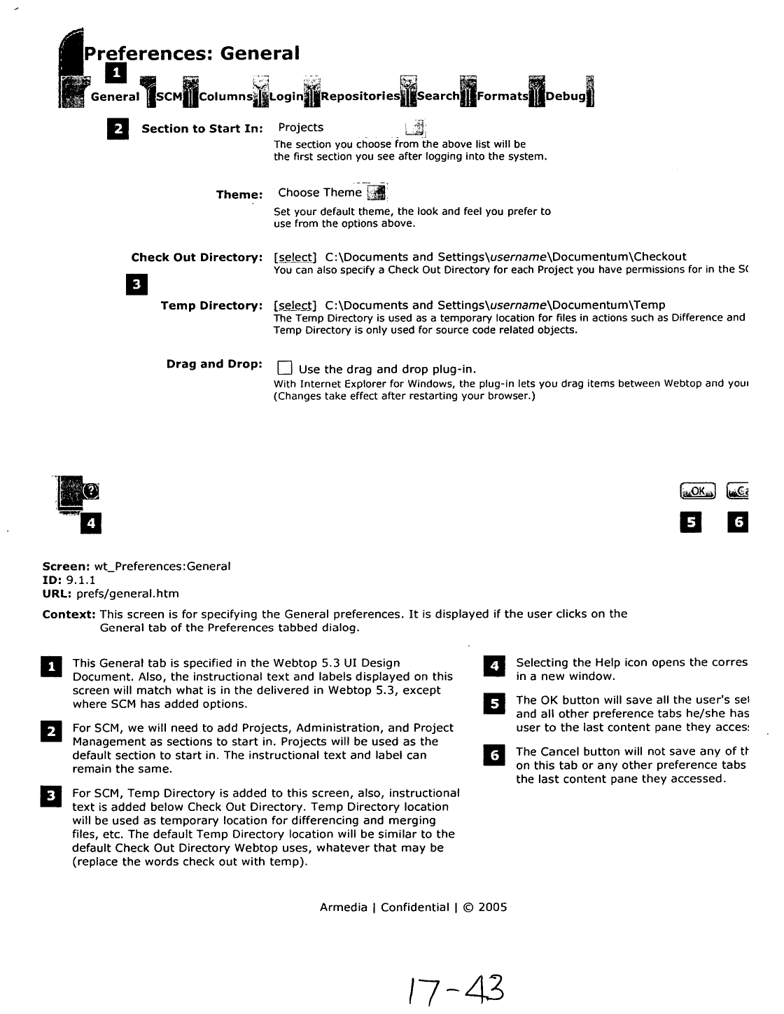

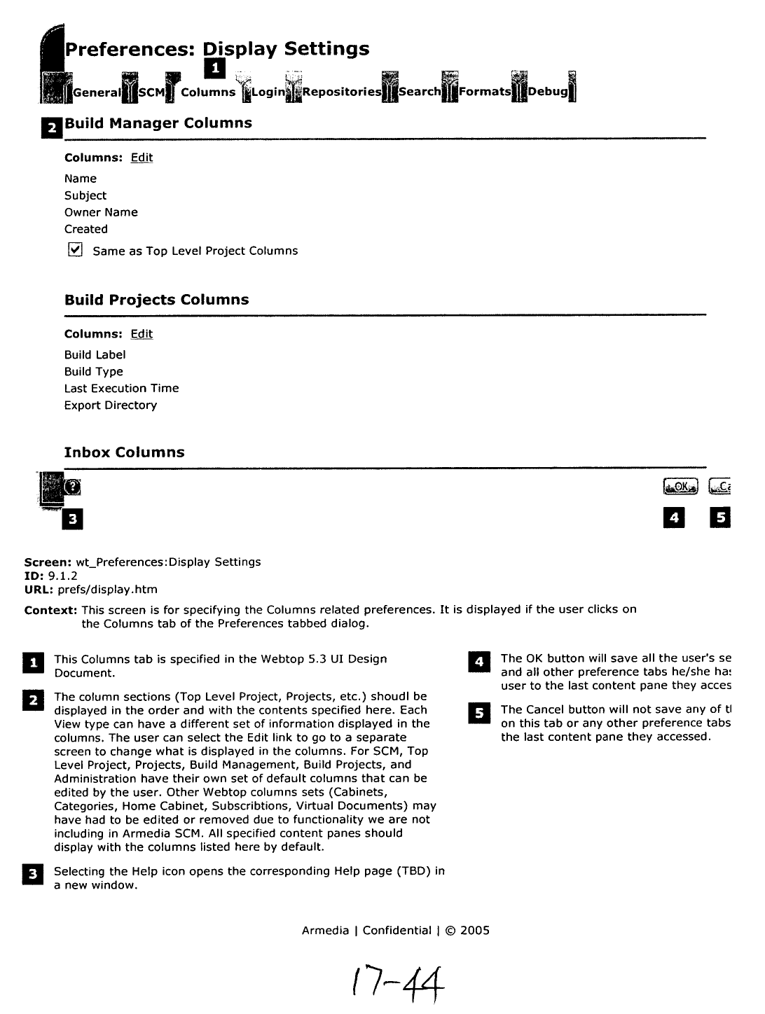

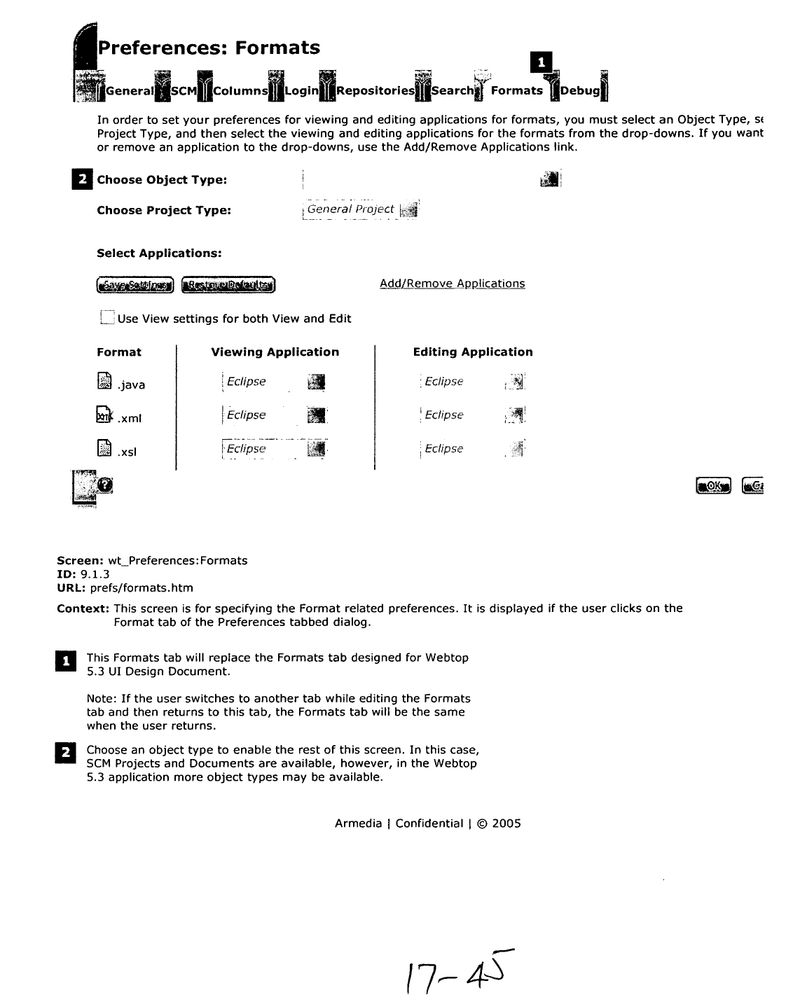

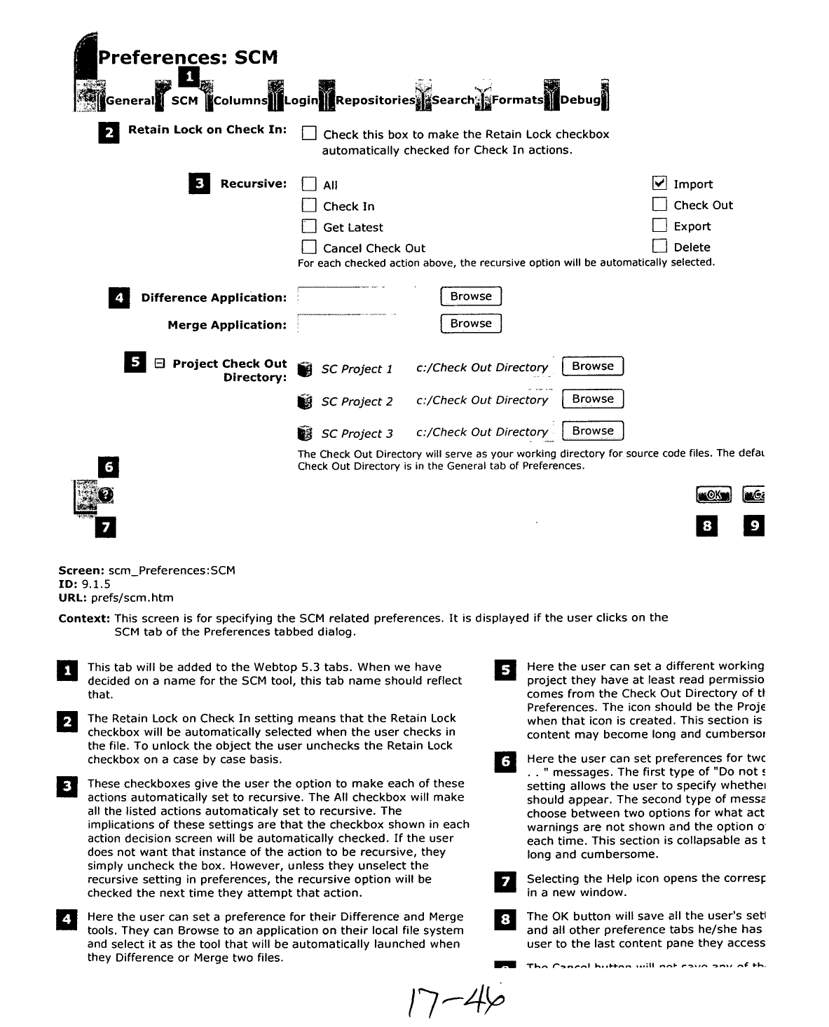

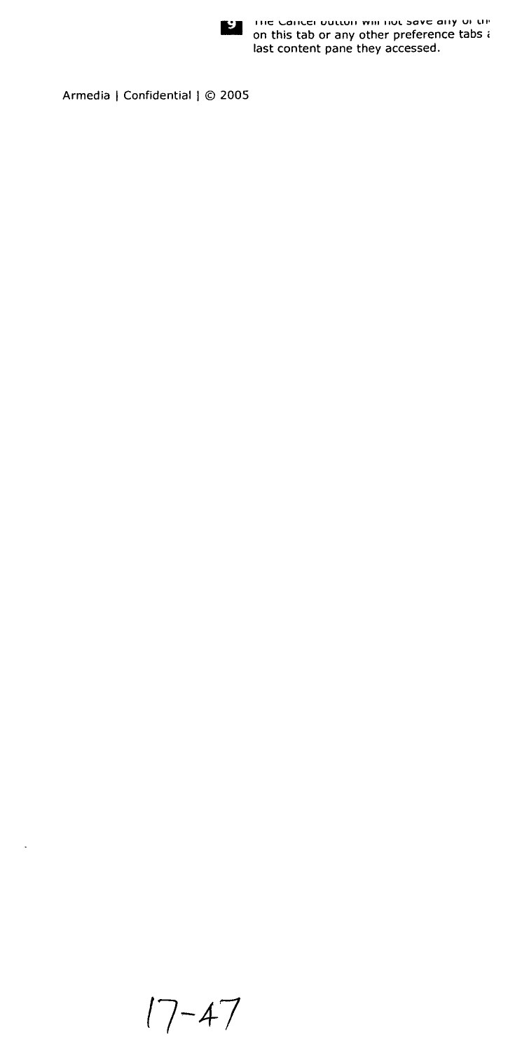

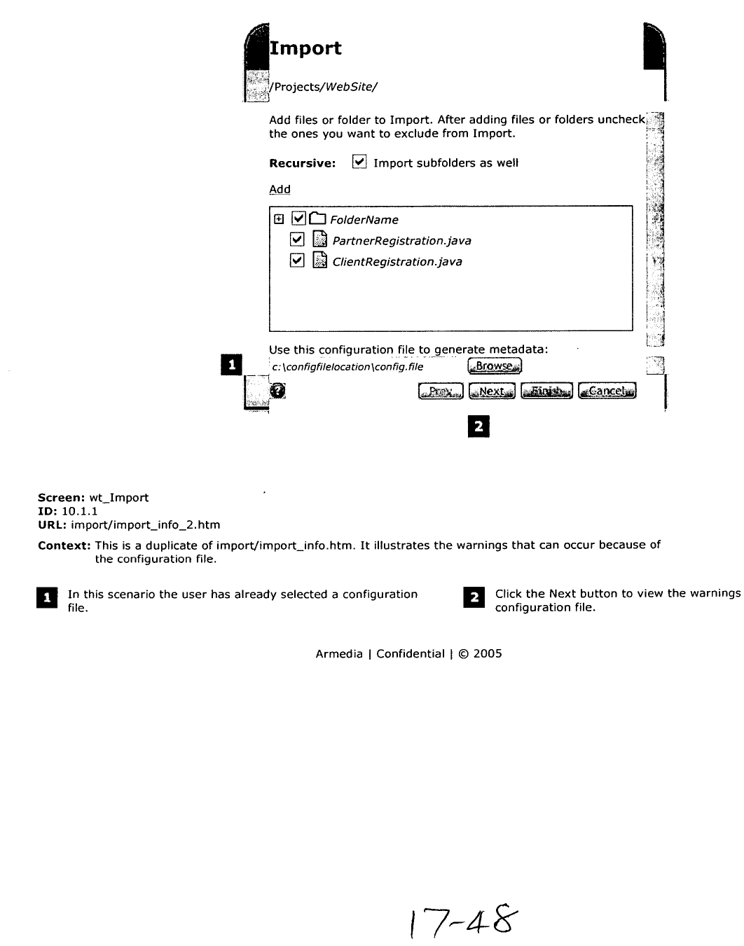

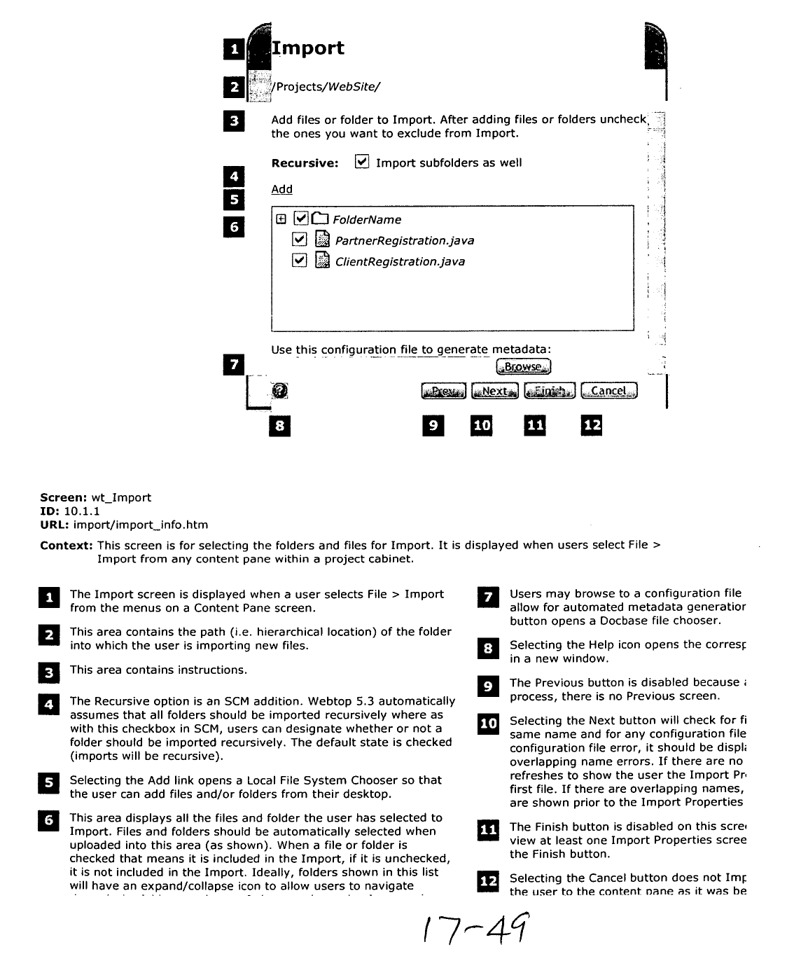

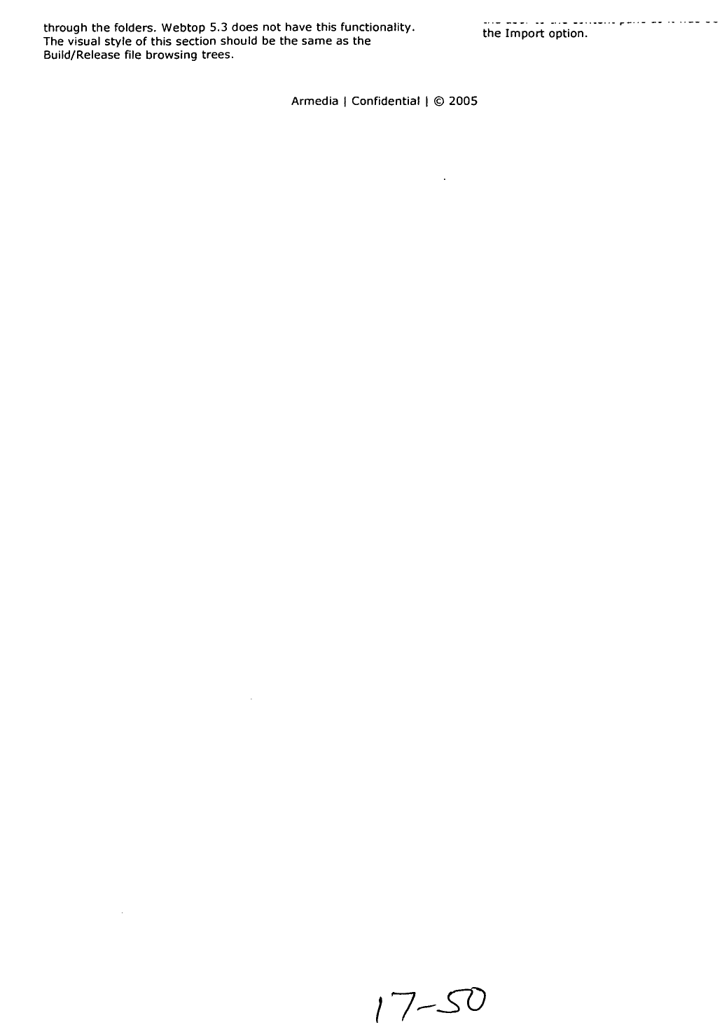

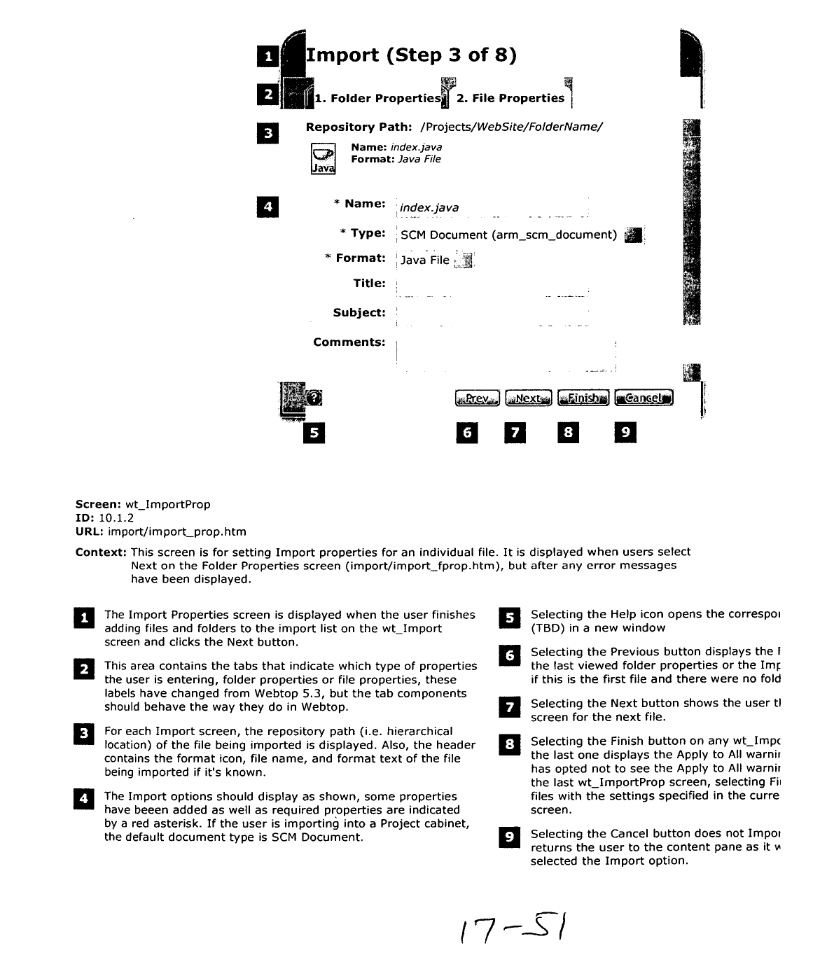

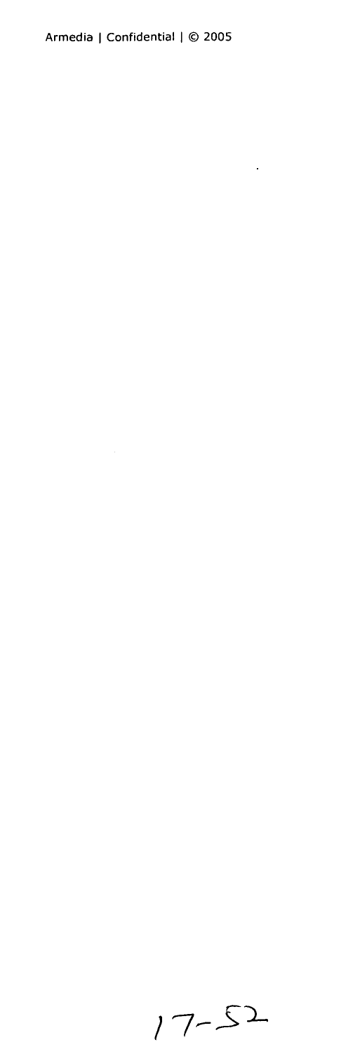

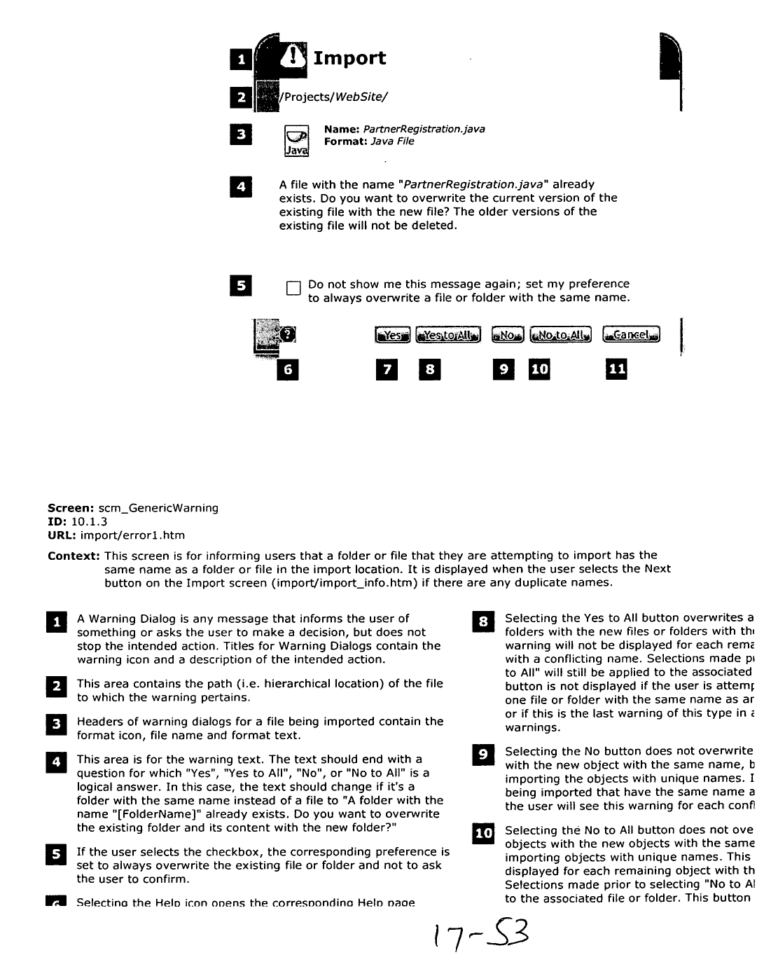

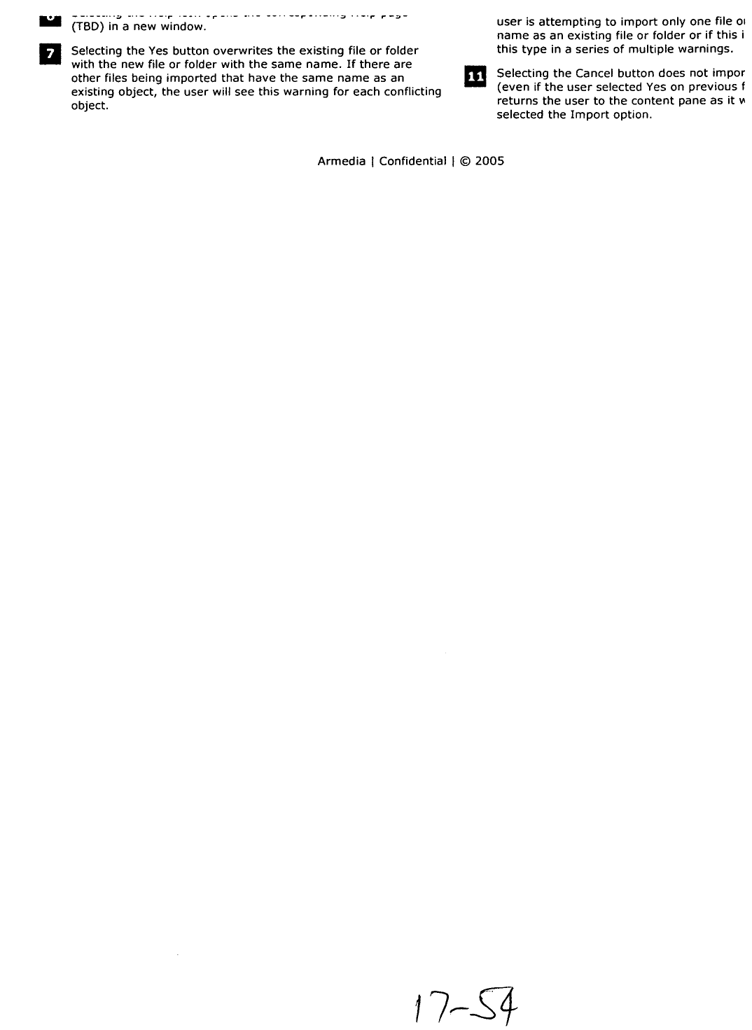

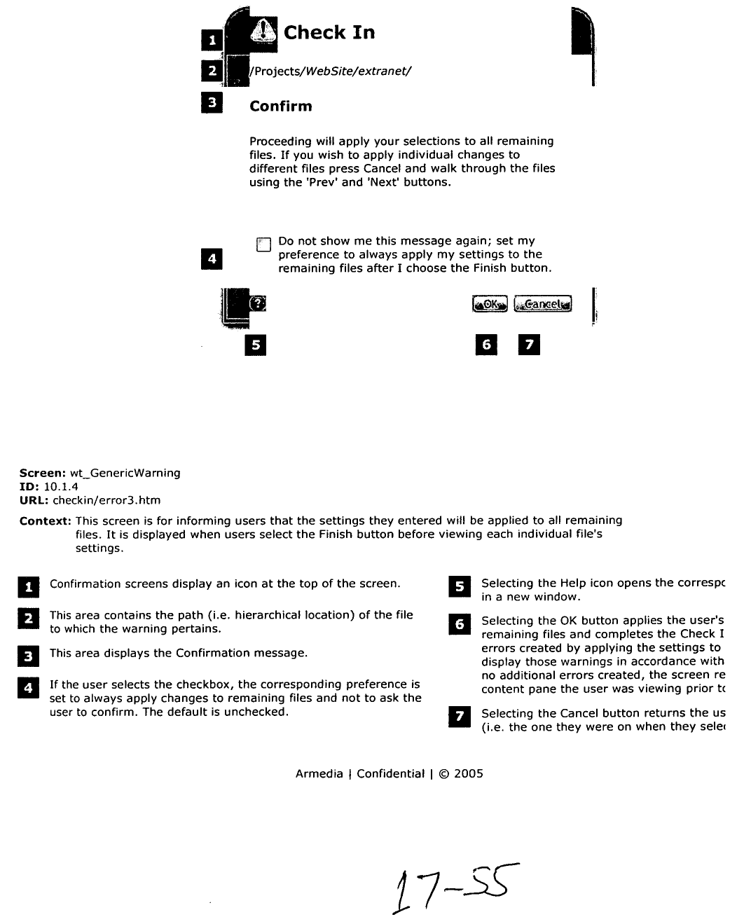

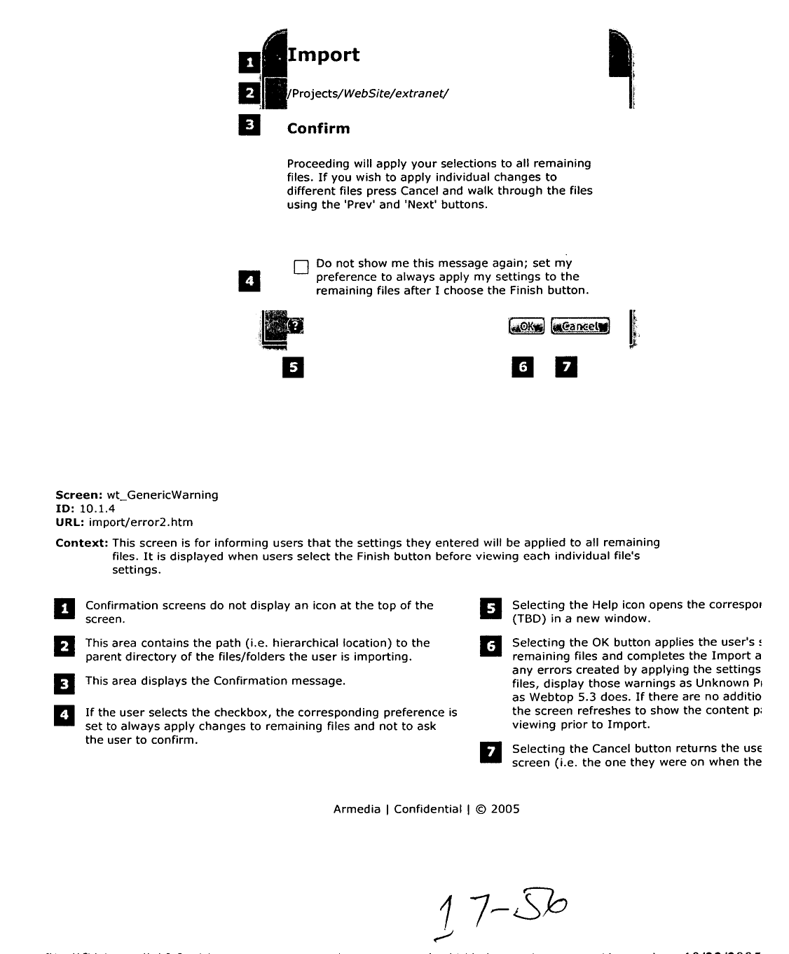

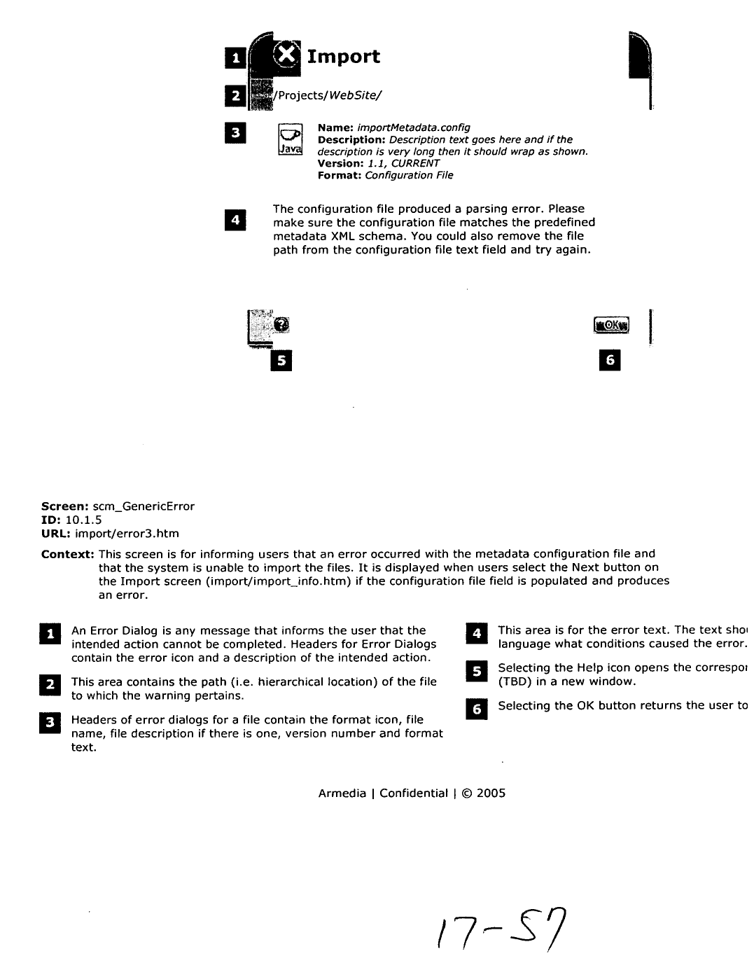

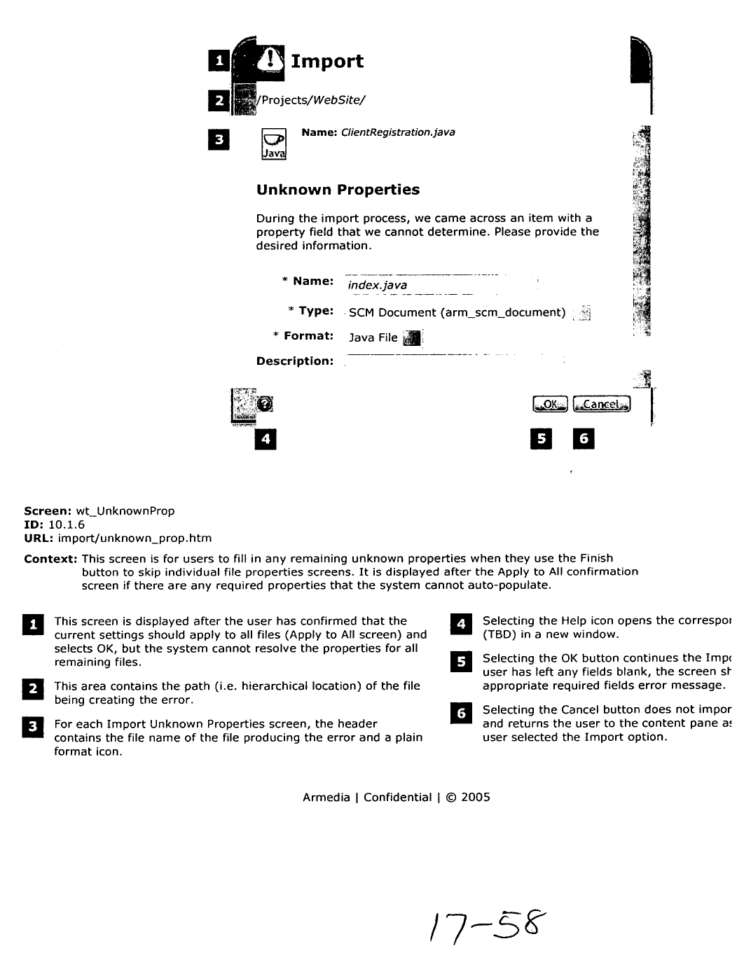

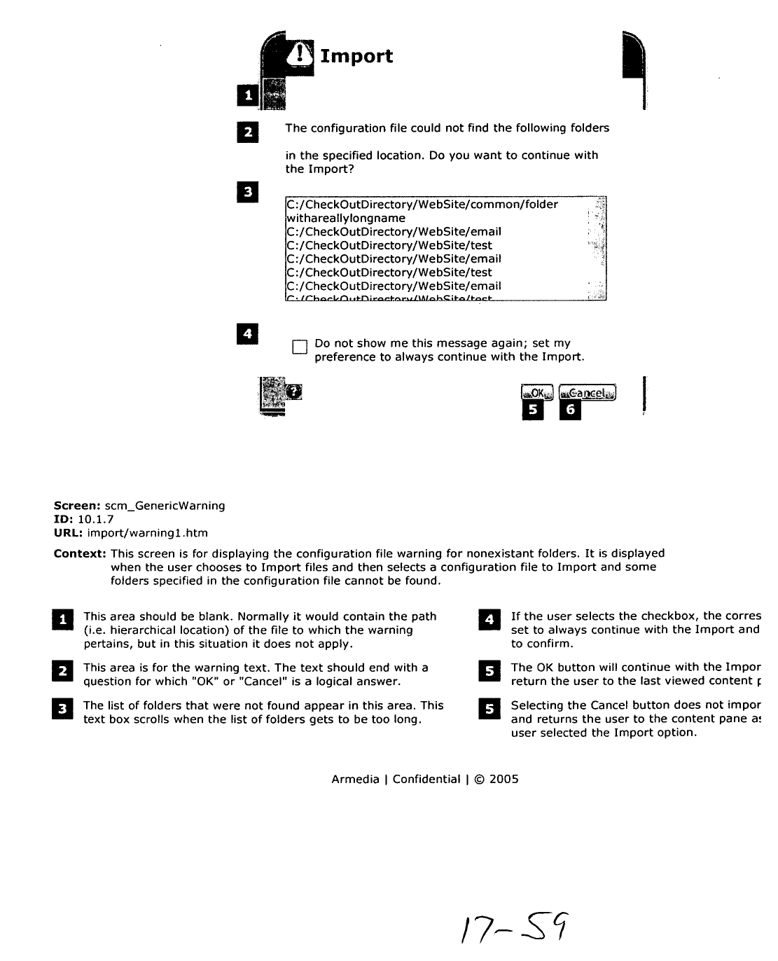

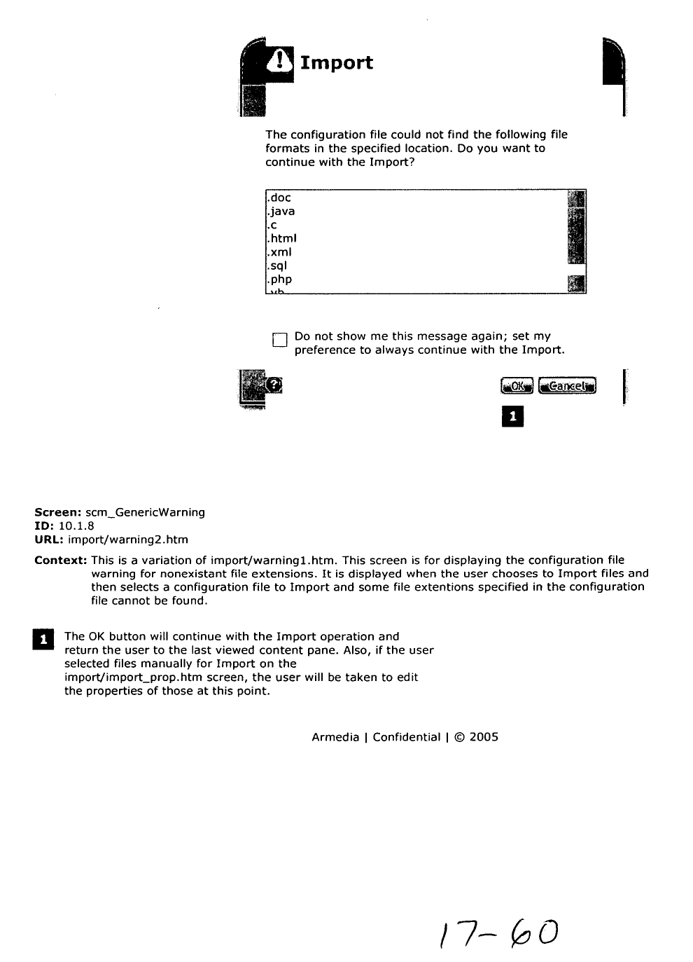

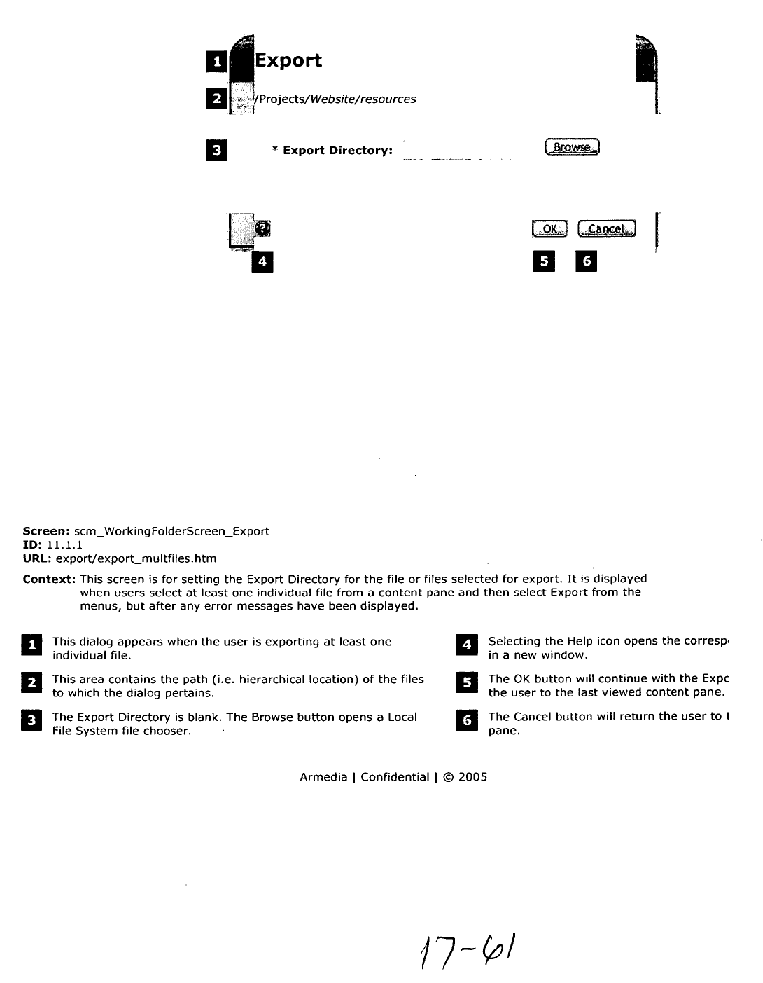

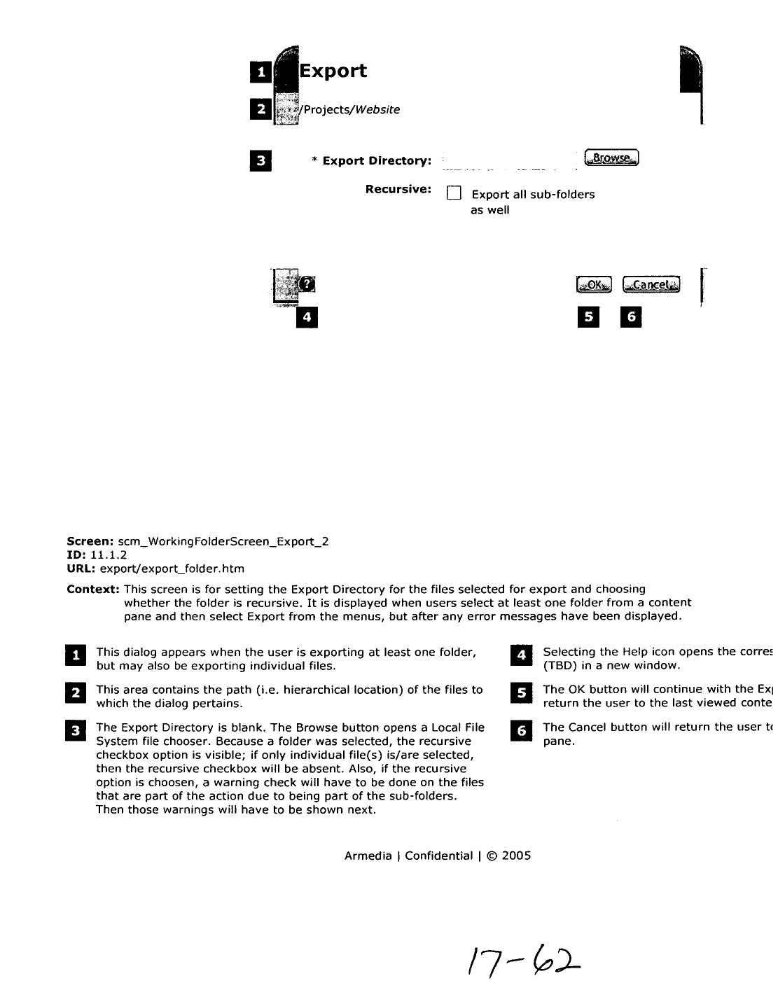

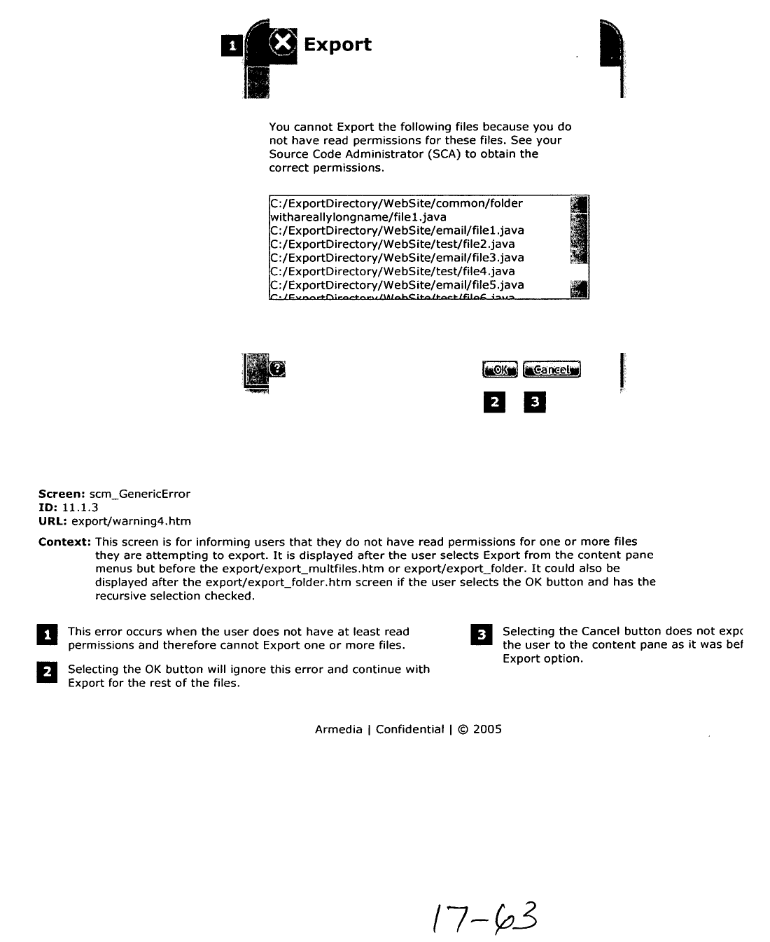

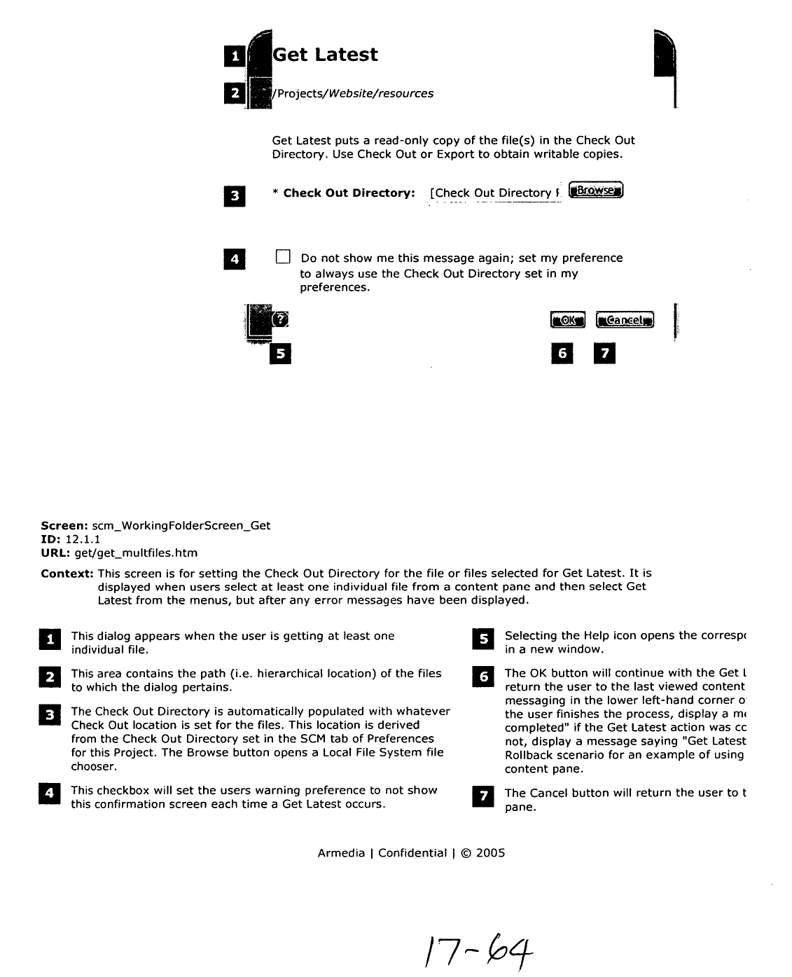

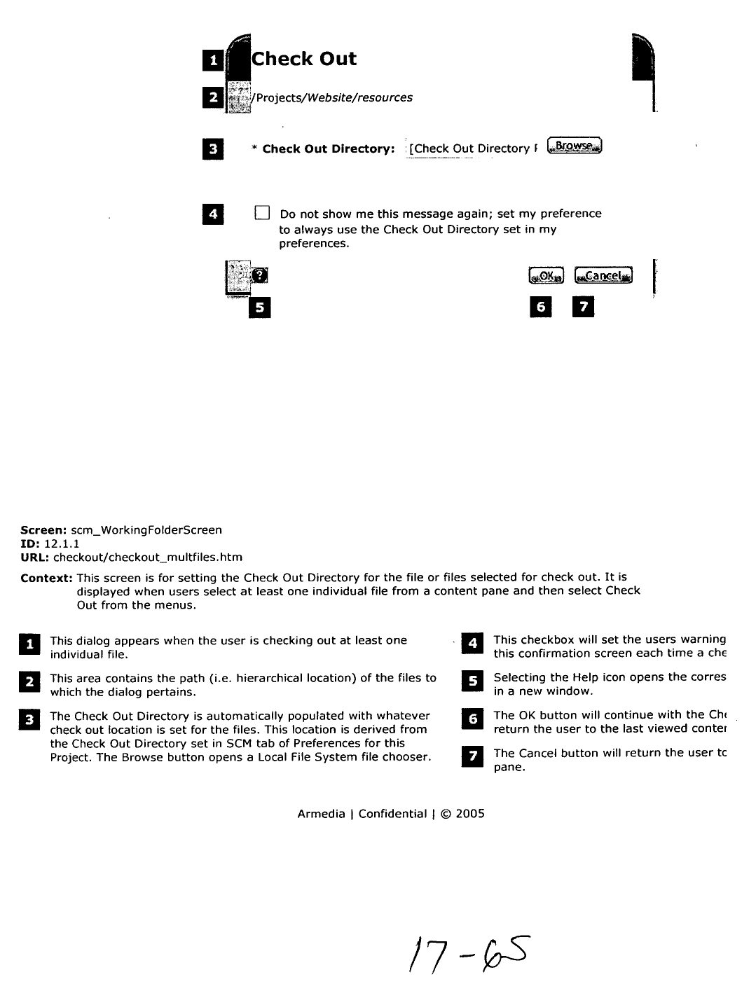

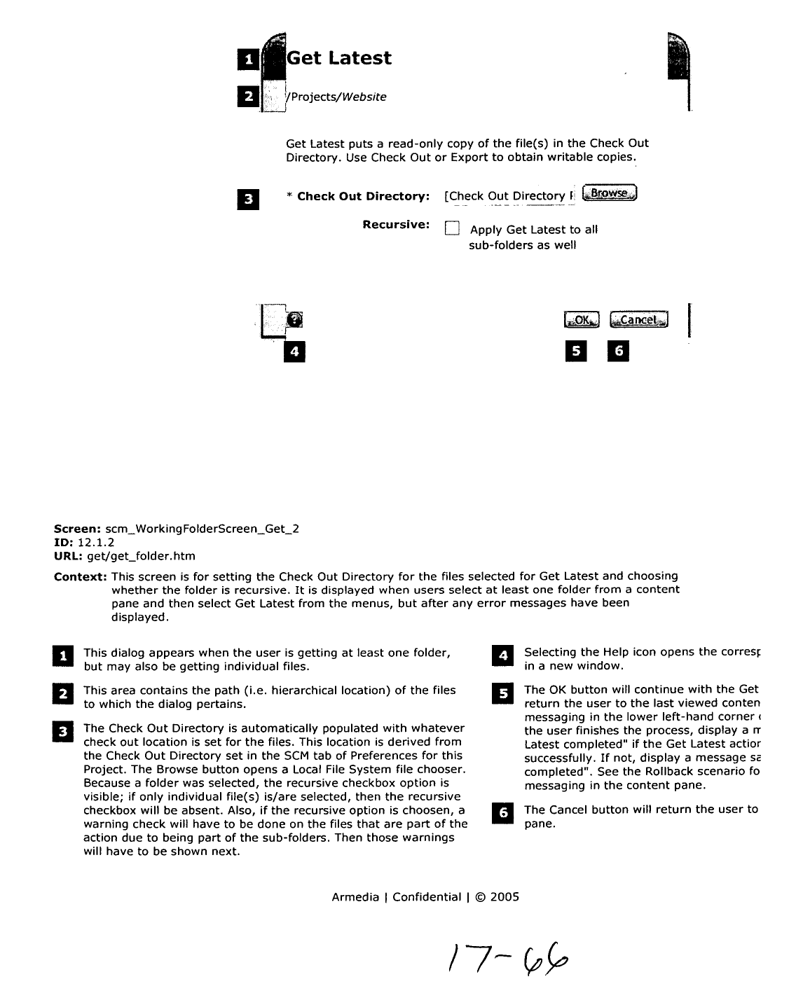

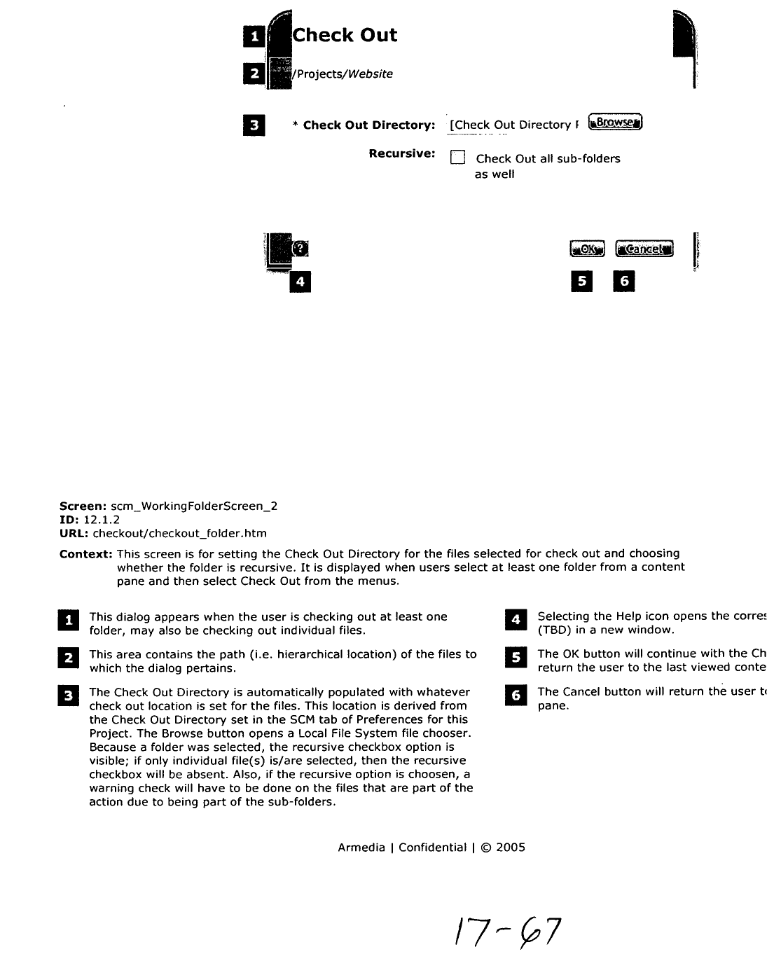

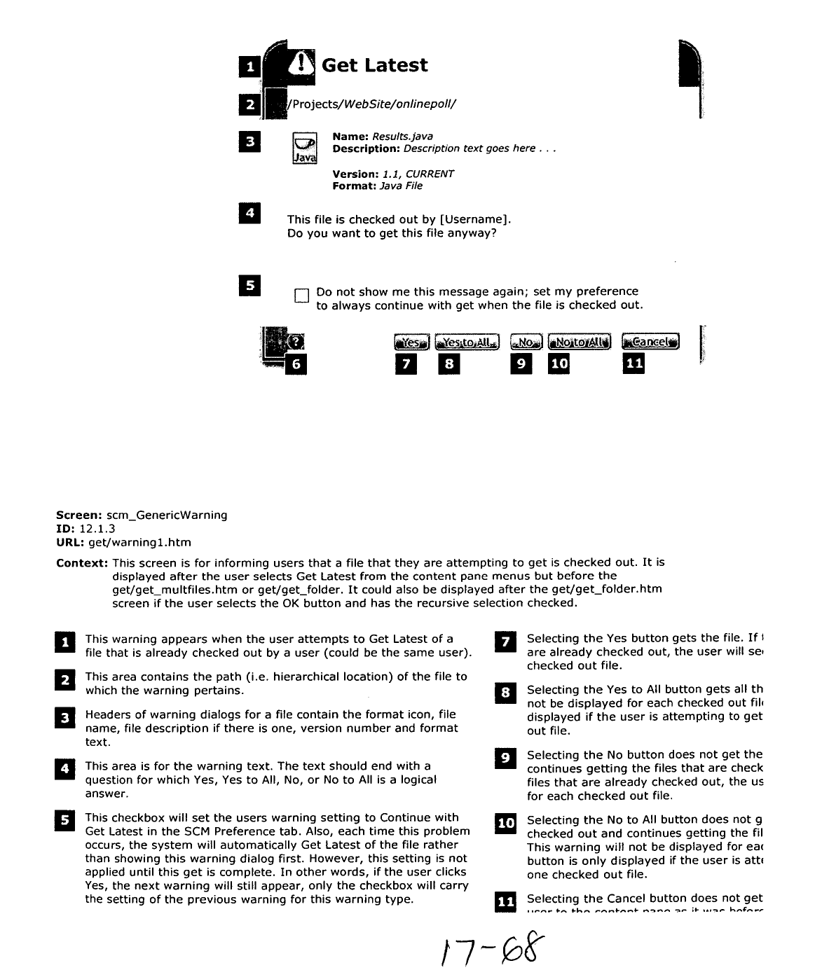

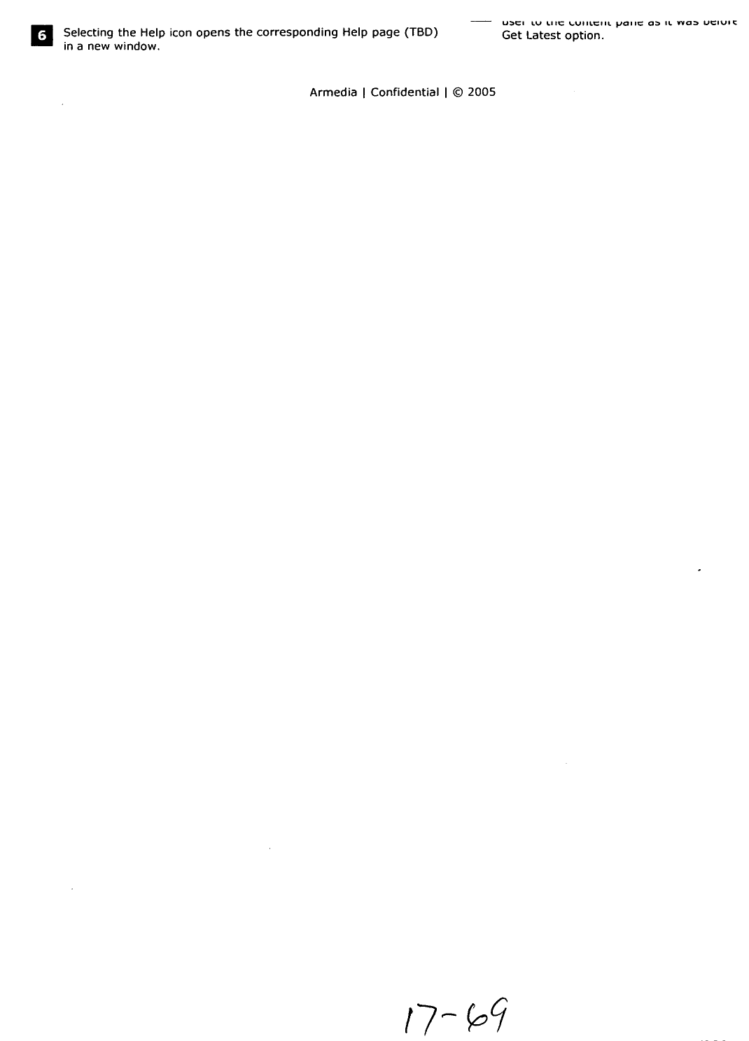

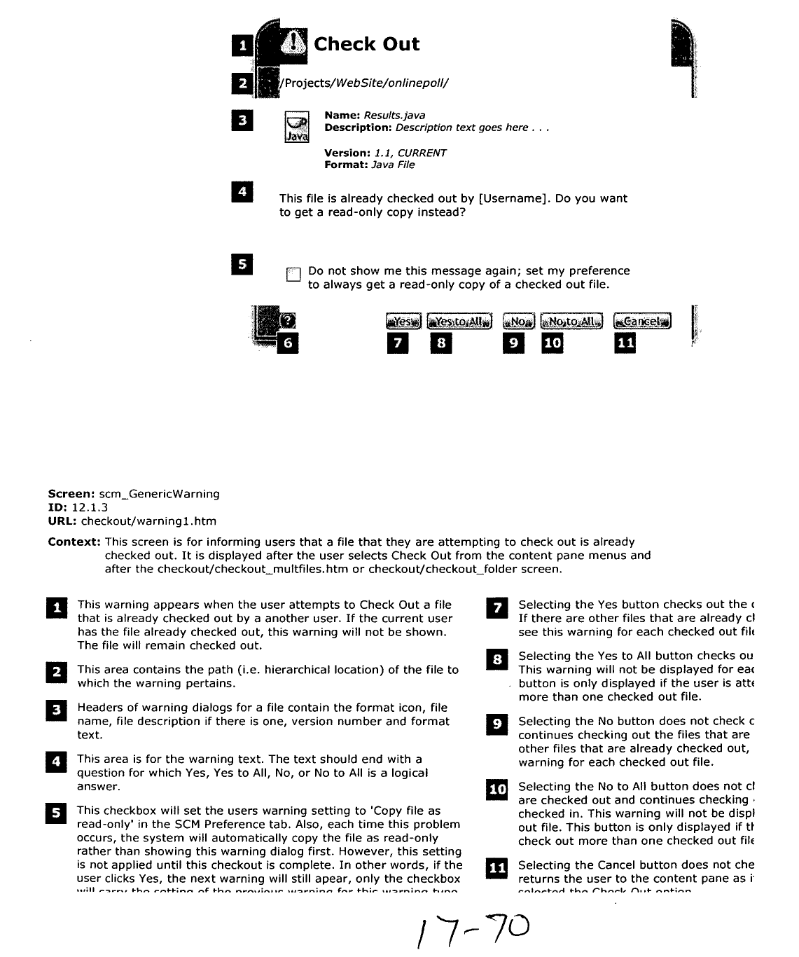

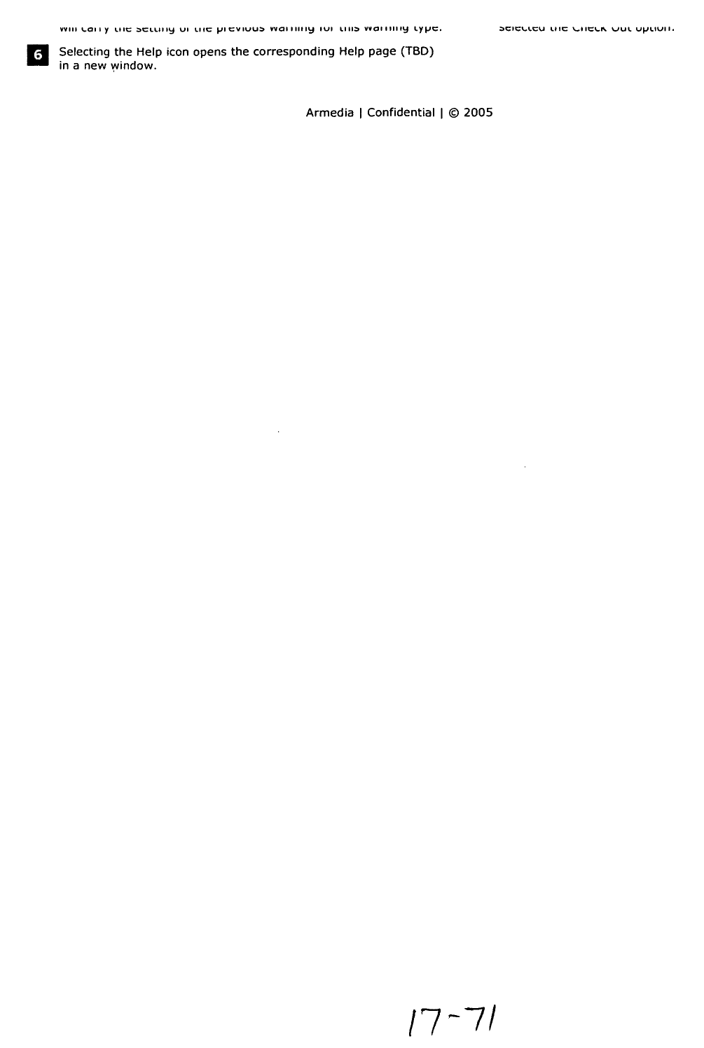

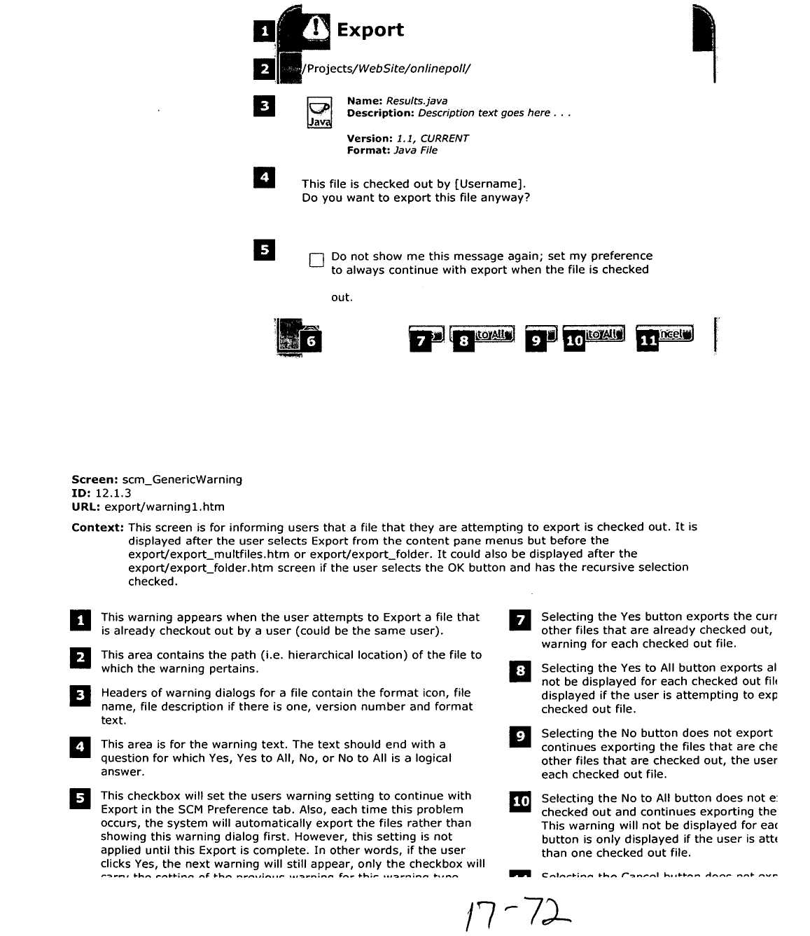

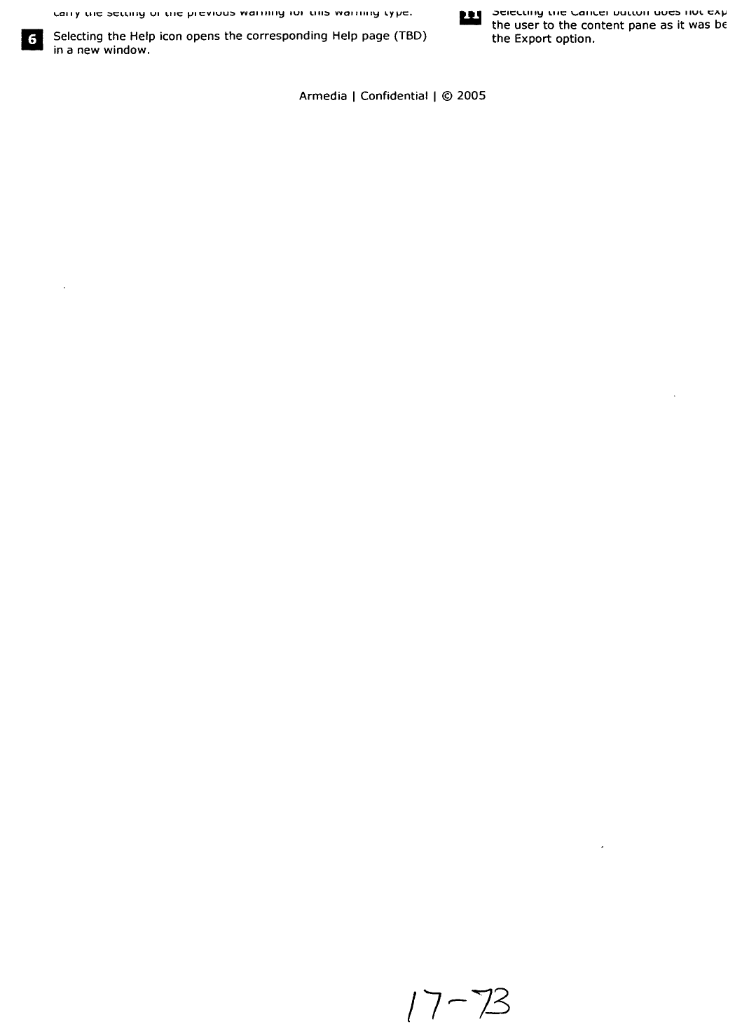

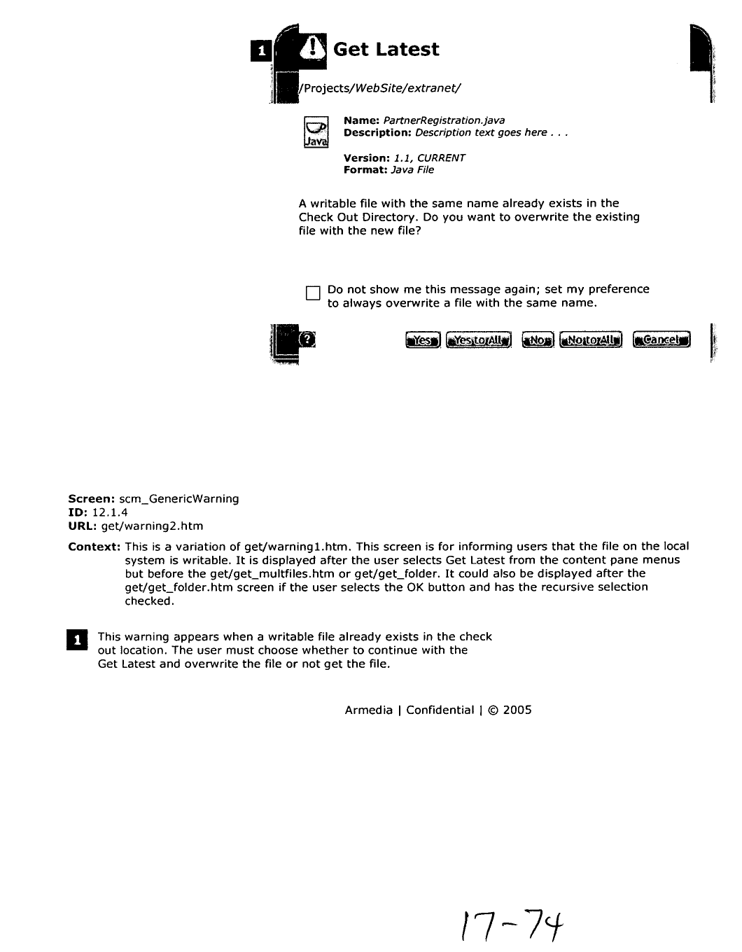

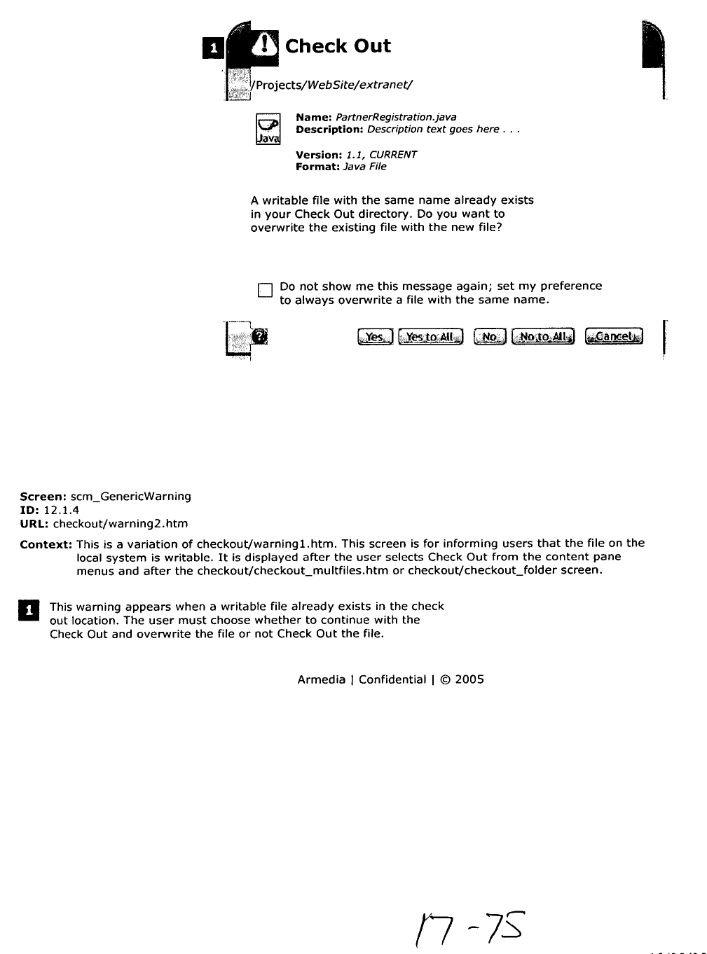

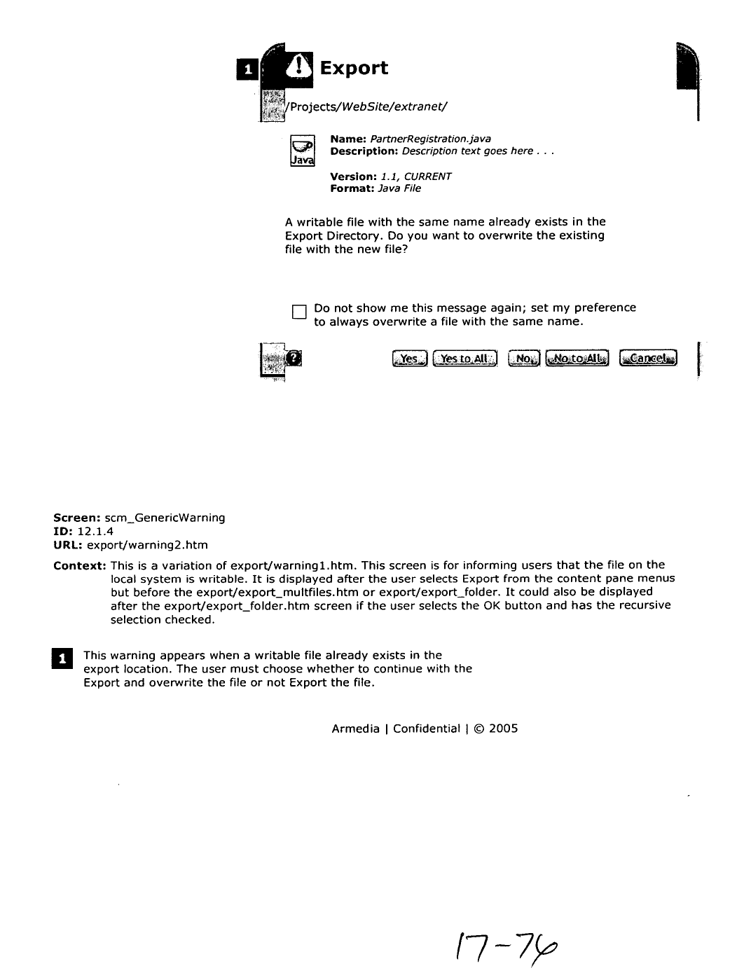

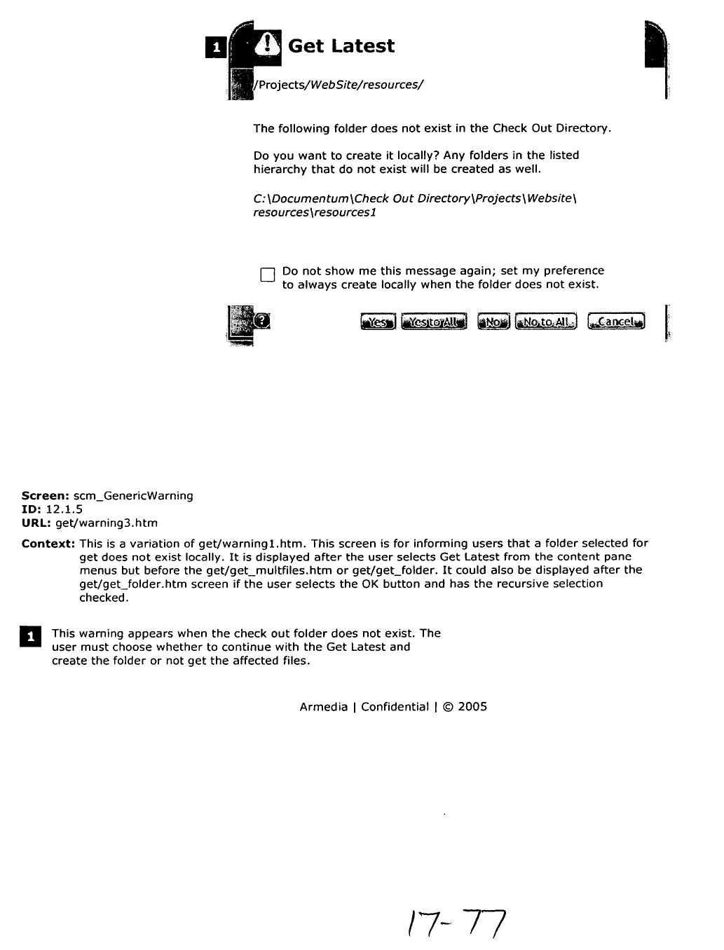

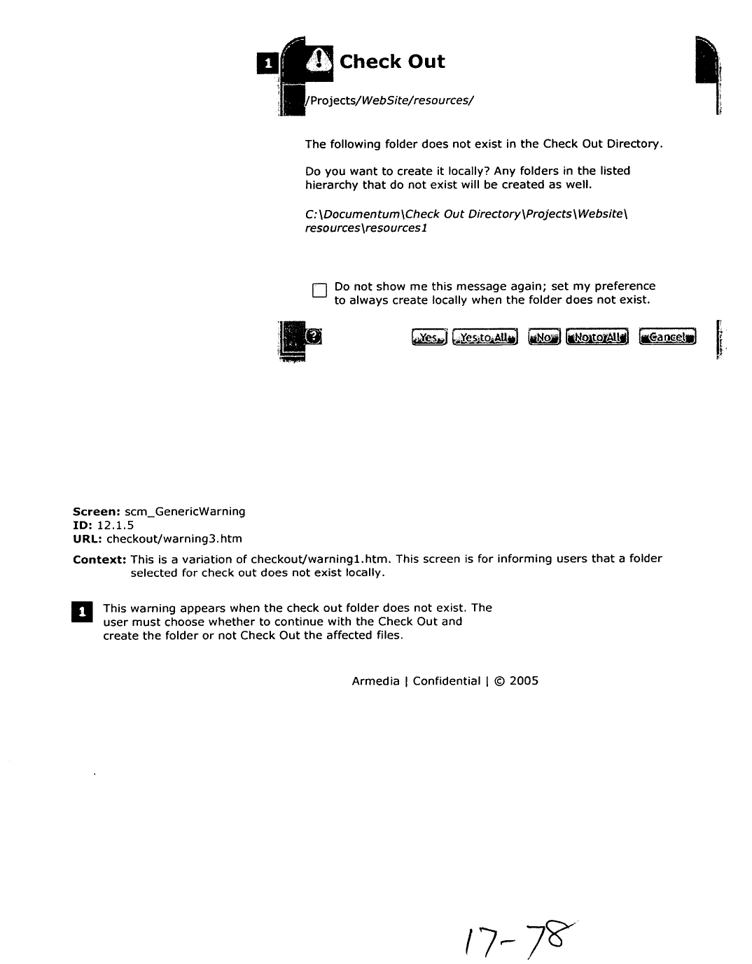

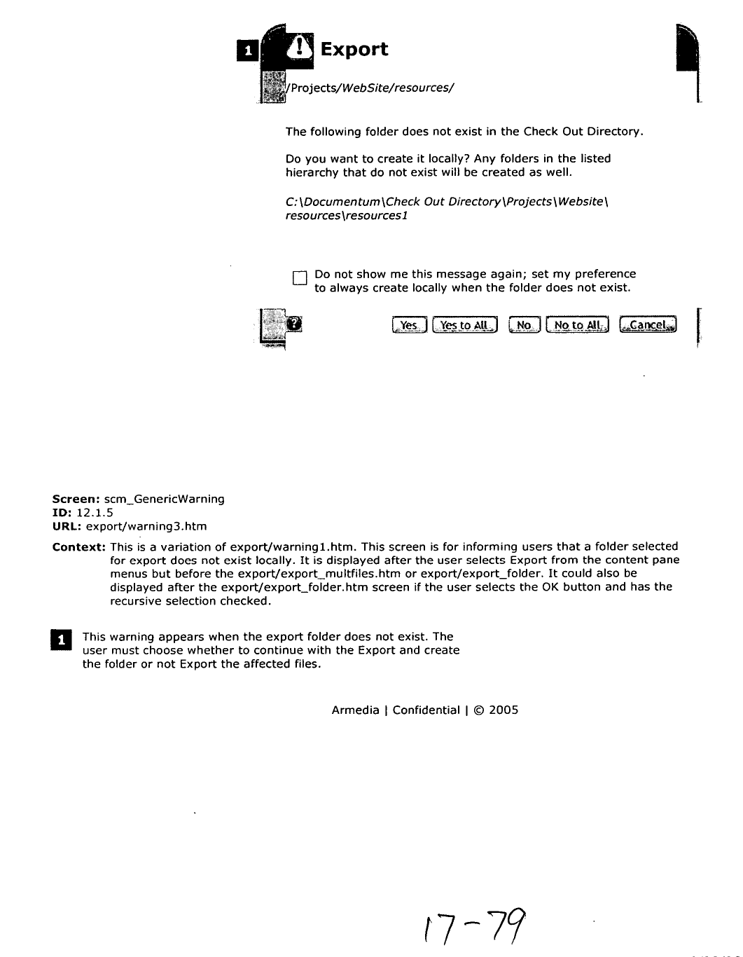

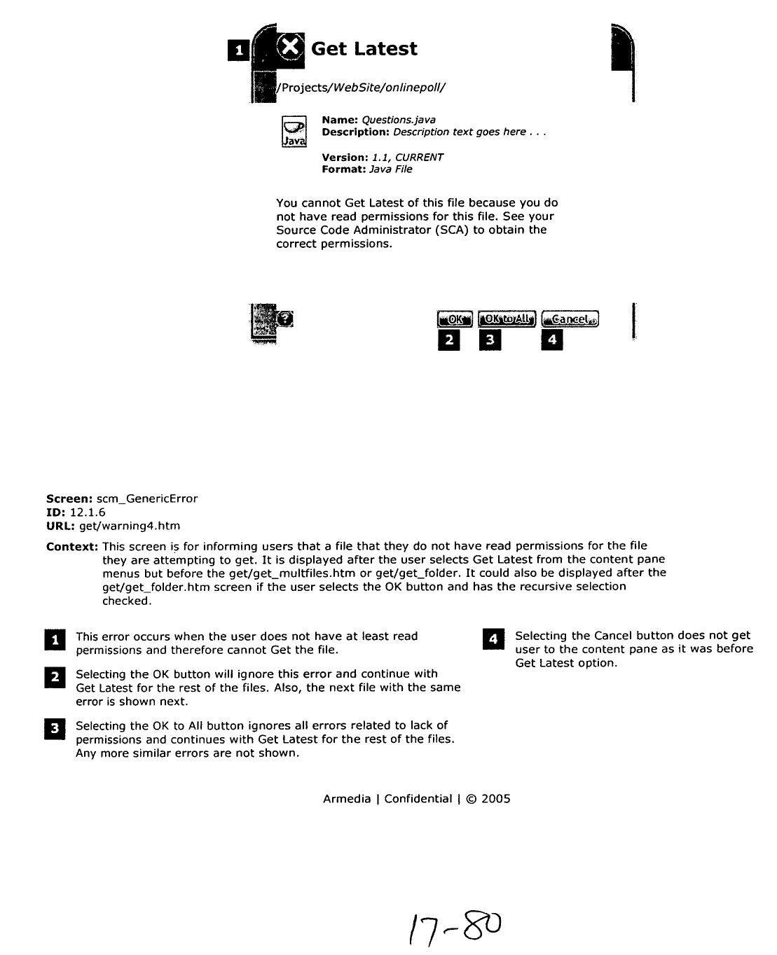

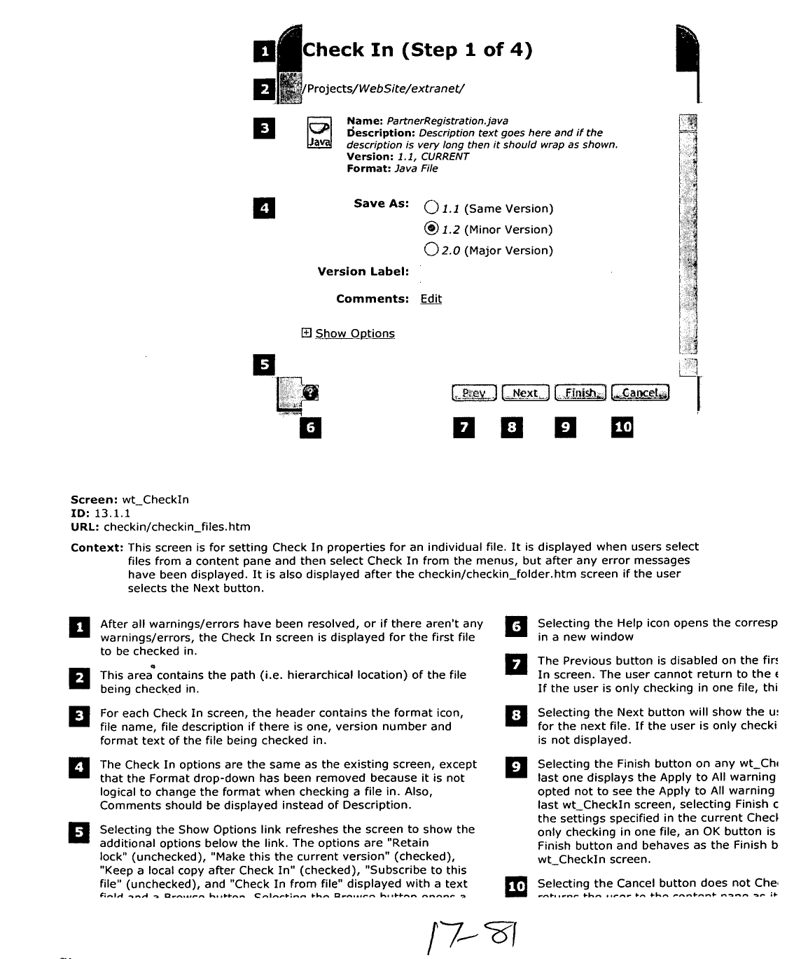

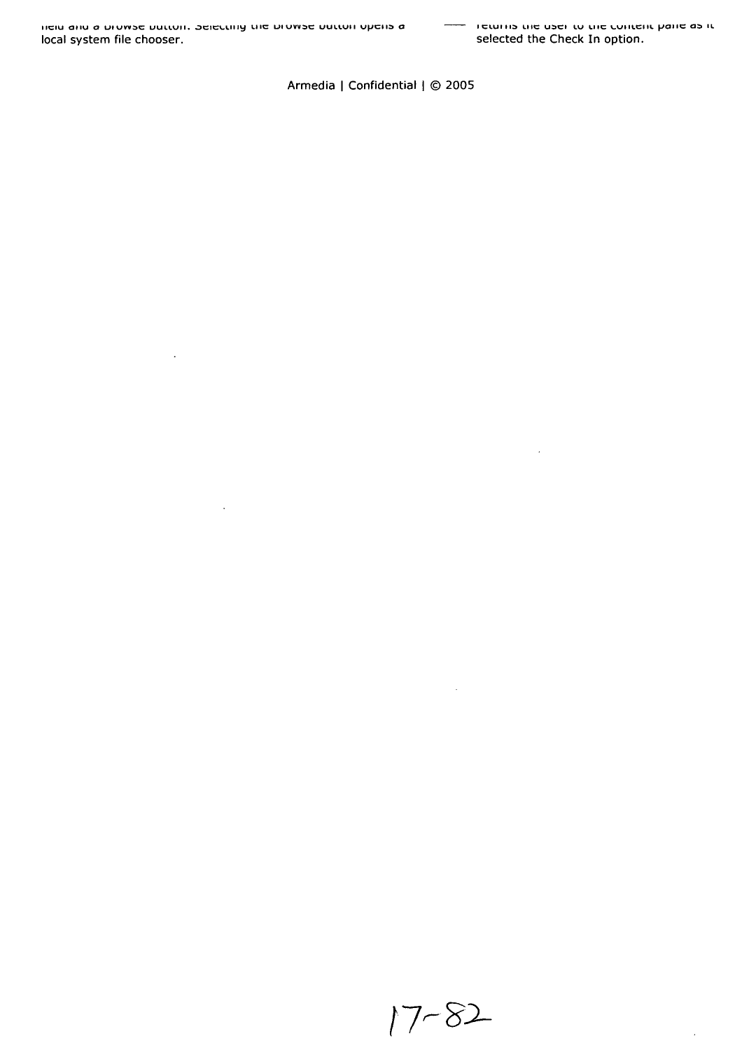

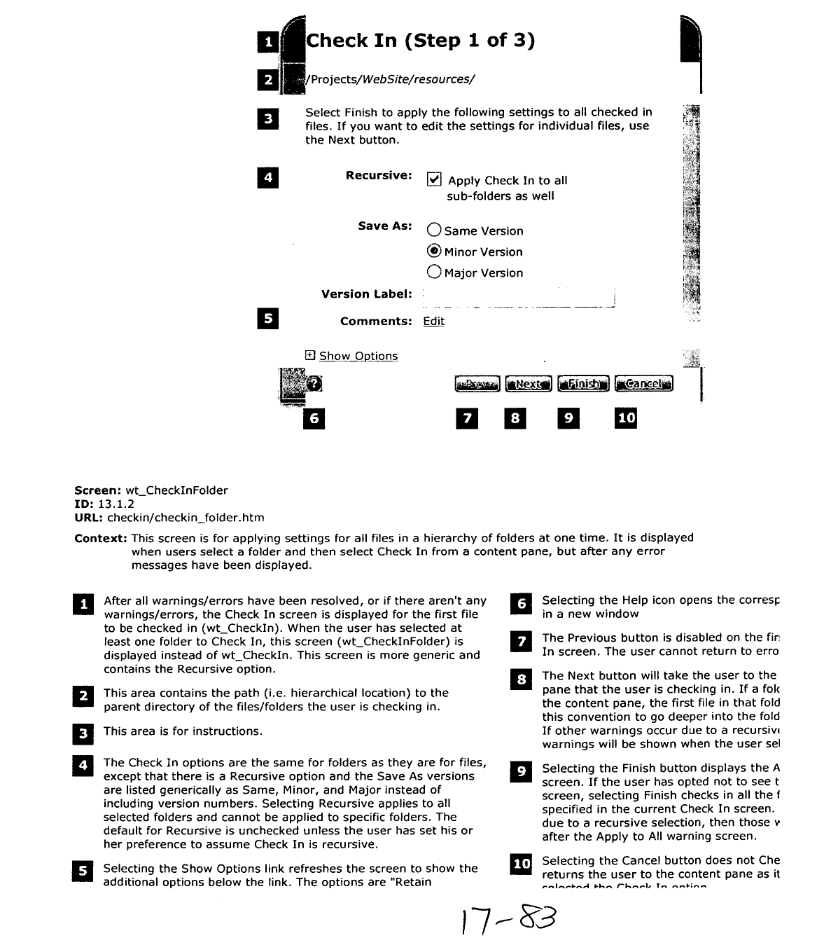

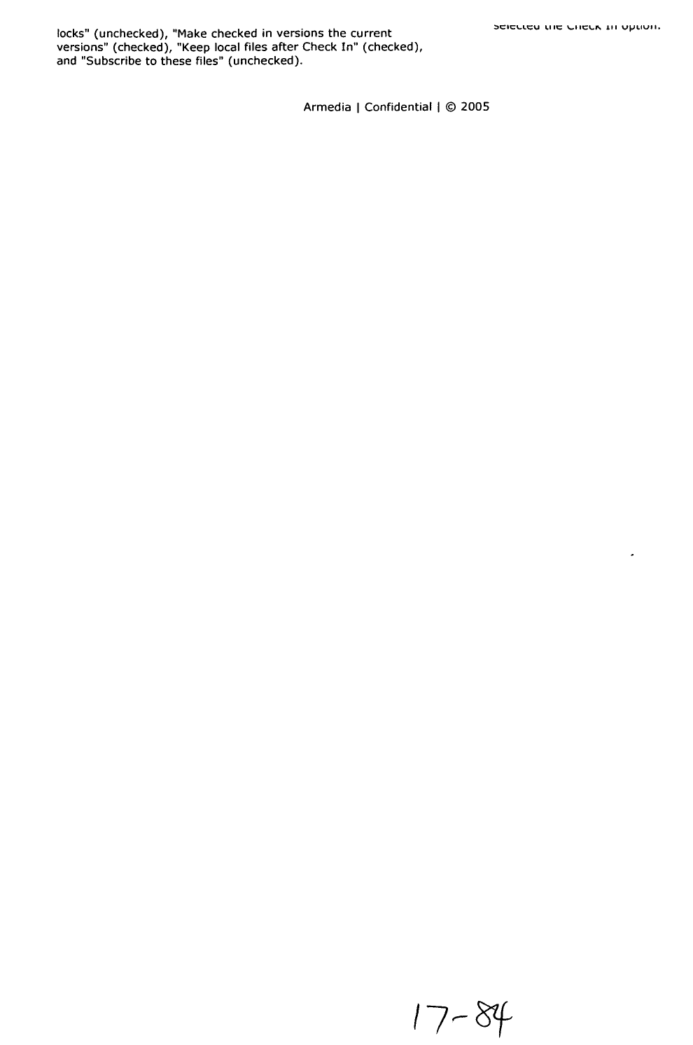

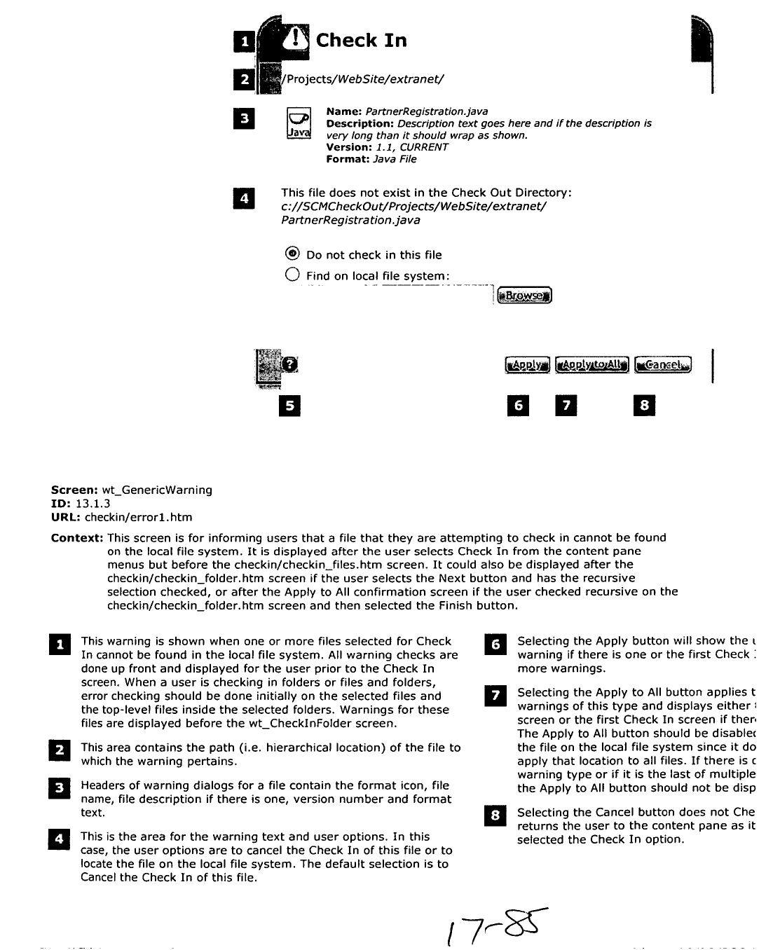

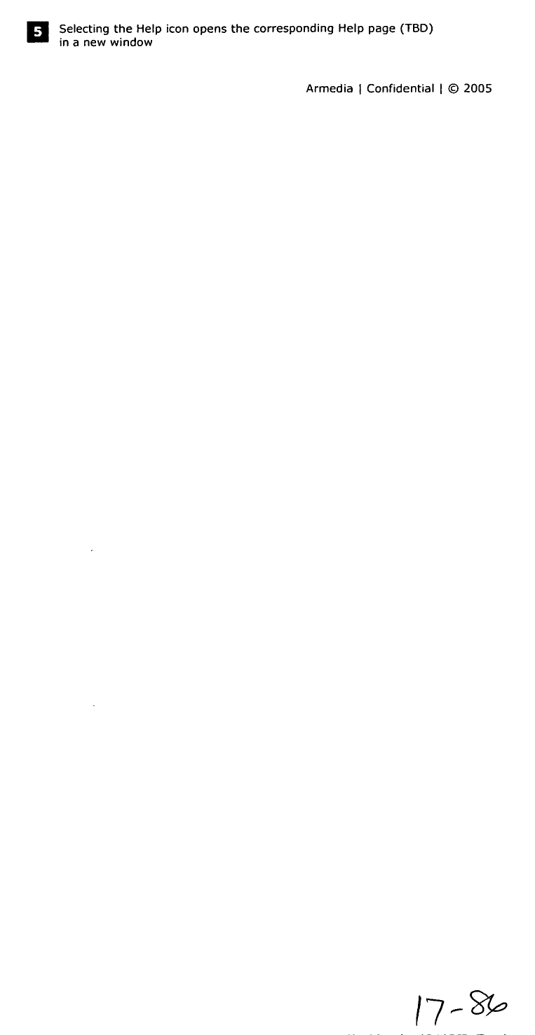

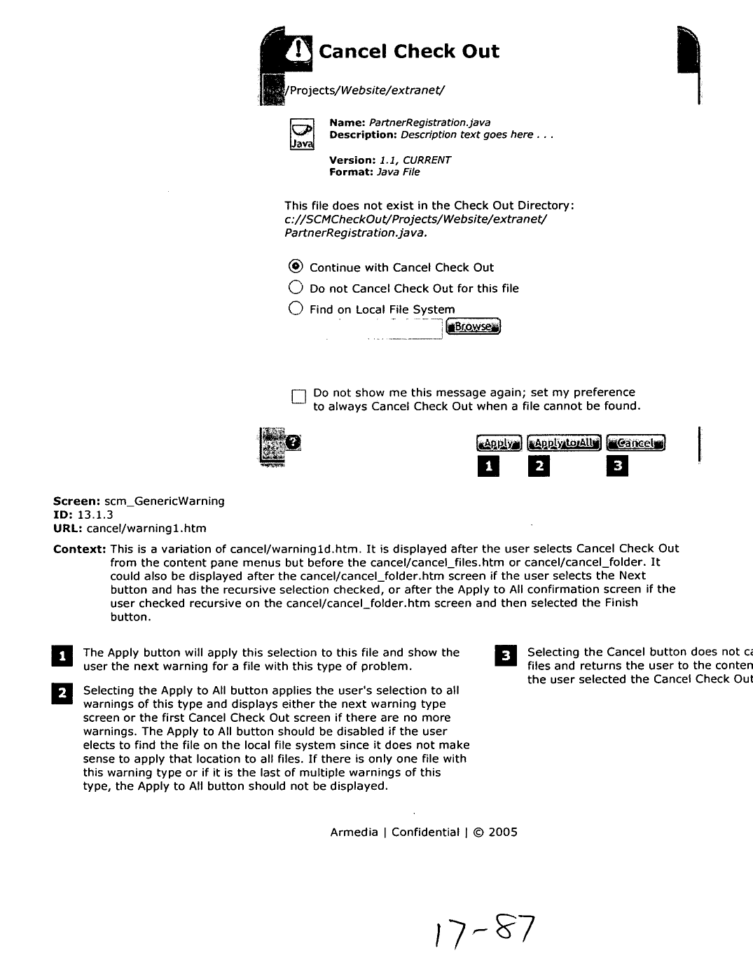

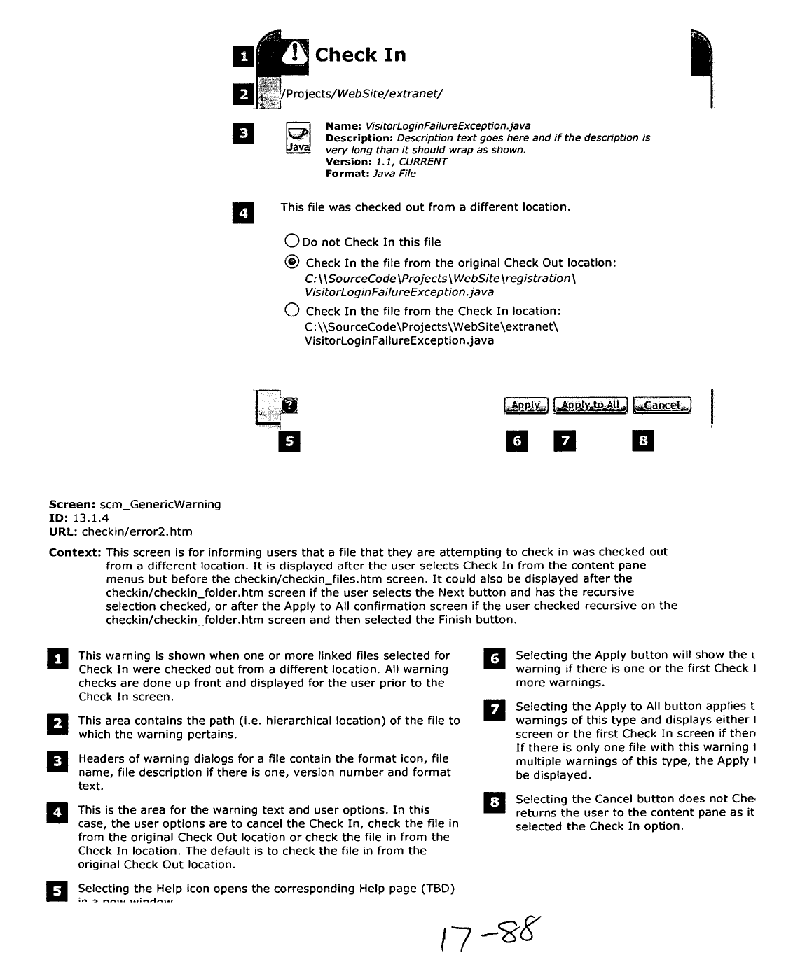

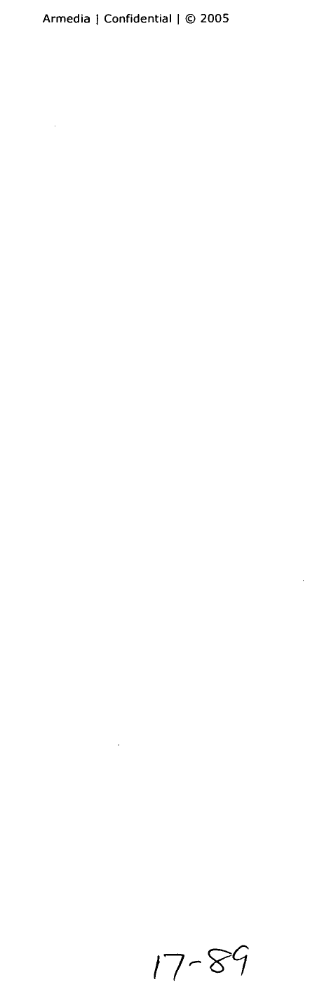

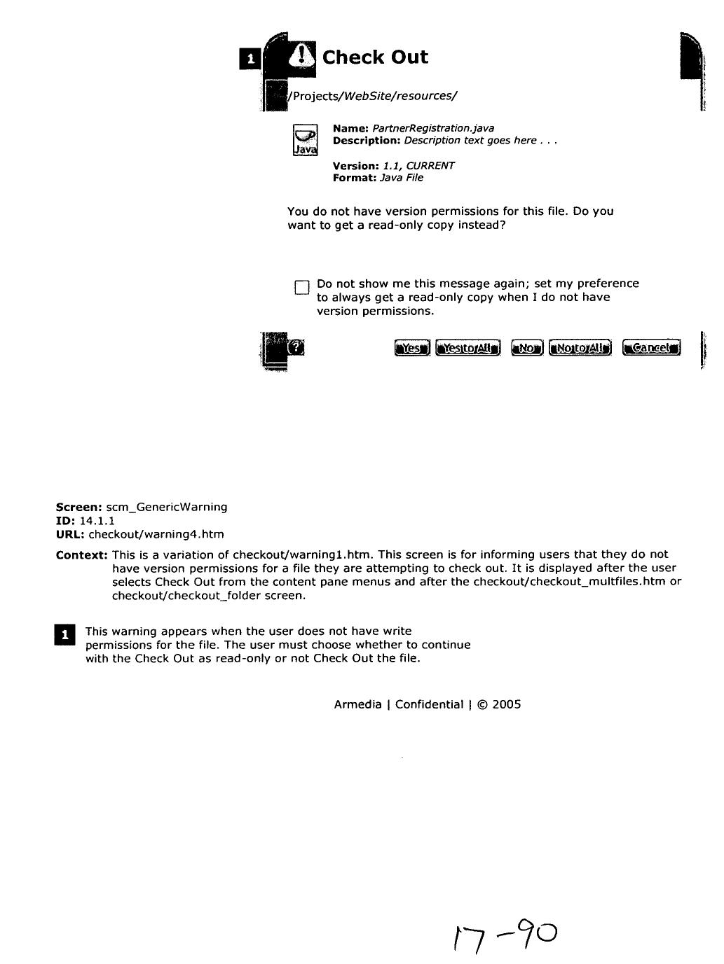

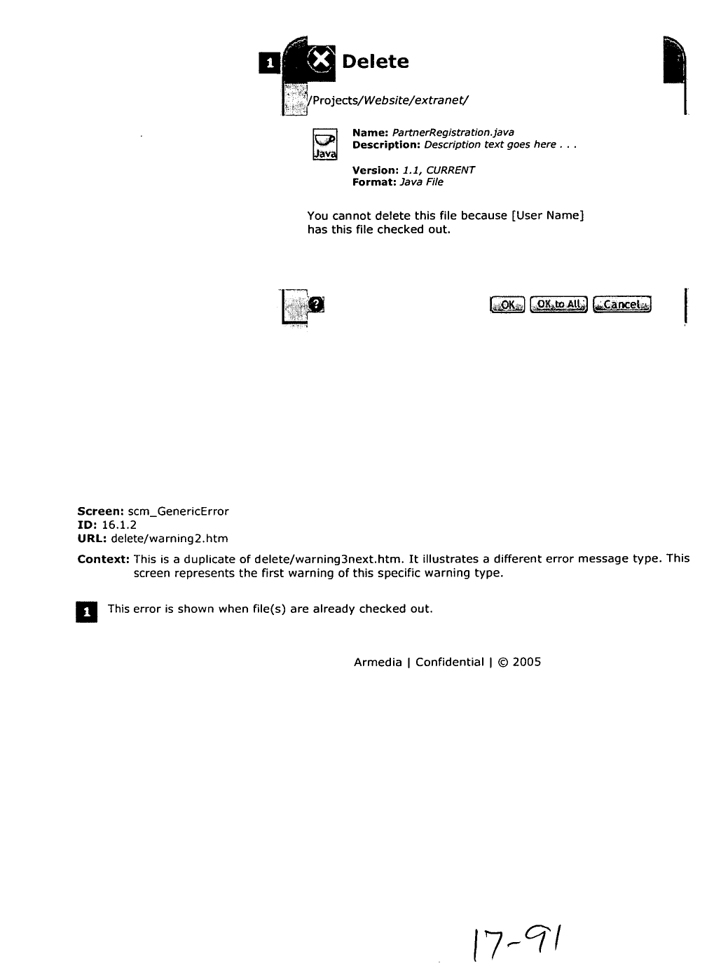

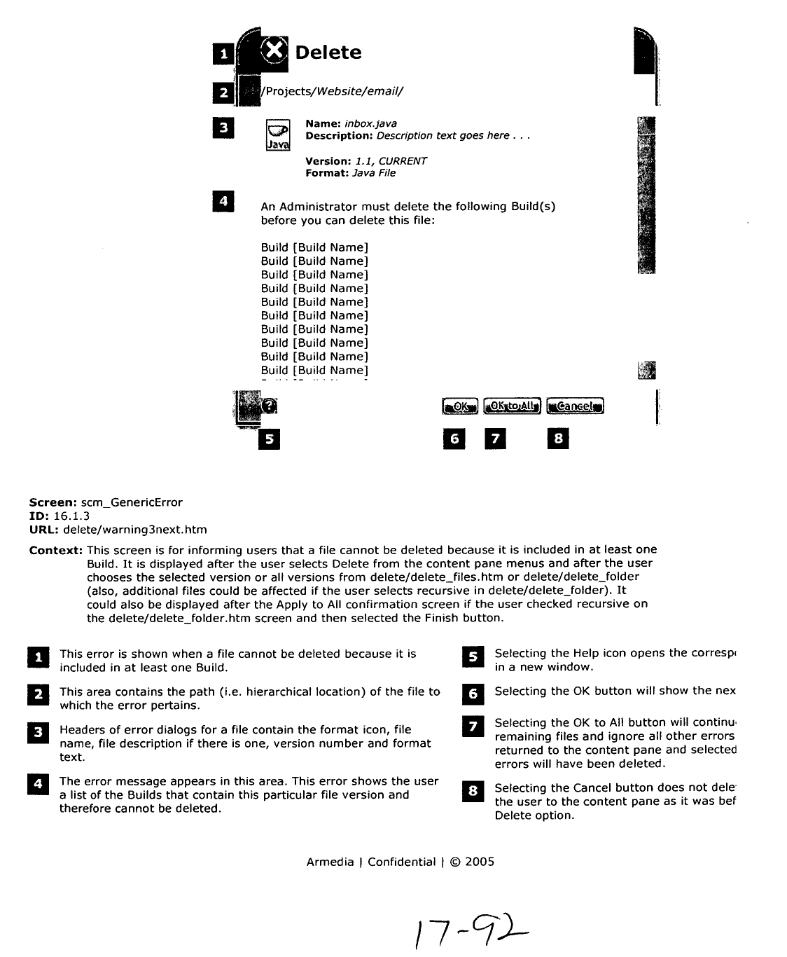

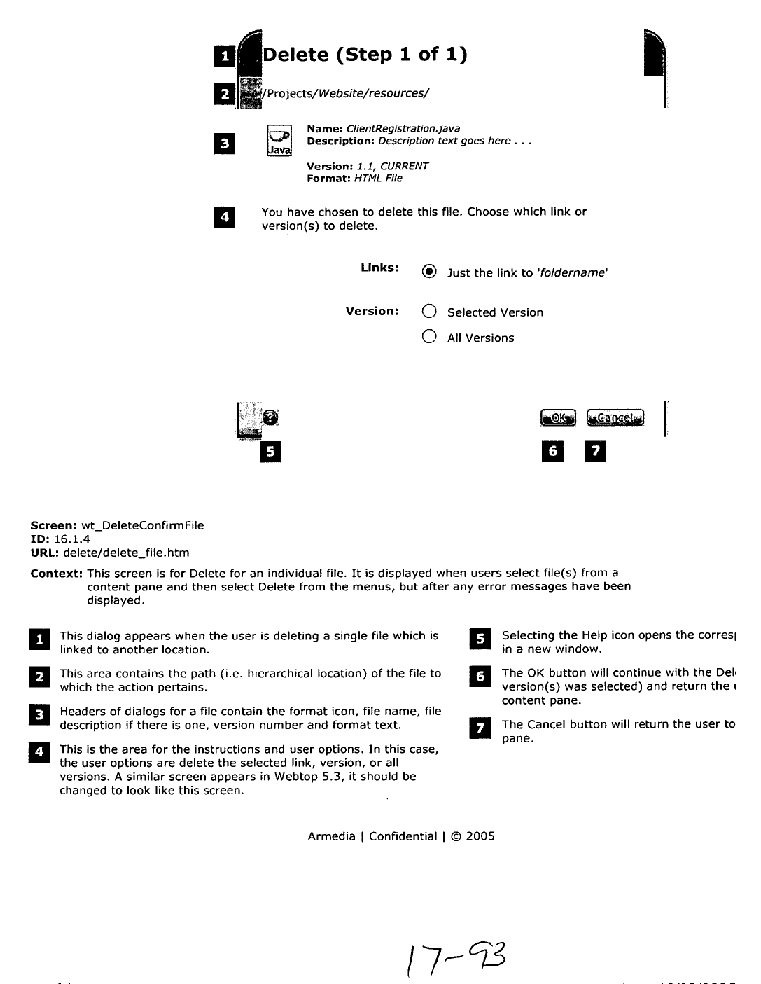

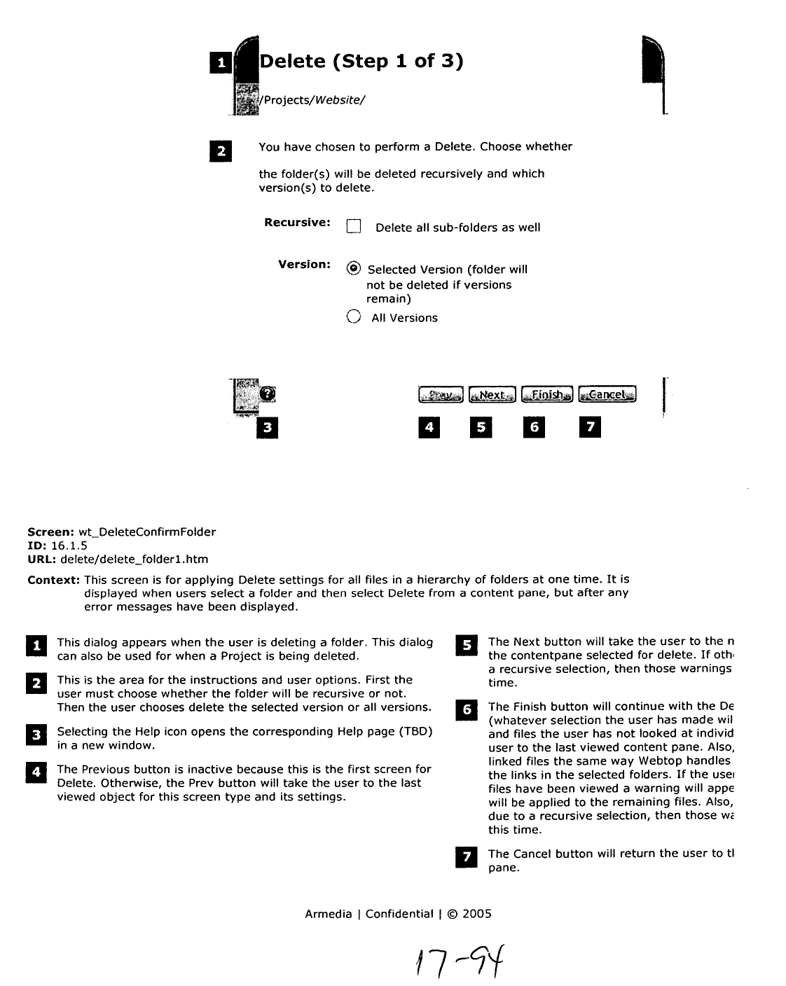

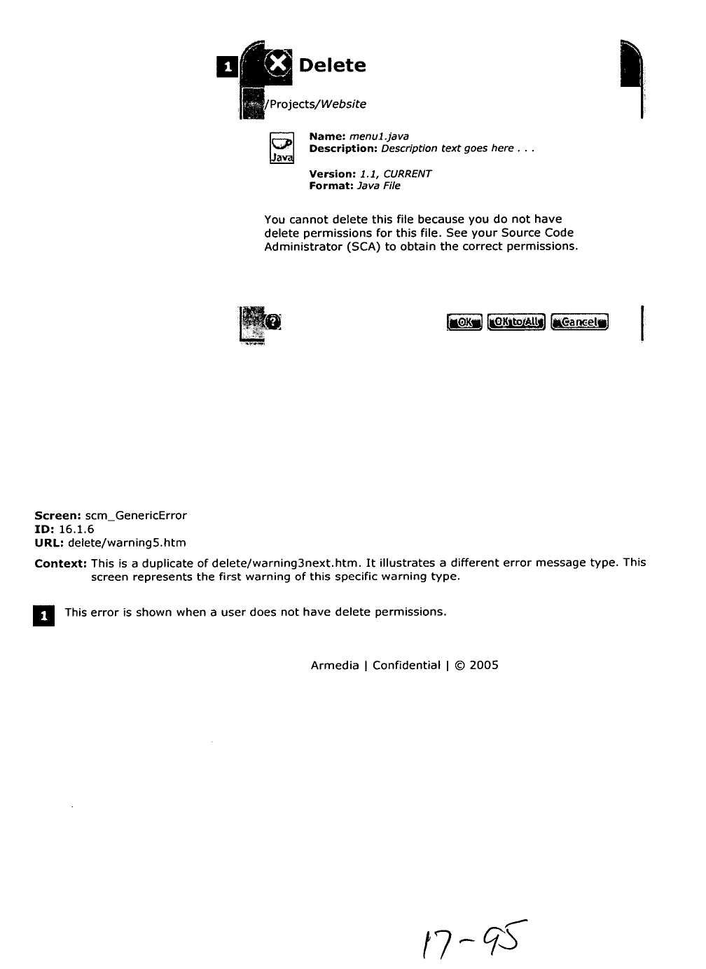

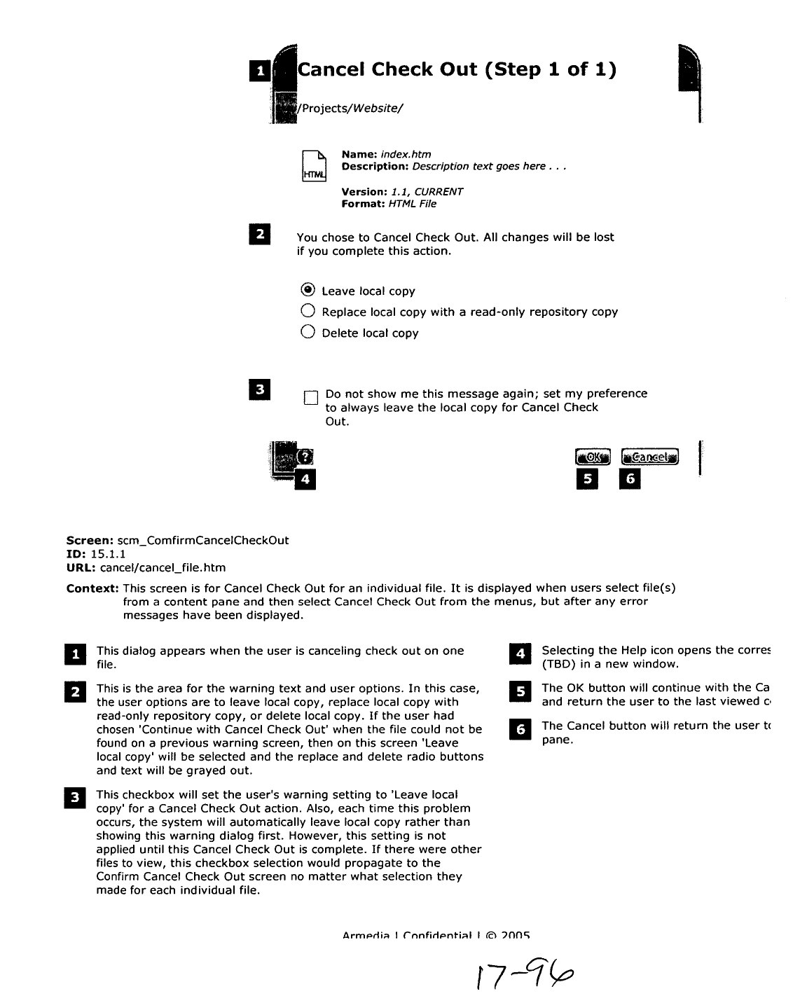

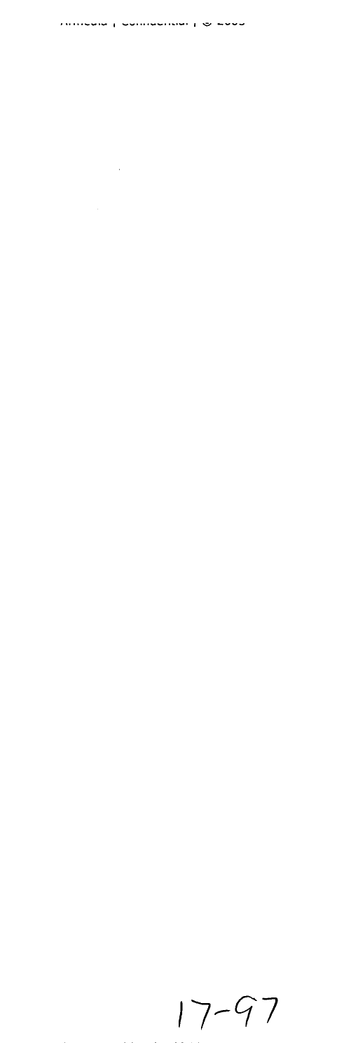

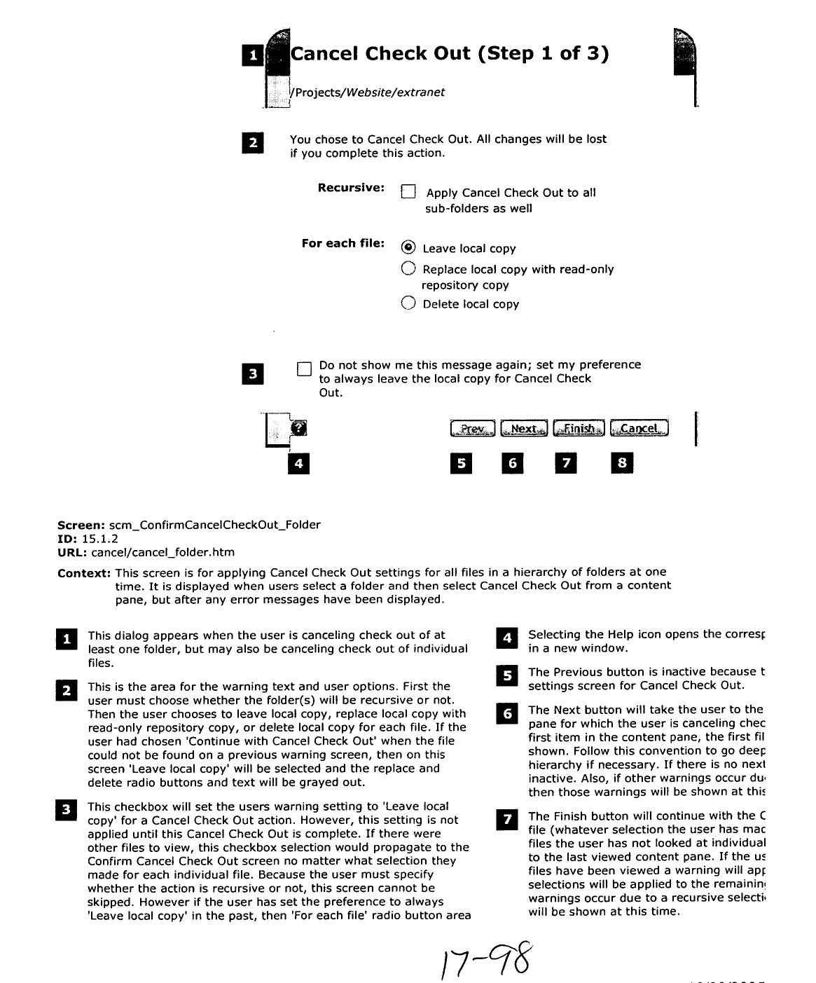

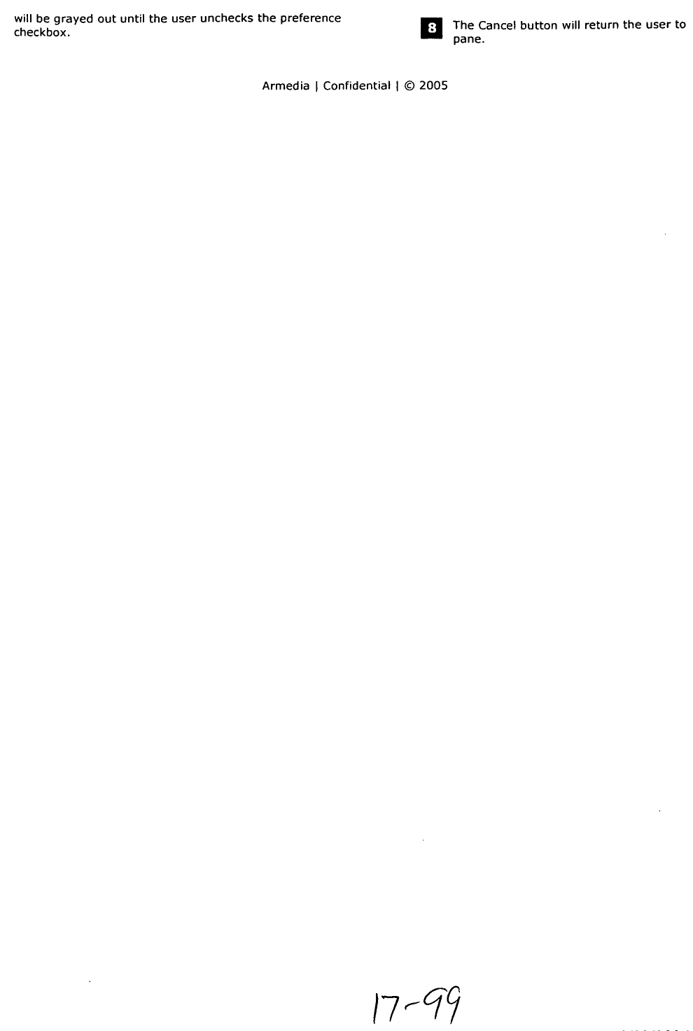

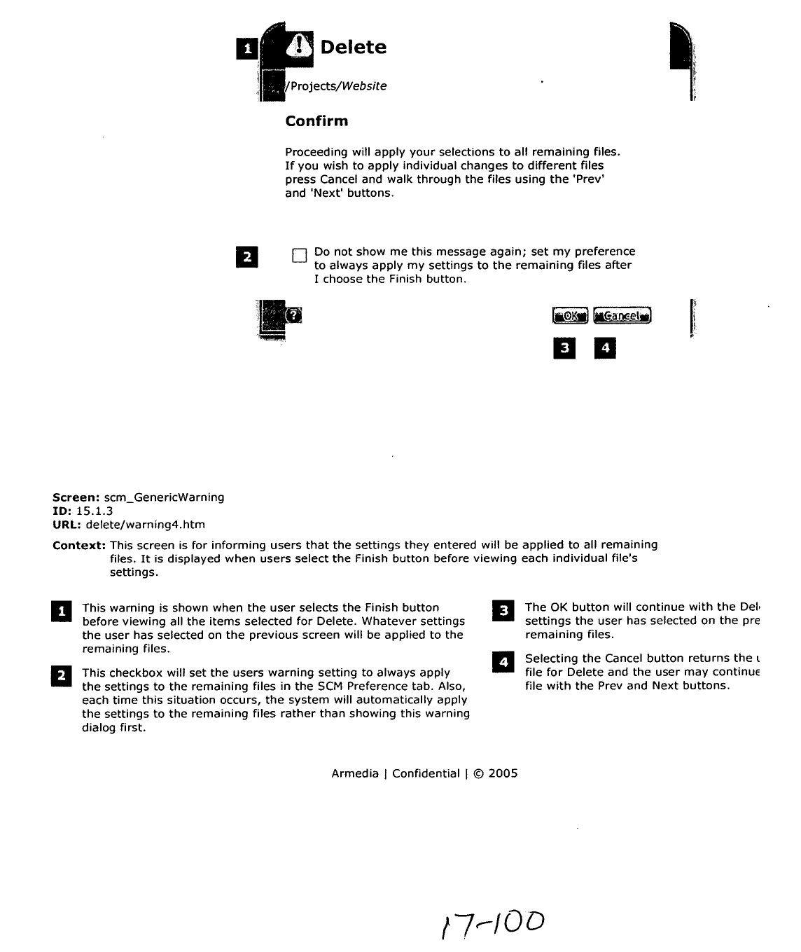

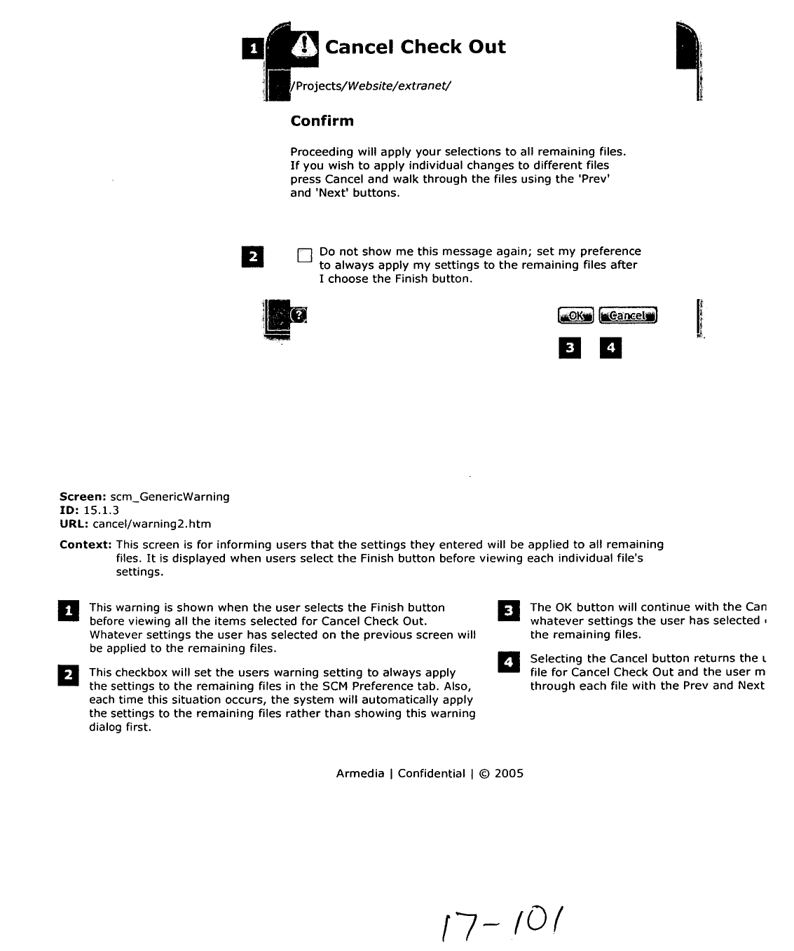

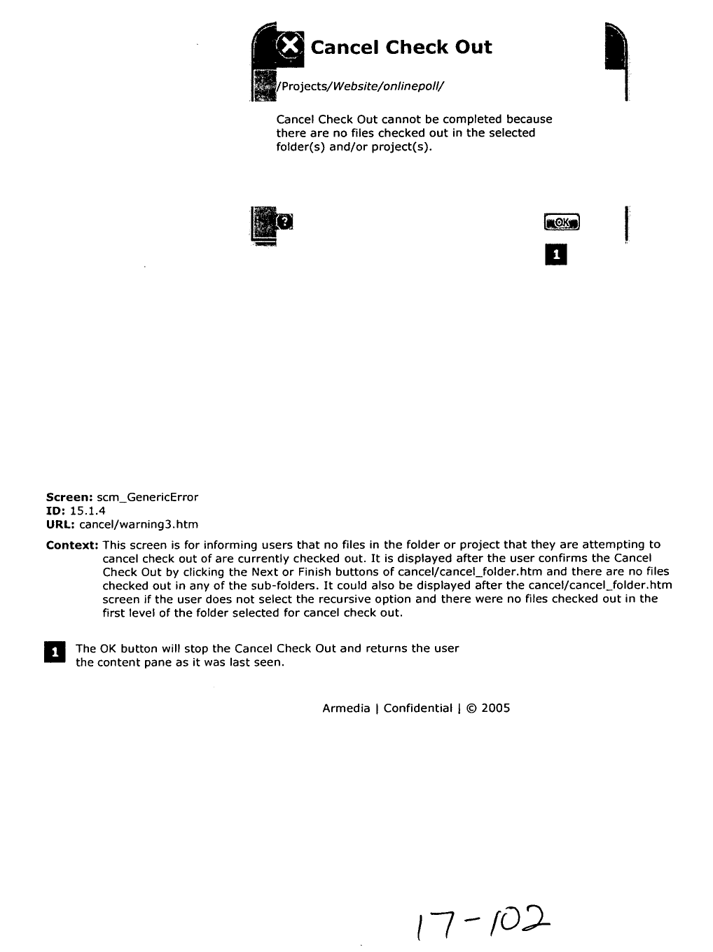

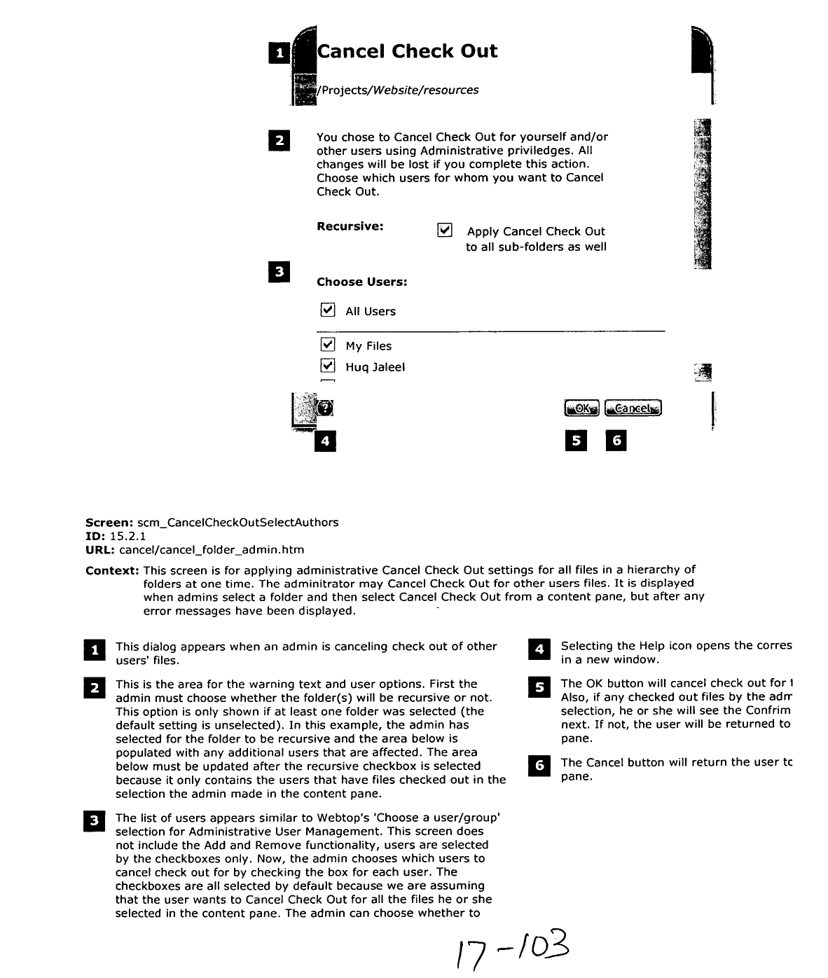

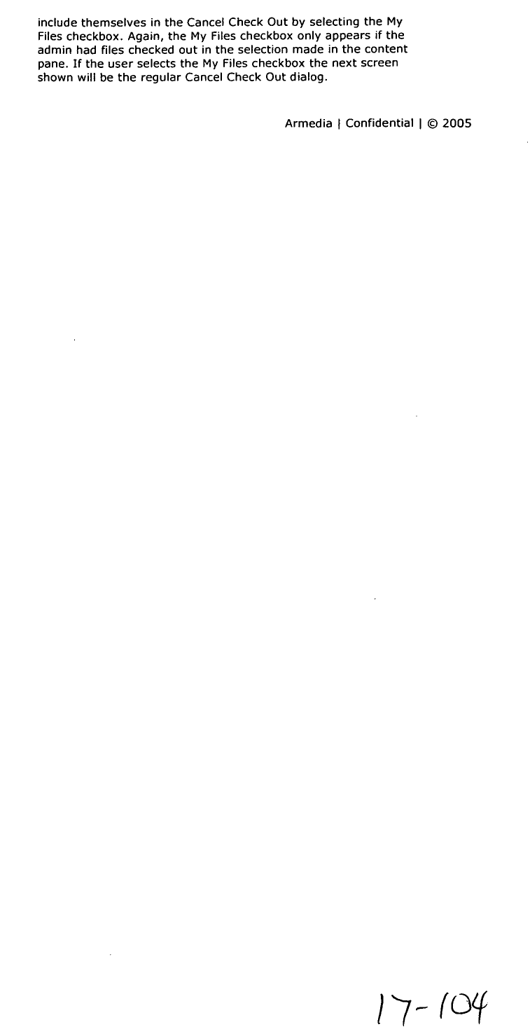

The ScmCheckinNlsProp.properties file will be located in scm/strings/com/armedia/scm/library/contenttransfer/checkin directory under the scm Web application. This file will hold NLS entries for the scmcheckin component and will inherit properties from the existing checkin component. The only properties defined here are for the Check In Folder page. Referring to FIG. 8, a diagram of a Check In Folder page is shown. Referring to FIG. 17, documents comprising screen shots are provided, describing how a user interface in accordance with an embodiment of the present invention looks and behaves.

Help Context

Help context identification scmcheckin is used for providing help on the SCM-specific Checkin operation. This primarily covers checking in files from a folder or a folder hierarchy.

Class Diagram

Extending Precondition Classes: The CheckinAction class is extended for handling SCM specific preconditions. Referring to FIG. 9, a precondition class, SCMCheckinAction, is created for SCM check in action.

Extending Behavior Classes: Referring to FIG. 10, the behavior class for the Checkin component is SCMCheckin and is extended from Checkin.

Referring to FIG. 11, the CheckinContainer is extended to SCMCheckinContainer.

Referring to FIG. 12, as per WDK/Webtop 5.3 Design Specification, the check in functionality in the service layer comprises three parts, CheckinService class, CheckinProcessor, and UcfContentTransport. The CheckinService class (WDK 5.3) is extended by SCMCheckinService class only if there are any SCM-specific needs such as exception handling.

Sequence Diagram

The Sequence Diagram is shown at FIG. 13. This diagram illustrates the SCM checkin in functionality and the interaction between the component and service layer. This diagram is based on the Design Specification for WDK/Webtop 5.3. The number of components and processors are the same as the number of files being checked in.

Queries

DQL queries may be needed to obtain the list of documents to be checked in, when the check in is performed on a folder. Depending on the selected option, the subfolder hierarchy may need to be investigated.

“Documents to be checked in from the selected folder” query identifies all the objects, of type arm_scm_doc, which are checked out by the current user, and whose parent folder is the currently selected folder.

“Documents to be checked in from the selected folder and its subtree (folder hierarchy below the folder)” query identifies all the objects of type arm_scm_doc, which are checked out by the current user, and which have the currently selected folder as an ancestor (parent or parent's ancestor) folder.

Command-Line

Referring to FIGS. 14-16, the command line functionality is implemented as Service-based Business Object (SBO). Refer to the command line approach document for the details of how this SBO is called. The check in related SBO is the SCMBOCheckin and subclass the com.doctumentum.fc.client.DfService class. It relies on the client registry to retrieve the information for where the objects need to go in the document database. This service should also support deep check in of folders. Referring to FIG. 16, in addition, some common utility classes can be designed.

Exceptions

Generic Errors and Warnings include existing error and warning pages, and SCM error and warning pages.

Existing error and warning pages include: Local File not Found and Confirm Warning. The error “Local File not Found” occurs if a user is trying to check in a file that does not exist in the local file system in the check out path. The user is given the option of manually locating the file to check in on the local file system. The page associated with this error is localFileNotFound.jsp. This page is specified in check in_component.xml.

The error message “Confirm Warning” occurs when a user is checking in multiple files and does not view the properties for each file separately. This warning tells the user that the metadata/settings applied to one file is applied to the rest of the files. This is a generic warning page, prompt.jsp. The ComboContainer class calls this generic page and passes an argument string to be displayed. The configuration file associated with the prompt component is prompt_component.xml.

SCM Error and Warning Pages include Linked Location. Linked Location is a warning displayed if a linked file has been checked out from a different location than from where the user is trying to check in. A warning is displayed to the user to either not check in or check in from the original location (folder path to which it was checked out).

Logging

The existing logging will be extended to log any new functionality introduced by the SCM Check In changes. The name of the log file is scm log. Each of these logging messages should at least include:

1. Log Category—INFO, WARN, FATAL;

2. Date/Time—Date and time stamp of when this log message is generated;

3. User—User who is accessing the system;

4. Message—The actual warning, information or fatal message.

The logging will be at four levels:

1. DEBUG—debug messages: Check In specific debug messages will be logged;

2. ERROR—fatal exceptions: Check In specific errors will be logged in. The attributes that need to be logged in are the error message, category, object ID, object type, date, timestamp, user ID, action that caused it;

3. WARN—nonfatal: For the Linked Location warning, the attributes that need to be logged in are same as above.

4. INFO—success or milestones: The successful completion of any operation of the Check In operation, the timestamp, the success message, object ID and document name will be logged in.

Samples of a user interface in accordance with an embodiment of the present invention are shown at FIG. 17.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is therefore, indicated by the appended claim rather than by the foregoing description. All changes which come within the meaning and range of equivalency of the claims are to be embraced within their scope.

For example, although action modules 122 are shown as separate modules, they may be all included as a single module. Also, while modules are shown as either belonging to the administrative services module 110 or the library services module 120, they may also be included in either or both, or may extend functionality throughout different modules. For example, modules in the administrative services module 110 may typically exert control over modules included in the library services module 120.

Additionally, it is contemplated that additional actions and functions not disclosed herein may be included in an embodiment. Further an embodiment does not necessarily include all modules disclosed herein.

Further, it is contemplated that the invention may be embodied in software, hardware, or other modes, or in combinations thereof.

Also, it is envisioned that there may be a plurality of Source Code Administrators with either overlapping functions or unique functions. Additionally, permissions granted to Source Code Developers may be further partitioned and tiered creating a rich structure to the permissions and roles of those Source Code Developers.

Finally, it is also envisioned that the source code content may include content other than web-based content.

Thus, while the present invention has been fully described above with particularity and detail in connection with what is presently deemed to be the most practical and preferred embodiment of the invention, it will be apparent in those of ordinary skill in the art that numerous modifications, including, but not limited to variations in size, materials, form, function and manner of operation, assembly and use may be made, without departing from the principles and concepts of the invention as set forth in the claims.

What is claimed is:

1. A system for managing source code, comprising:
an administrative module including a build services module configured to perform a build action on a source code file; and
a library module functionally coupled to the administration module and configured to support library services operations on the source code file.

2. A system for managing source code, comprising:
an administrative module configured to create and manage a source code project; and
a document management based library module functionally coupled to the administration module and configured to perform a file action on a folder associated with the source code project.

3. A system for managing source code, comprising:
an administrative module including a build services module configured to perform
a build action on a source code file, and
a document management based library module functionally coupled to the administration module and configured to perform a file action on a folder containing the source code file.

4. A system for managing source code as in claim 1, wherein the build action is selected from the group comprising extracting, packaging and deploying.

5. A system for managing source code as in claim 1, wherein the library based module is a document management based library module configured to perform a file action on a folder including a source code file.

6. A system for managing source code as in claim 5, wherein the file action is selected from the group comprising check out, check in, import, export, get latest, and unlock.

7. A system for managing source code as in claim 1, wherein the library based module is a document management based library module configured to perform a file action on a folder and on any subfolders within the folder.

8. A system for managing source code as in claim 1 wherein the document based library module and the administrative module are included in the same module.

9. A system for managing source code as in claim 1 wherein the document based library module and the administrative module are the same module.

10. A system for managing source code as in claim 1 wherein the build services module is configured to perform a build action by attaching a build metatag to the source code file, or the source code file collection.

11. The system according to claim 10 wherein the build metatag is configured to functionally interact with the system for managing source code.

12. The system according to claim 10 wherein the build action defines what file actions may be taken on the source code file.

13. The system according to claim 10 wherein the build metatag defines the build action.

14. The system according to claim 10 wherein the build metatag defines the file actions taken on the source code file.

15. The system according to claim 10 wherein the build metatag defines how the administrative module and library module may interact with the source code file.

16. The system according to claim 10 wherein the build metatag comprises a build status label.

17. The system according to claim 16 wherein the build status label is an object.

18. The system according to claim 17 wherein the object is a collection.

19. The system according to claim 16 wherein the build status label functionally interacts with the library module.

20. The system according to claim 16 wherein the build status label functionally interacts with the administrative module.

21. The system according to claim 1 wherein there is at least one version of the source code file.

22. The system according to claim 1 wherein there is more than one version of the source code file.

23. The system according to claim 1 wherein the library module, the administrative module, the build metatag, the file actions, and the build actions act independently on each version of the source code file.

24. The system according to claim 1 wherein the library module, the administrative module, the build metatag, the file actions, and the build actions act simultaneously on each version of the source code file.

25. The system according to claim 1 wherein the build action creates a build list.

26. The system according to claim 25 wherein the build list is an object functionally interactive with another portion of the system.

27. The system according to claim 25 wherein the build list is an object functionally interactive with the library module.

28. The system according to claim 25 wherein the build list is a object functionally interactive with the administrative module.

29. The system in accordance with claim 1 wherein the build action creates a system object.

30. The system according to claim 1 configured to functionally interact with an integrated development environment.

31. The system according to claim 1 configured to automatically launch a source code file in the Eclipse Integrated Development Environment or other source code editors.

32. The system according to claim 1 configured to functionally interact with a diff/merge application, to enable the system to perform diff/merge actions on two versions of the same file, or two completely different files or a file from the repository and the local file system.

33. The system of claim 1 wherein the build services module performs build actions on source code files together with content files.

34. A computer operable method for managing computer data storage, comprising the steps of:
a first software agent obtaining file storage attributes for a plurality of files, wherein the files are stored on a data storage device of a first computer, wherein the files are controlled by a file system, and wherein the file storage attributes are obtained from the file system;
a second software agent intercepting calls to the file system and obtaining file storage attributes from the calls;
the second software agent storing obtained file storage attributes in a first data repository;
a third software agent obtaining file storage attributes from first data repository;
a storage management application obtaining file storage attributes from the first software agent;
the storage management application obtaining file storage attributes from the third software agent; and
the storage management application storing and updating file storage attributes in a second data repository.

35. A computer operable method for managing source code, comprising the steps of: managing a source code file with a library module; and
managing a source code project, associated with the source code file, with an administrative module.

36. A method as in claim 35 wherein the library module comprises a document management based library module configured to perform a file action on a folder and the step of managing a source code file further comprises performing a file action.

37. A method as in claim 35 wherein the administrative module is configured to create and manage a source code project, and the method further comprises the step of creating a source code project with the administrative module.

38. A method as in claim 35 wherein the administrative module is configured to perform a build action on the source code file, and the step of managing the source code project further comprises performing a build action on the source code file.

39. A method as in claim 35 wherein the library module is functionally coupled to the administration module and configured to support library services operations on the source code file, and the step of managing a source code file includes performing library services operations on the source code file.

40. A method as in claim 35 wherein the library module comprises a document management based library module functionally coupled to the administration module and configured to perform a file action on a folder associated with the source code project, and the step of managing a source code file includes performing a file action on a folder associated with the source code project.

41. A method as in claim 40 wherein the library module performs a file action selected from the group comprising check out, check in, import, export, get latest and cancel check out.

42. A method as in claim 40 wherein the library module performs the file action on a folder and on any subfolders within the folder.

43. A method as in claim 35 further comprising the step of performing a build action with the administrative module.

44. A method as in claim 43 wherein the build action is selected from the group comprising extracting, packaging and making deploying.

45. The method of claim 43 wherein the build and release action defines what file actions may be taken on the source code file.

46. A method as in claim 43 wherein the administrative module is configured to perform a build action by attaching a build metatag to the source code file collection, and the step of performing a build action with the administrative module comprises attaching a build metatag to the source code file collection with the administrative module.

47. The method of claim 46 wherein the build metatag is configured to functionally interact with the system for managing source code.

48. The method of claim 46 wherein the build metatag defines the build action.

49. The method of claim 46 wherein the build metatag defines the file actions taken on the source code file.

50. The method of claim 46 wherein the build metatag defines how the administrative module and library module may interact with the source code file.

51. The method of claim 46 wherein the build metatag comprises a build status label.

52. The method of claim 51 wherein the build status label is an object.

53. The method of claim 52 wherein the object is a collection.

54. The method of claim 51 wherein the build status label functionally interacts with the library module.

55. The method of claim 51 wherein the build status label functionally interacts with the administrative module.

56. The method of claim 35 wherein there is at least one version of the source code file.

57. The method of claim 35 wherein there is more than one version of the source code file.

58. The method of claim 46 further comprising the step of managing at least one additional version of the source code file, and wherein the library module, the administrative module, the build metatag, the file actions, and the build actions act independently on the source code file and the at least one additional version of the source code file.

59. The method of claim 35 wherein the build action creates a build list.

60. The method of claim 59 wherein the build list is an object functionally interactive with another portion of the system.

61. The method of claim 59 wherein the build list is an object functionally interactive with the library module.

62. The method of claim 59 wherein the build list is an object functionally interactive with the administrative module.

63. The method of claim 35 wherein the build action creates a system object.

64. The method of claim 35 wherein the system is configured to functionally interact with an integrated development environment.

65. The method of claim 35 wherein the system is configured to automatically launch a source code file in the Eclipse Integrated Development Environment or other source code editors.

66. The method of claim 35 wherein the system is configured to functionally interact with a diff/merge application, to enable the system to perform diff/merge actions on a first version of a file and second version of the file, and the method further comprises performing diff/merge actions on the first version and the second version.

67. The method of claim 35 wherein the system is configured to functionally interact with a diff/merge application, to enable the system to perform diff/merge actions on two completely different files, and the method further comprises the step of performing diff/merge actions on a first file and a second file.

68. The method of claim 35 wherein the build services module performs build actions on source code files together with content files.
